(19) United States
(12) Patent Application Publication
(10) Pub. No.: US 2009/0054292 A1
(43) Pub. Date: Feb. 26, 2009

(54) Encapsulated phthalocyanine granulates

(76) Inventors: Ullrich Menge, Grenzach-Wyhlen (DE); Elke Haiss, Murg (DE); Laure Baptiste, Kingersheim (FR)

Correspondence Address: JoAnn Villamizar;Ciba Corporation/Patent Department, 540 White Plains Road, P.O. Box 2005, Tarrytown, NY, 10591, US

(21) Appl. No.: 11/919,601

(22) PCT Filed: Apr. 24, 2006
(86) PCT No.: PCT/EP2006/061771

§ 371 Date: Oct. 30, 2007

(30) Foreign Application Priority Data
May 4, 2005 (EP) 05103718.2

(51) Int. Cl. B32B 1/00; B05D 1/02; C11D 3/26

(52) U.S. Cl. 510/301; 427/427.4; 428/403

(57) ABSTRACT

The present invention relates to encapsulated granulates of phthalocyanine compounds wherein the encapsulating layer consists of at least one finely particulate solid and at least one hydrophobic coating material, to a process for the preparation thereof, and to washing agent formulations comprising such granulates.

The present invention relates to encapsulated granulates of phthalocyanine compounds, to a process for the preparation thereof, and to washing agent formulations comprising such granulates.

Water-soluble phthalocyanine compounds, especially zinc and aluminium phthalocyanine sulfonates, are frequently used as photoactivators in washing agent preparations. A compilation of such formulations and their preparation, properties and use is to be found, for example, in WO 04/022693.

A further development for improved bleaching and whiteness build-up consists, for example, of mixtures of phthalocyanine compounds with at least one azo dye and/or a triphenyl-methane dye, as mentioned in WO 05/014769. Further improvements are obtained by the use of a phthalocyanine system that comprises at least one phthalocyanine to which at least one dye is covalently bonded.

As is furthermore described in the mentioned documents, suitable solid commercial forms can be produced using such phthalocyanine compounds. Such granulates meet the requirement of very rapid solubility in water in order, as a result, to avoid staining of the textile with the coloured phthalocyanine during application to the textile. A disadvantage of such granulates can be that when they are incorporated in the washing agent they can, depending on the storage conditions and the composition of the washing agent, start to dissolve and, as a result, stain the washing agent.

It has now been found that the stability of such granulates in the washing agent can be improved and, as a result, staining of the washing agent prevented, if the granulates are coated with a non-aqueous coating agent comprising at least one finely particulate solid. The finely particulate solid is present in the coating agent and, in addition thereto, may be admixed with the already coated granulate (dusting). In the embodiment of the invention, the rapid solubility of the phthalocyanine granulate in water and, as a result, the advantageous use profile of the granulates are retained.

The present invention accordingly relates to encapsulated granulates G of phthalocyanine compounds wherein the encapsulating layer consists of at least one finely particulate solid and at least one hydrophobic coating material.

The present invention relates preferably to encapsulated granulates G which are distinguished by the fact that the granulate does not contain enzymes.

The granulates do not contain any enzymes, whether in the core or in or on the encapsulation.

The present invention relates preferably to encapsulated granulates Go of phthalocyanine compounds containing
a) from 2 to 50% by weight of at least one water-soluble phthalocyanine compound, based on the total weight of the granulate,
b) from 10 to 60% by weight of at least one anionic dispersing agent and/or at least one water-soluble organic polymer, based on the total weight of the granulate,
c) from 15 to 75% by weight of at least one inorganic salt and/or at least one low-molecular-weight organic acid or salt thereof, based on the total weight of the granulate,
d) from 0 to 10% by weight of at least one further additive, based on the total weight of the granulate,
e) from 3 to 15% by weight water, based on the total weight of the granulate, wherein the encapsulating layer consists of at least one finely particulate solid and at least one hydrophobic coating material.

The sum of the percentages by weight (% by weight) is always 100%.

The granulates G₀ preferably contain no enzymes, whether in the core or in or on the encapsulation.

The present invention relates preferably to encapsulated granulates G₁ of phthalocyanine compounds containing
a) from 2 to 50% by weight of at least one water-soluble phthalocyanine compound, based on the total weight of the granulate,
b) from 10 to 60% by weight of at least one anionic dispersing agent and/or at least one water-soluble organic polymer, based on the total weight of the granulate,
c) from 15 to 75% by weight of at least one inorganic salt and/or at least one low-molecular-weight organic acid or salt thereof, based on the total weight of the granulate,
d) from 0 to 10% by weight of at least one further additive, based on the total weight of the granulate,
e) from 3 to 15% by weight water, based on the total weight of the granulate,
f) from 1 to 60% by weight of an encapsulating layer comprising at least one finely particulate solid and at least one hydrophobic coating material.

The granulates G₁ preferably contain no enzymes, whether in the core or in or on the encapsulation.

As the phthalocyanine compound for the granulates G₀ and G₁ there come into consideration phthalocyanine complexes with di-, tri- or tetra-valent metals (complexes having a d⁰ or d¹⁰ configuration) as the central atom.

Such complexes are especially water-soluble Zn(II), Fe(II), Ca(II), Mg(II), Na(I), K(I), Al, Si(IV), P(V), Ti(IV), Ge(IV), Cr(VI), Ga(III), Zr(IV), In(III), Sn(IV) or Hf(VI) phthalocyanines, aluminium and zinc phthalocyanines being especially preferred.

The granulate G and G₁ advantageously comprises at least one phthalocyanine compound of formula

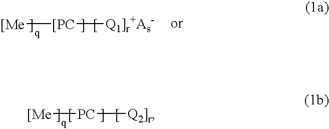

wherein
PC is the phthalocyanine ring system;
Me is Zn; Fe(II); Ca; Mg; Na; K; Al-Z₁,; Si(IV); P(V); Ti(IV); Ge(IV); Cr(VI); Ga(III); Zr(IV); In(III); Sn(IV) or Hf(VI);
Z₁ is a halide ion, sulfate ion, nitrate ion, acetate ion or hydroxy ion;
q is 0, 1 or 2;
r is from 1 to 4;
Q₁ is a sulfo or carboxyl group; or is a radical of formula —SO₂X₂—R₆—X₃⁺; —O—R₆—X₃⁺; or —(CH₂)ₜ—Y₁₊; wherein

R₆ is branched or unbranched C₁-C₈alkylene; or 1,3- or 1,4-phenylene;

X₂ is —NH—; or —N—C₁-C₅alkyl-; X₃+ is a group of formula —N—R₈; (CH⁺—N A; —COCH₂—NA₁; or —COCH₂—N—R₈; and, in the case where R₆═C₁-C₈alkylene, may also be a group of formula —NNN A; or —S+N Al —N Bi H′z R//N—R₁₂R₁₃R₁₅

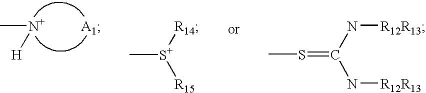

Y₁+ is a group of formula

t is 0 or 1;

in which above formulae

R₇ and R₈ are each independently of the other C₁-C₆alkyl;

R₉ is C₁-C₆alkyl; C₅-C₇cycloalkyl; or NR₁₁R₁₂;

R, O and R₁, are each independently of the other C₁-C₅alkyl;

R₁₂ and R₁₃ are each independently of the other hydrogen or C₁-C₅alkyl;

R₁₄ and R₁₅ are each independently of the other unsubstituted or hydroxy-, cyano-, carboxy-,

C₁-C₆alkoxy-carbonyl-, C₁-C₆alkoxy-, phenyl-, naphthyl- or pyridyl-substituted C₁-C₆alkyl;

u is from 1 to 6;

A¹ is the balance of an aromatic 5- to 7-membered nitrogen heterocycle which may contain one or two further nitrogen atoms as ring members, and B₁ is the balance of a saturated 5- to 7-membered nitrogen heterocycle which may contain 1 or 2 further nitrogen, oxygen and/or sulfur atoms as ring members;

Q₂ is hydroxy; C₁-C₂₂alkyl; branched C₄-C₂₂alkyl; C₂-C₂₂alkenyl; branched C₄-C₂₂alkenyl or a mixture thereof; C₁-C₂₂alkoxy; a sulfo or carboxyl radical; a radical of formula

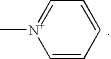

a branched alkoxy radical of formula

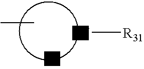

an alkylethyleneoxy unit of formula
-(T₁)_{d}-(CH₂)_{b}(OCH₂CH₂)ₐ—B₃ or an ester of formula COOR₂₃,
wherein
B₂ is hydrogen; hydroxy; C₁-C₃₀alkyl; C₁-C₃₀alkoxy; —CO₂H; —CH₂COOH; SO₃⁻M₁⁺; —OSO₃⁻M₁⁺; —PO₃²⁻M₁²⁺; —OPO₃²⁻M₁²⁺; or a mixture thereof;
B₃ is hydrogen; hydroxy; —COOH; —SO₃⁻M₁⁺; —OSO₃⁻M₁⁺; or C₁-C₆alkoxy;
M₁ is a water-soluble cation;
T₁ is —O—; or —NH—;
X₁ and X₄ are each independently of the other —O—; —NH—; or —N—C₁-C₅alkyl;
R₁₆ and R₁₇ are each independently of the other hydrogen; a sulfo group or a salt thereof; a carboxyl group or a salt thereof, or a hydroxyl group, at least one of the radicals R₁₆ and R₁₇ being a sulfo or carboxyl group or a salt thereof,
Y₂ is —O—; —S—; —NH— or —N—C₁-C₅alkyl;
R₁₈ and R₁₉ are each independently of the other hydrogen; C₁-C₆alkyl; hydroxy-C₁-C₆alkyl; cyano-C₁-C₆alkyl; sulfo-C₁-C₆alkyl; carboxy-C₁-C₆alkyl or halo-C₁-C₆alkyl; unsubstituted or halo-, C₁-C₄alkyl-, C₁-C₄alkoxy-, sulfo- or carboxy-substituted phenyl; or R₁₈ and R₁₉, together with the nitrogen atom to which they are bonded, are a saturated 5- or 6-membered heterocyclic ring which may additionally contain a further nitrogen or oxygen atom as ring member;
R₂₀ and R₂₁ are each independently of the other a C₁-C₆alkyl or aryl-C₁-C₆alkyl radical;
R₂₂ is hydrogen; or unsubstituted or halo-, hydroxy-, cyano-, phenyl-, carboxy-, C₁-C₆-alkoxy-carbonyl- or C₁-C₆alkoxy-substituted C₁-C₆alkyl;
R₂₃ is C₁-C₂₂alkyl; branched C₃-C₂₂alkyl; C₂-C₂₂alkenyl or branched C₃-C₂₂alkenyl; C₃-C₂₂-glycol; C₁-C₂₂alkoxy; branched C₄-C₂₂alkoxy; or a mixture thereof;
M is hydrogen; or an alkali metal ion or ammonium ion,
Z₂ is a chlorine ion, bromine ion, alkylsulfate ion or aralkylsulfate ion;
a is 0 or 1;
b is from 0 to 6;
c is from 0 to 100;
d is 0 or 1;
e is from 0 to 22;
v is an integer from 2 to 12;
w is 0 or 1; and
A is an organic or inorganic anion,
and
in the case of monovalent anions A⁻ is equal to r and in the case of polyvalent anions is ≦r, it being necessary for Aₛ⁻ to balance the positive charge; and when r≠1, the radicals Q₁ may be identical or different,
   and wherein the phthalocyanine ring system may also contain further solubility-imparting groups.

The number of substituents Q₁ and Q₂ in formula (1a) and in formula (1b), respectively, which substituents may be identical or different, is from 1 to 8 and, as is usual with phthalo-cyanines, the number need not be a whole number (degree of substitution). If other, non-cationic substituents are also present, the sum of the latter and the cationic substituents is from 1 to 4. The minimum number of substituents that need to be present in the molecule is governed by the water-solubility of the resulting molecule. An adequate water solubility is achieved when the amount of phthalocyanine compound that dissolves is sufficient to cause photodynamically catalysed oxidation on the fibres. A solubility as low as 0.01 mg/l may be sufficient, but generally a solubility of from 0.001 to 1 g/l is expedient.

Halogen is fluorine, bromine or, especially, chlorine.

As groups

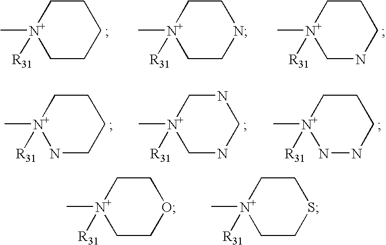

there come into consideration especially:

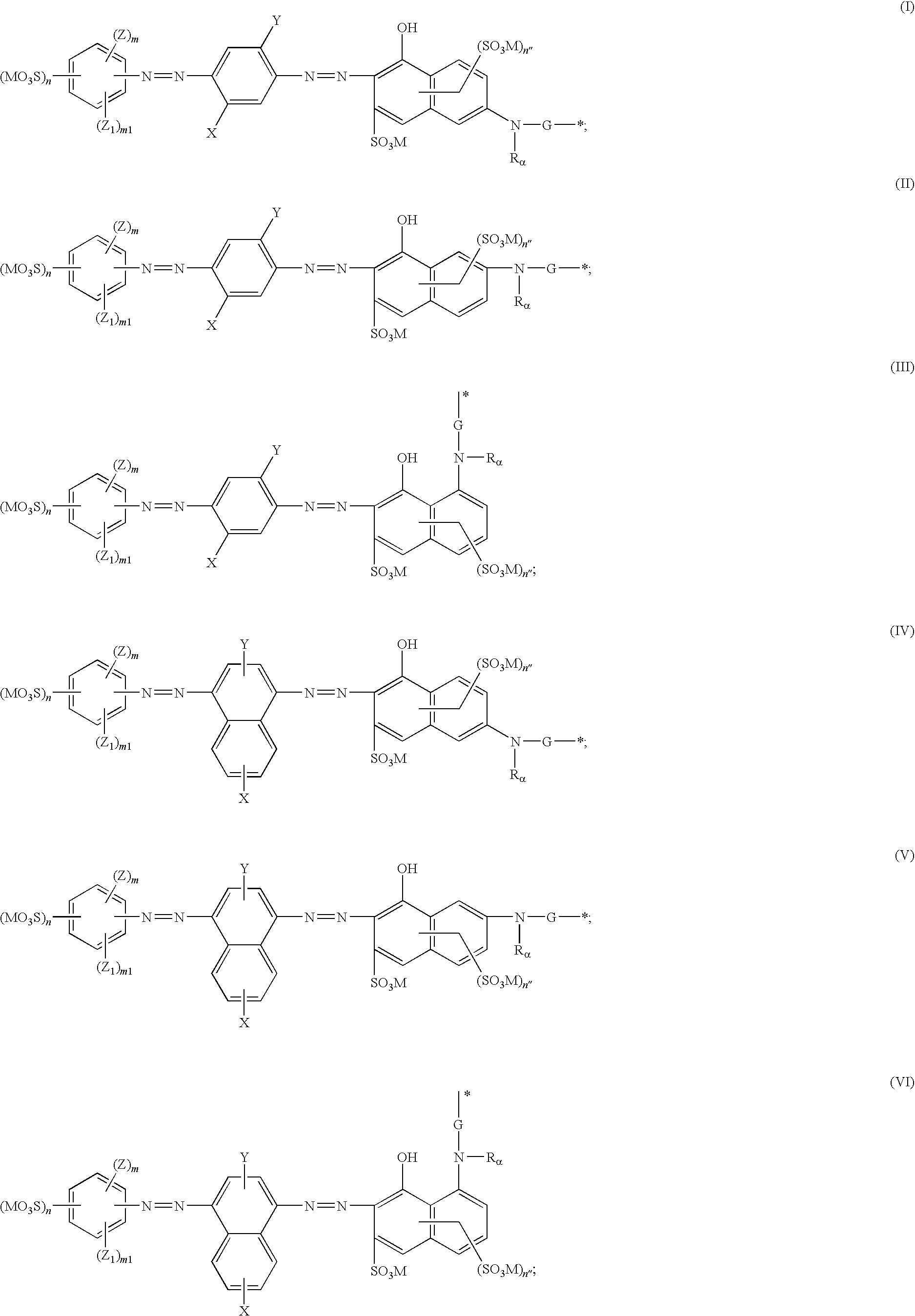

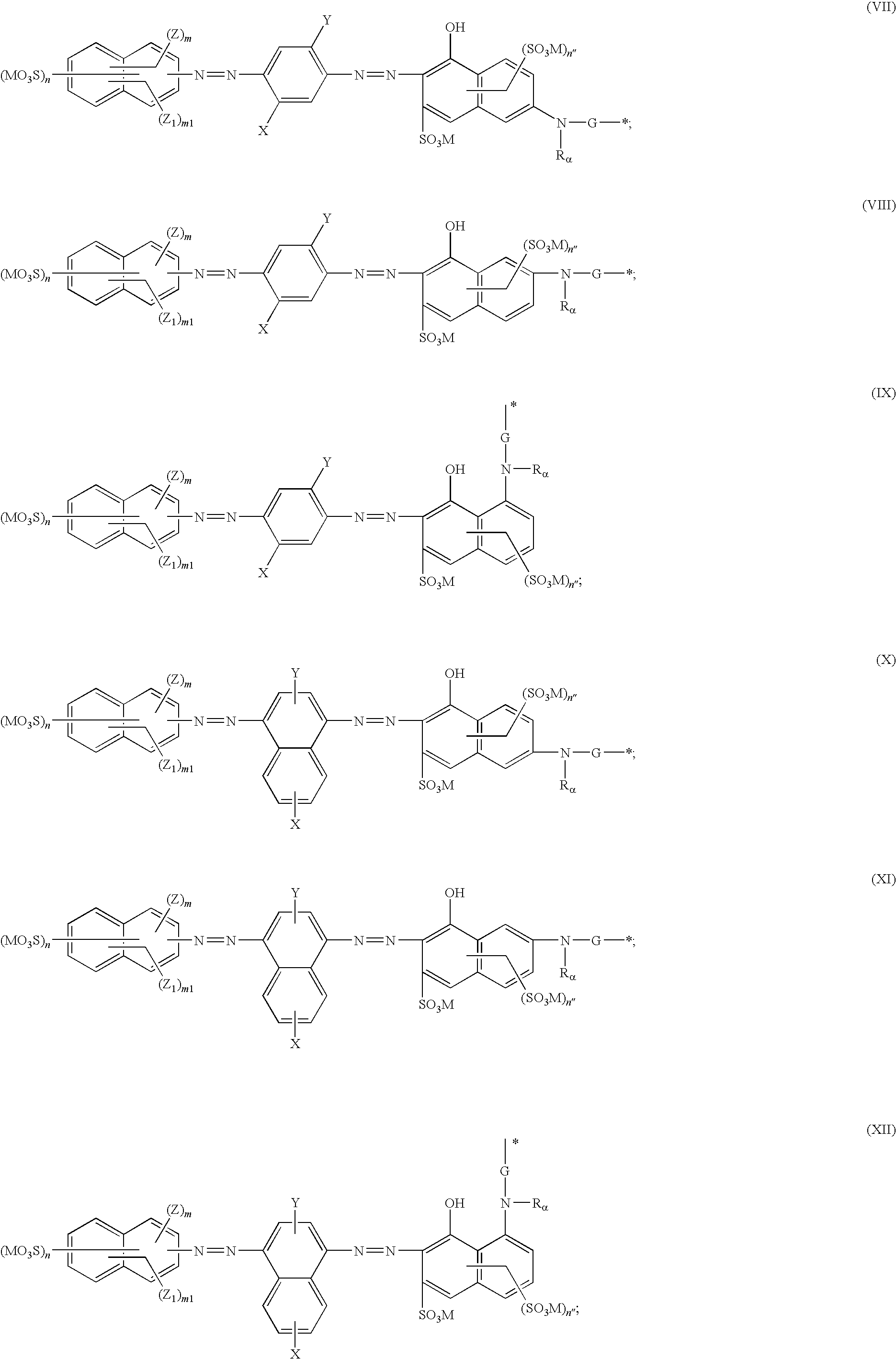

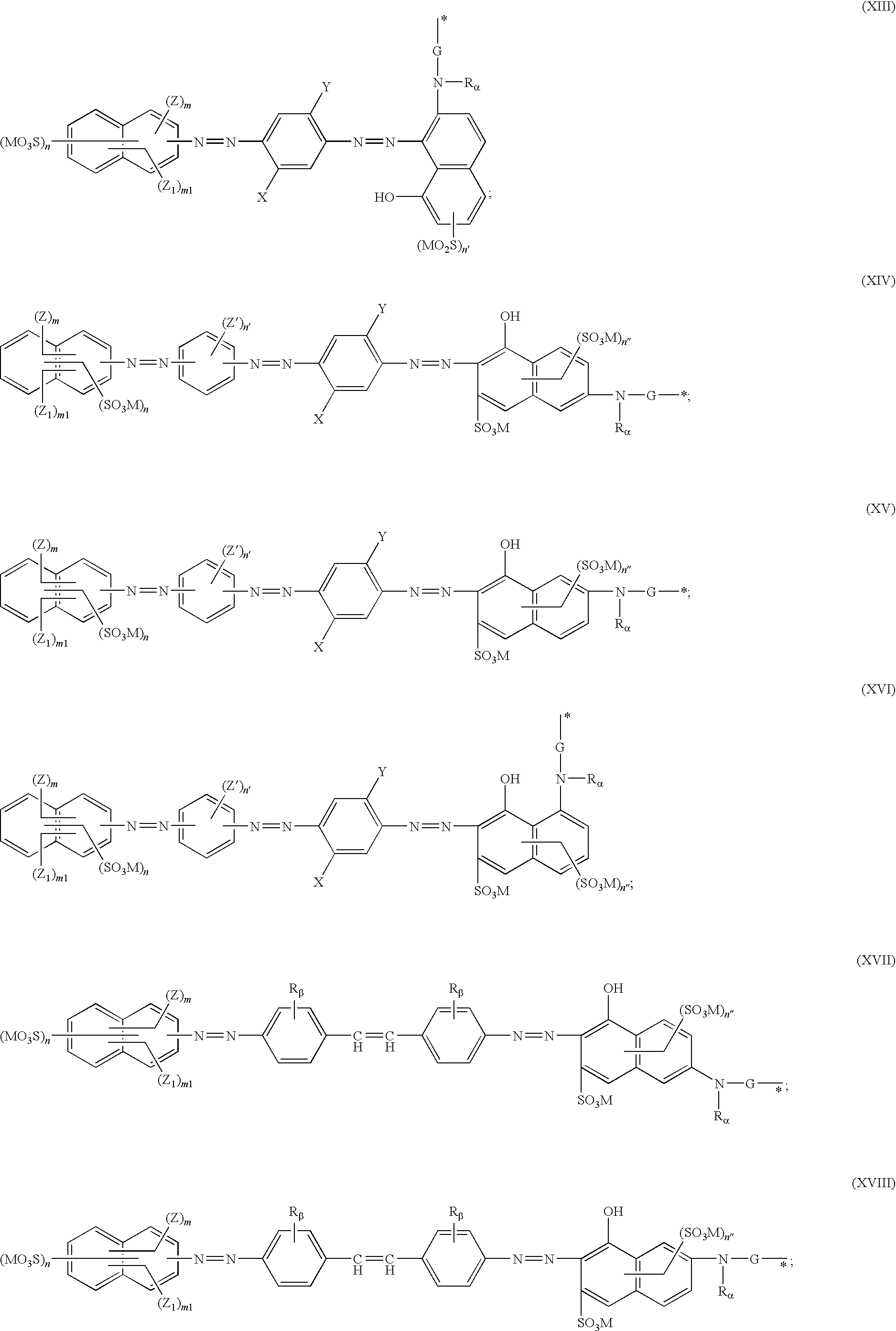

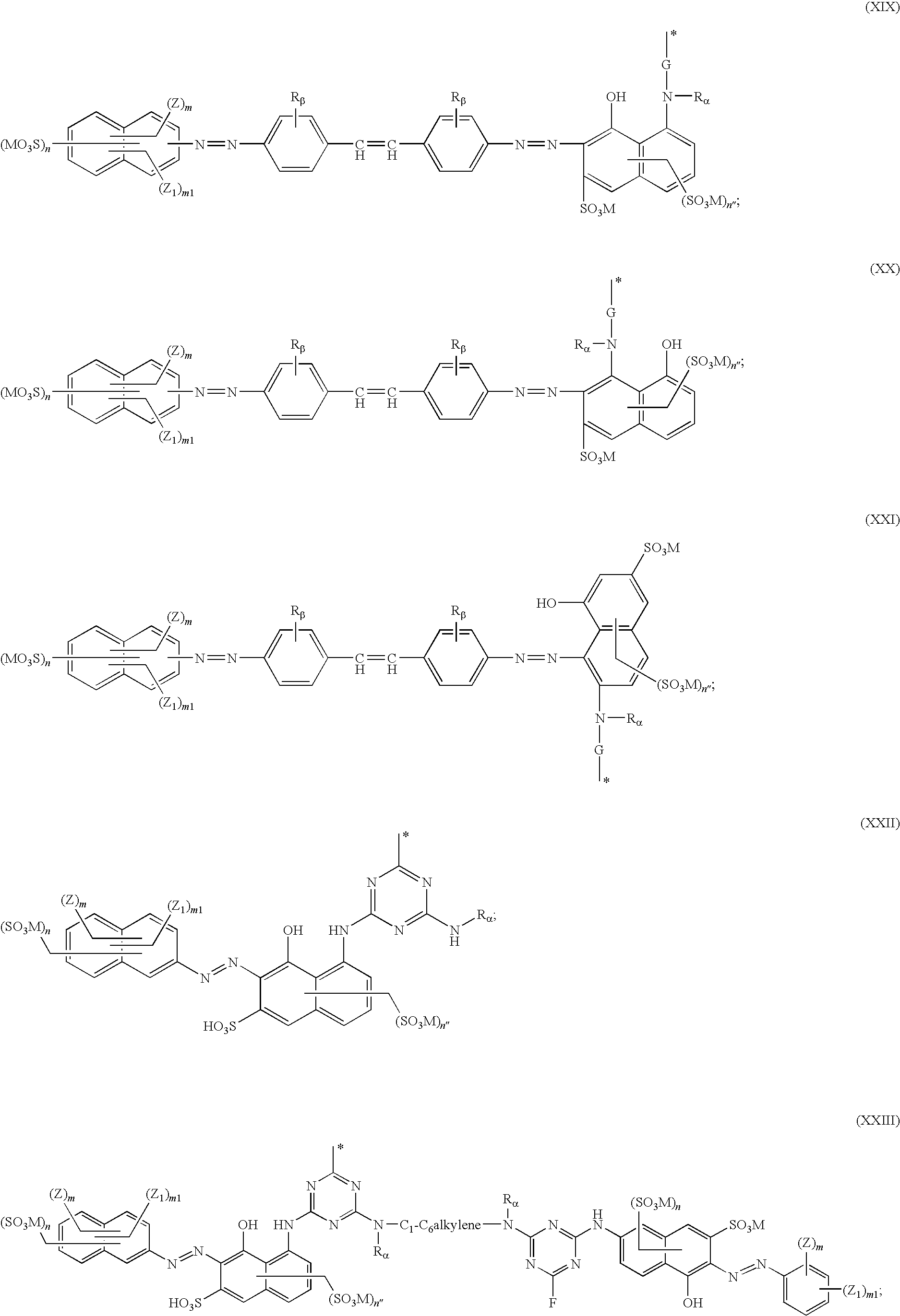

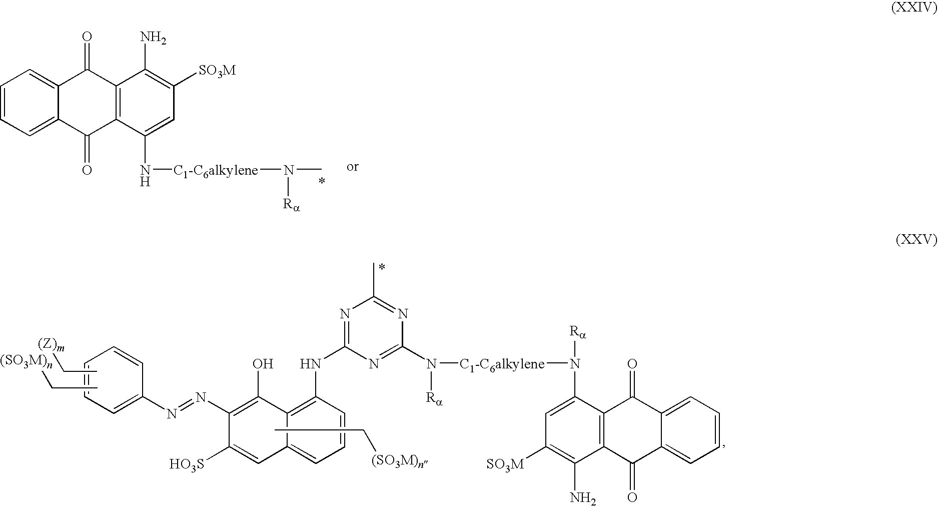

Preference is given to the group

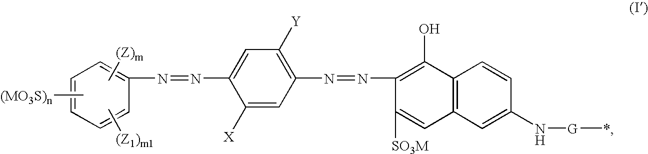

As heterocyclic rings in the group

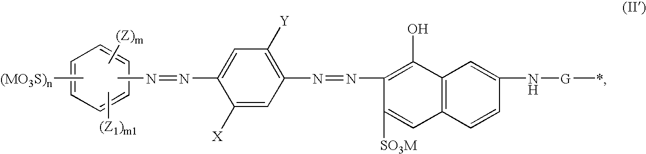

there likewise come into consideration the groups mentioned above, but with the bond to the remaining substituents being made by way of a carbon atom.

In all substituents, phenyl, naphthyl and aromatic hetero rings may be substituted by one or two further radicals, for example by C₁-C₆alkyl, C₁-C₆alkoxy, halogen, carboxy, C₁-C₆alkoxy-carbonyl, hydroxy, amino, cyano, sulfo, sulfonamido etc.

Preference is given to a substituent from the group C₁-C₆alkyl, C₁-C₆alkoxy, halogen, carboxy, C₁-C₆alkoxy-carbonyl and hydroxy.

As the group

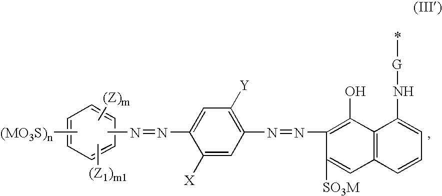

there come into consideration especially:

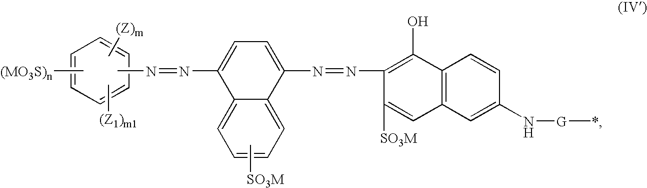

All above-mentioned nitrogen heterocycles may, in addition, be substituted by alkyl groups, either at a carbon atom or at a further nitrogen atom located in the ring, with preference being given to a methyl group as the alkyl group.

Aₛ⁻ in formula (1a) denotes, as counterion to the positive charge of the remainder of the molecule, any desired anion. It is generally introduced in the process of manufacture (quaternisation), in which case it preferably is a halogen ion, an alkylsulfate ion or an arylsulfate ion. Among the arylsulfate ions mention should be made of the phenylsulfonate, p-tolylsulfonate and p-chlorophenylsulfonate ions. It is also possible, however, for any other anion to function as the anion, since the anions can readily be interchanged in known manner; accordingly, Aₛ⁻ may also be a sulfate, sulfite, carbonate, phosphate, nitrate, acetate, oxalate, citrate or lactate ion or another anion of an organic carboxylic acid. In the case of monovalent anions, the index s is equal to r. In the case of polyvalent anions, s assumes a value ≦r but must be such, depending on the conditions, that it exactly balances the positive charge of the remainder of the molecule.

C₁-C₆Alkyl and C₁-C₆alkoxy are straight-chain or branched alkyl and alkoxy radicals, respectively, for example methyl, ethyl, n-propyl, isopropyl, n-butyl, sec-butyl, tert-butyl, amyl, isoamyl, tert-amyl or hexyl, and methoxy, ethoxy, n-propoxy, isopropoxy, n-butoxy, sec-butoxy, tert-butoxy, amyloxy, isoamyloxy, tert-amyloxy or hexyloxy, respectively. C₂-C₂₂Alkenyl denotes, for example, allyl, methallyl, isopropenyl, 2-butenyl, 3-butenyl, isobutenyl, n-penta-2,4-dienyl, 3-methyl-but-2-enyl, n-oct-2-enyl, n-dodec-2-enyl, isododecenyl, n-dodec-2-enyl or n-octadec-4-enyl.

Preferred phthalocyanine compounds of formula (1a) of the granulates G and G₁ correspond to formula

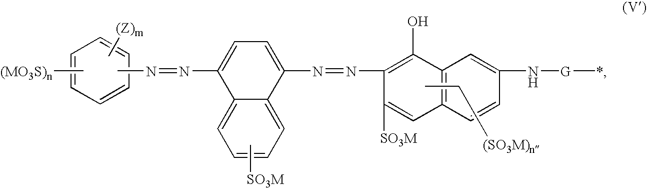

wherein
Me, q, PC, X₂, X₃ and R₆ are as defined for formula (Ia),
M is hydrogen; or an alkali metal ion, ammonium ion or amine salt ion; and the sum of the numbers r₁ and r₂ is from 1 to 4, and
Aₛ⁻ exactly balances the positive charge of the remainder of the molecule, and especially to formula

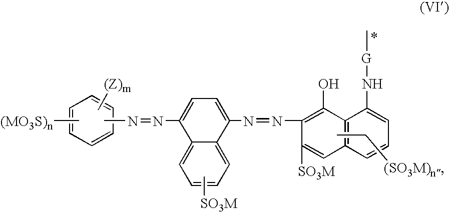

wherein
Me, q and PC are as defined for formula (Ia),
R₆′ is C₂-C₆alkylene;
r is a number from 1 to 4;
X₃′ is a group of formula

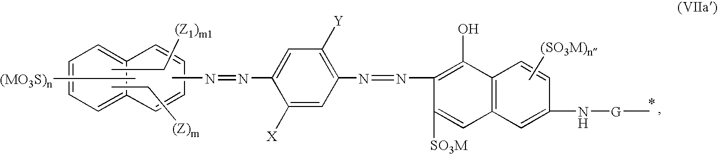

wherein
R₇ and R₈ are each independently of the other unsubstituted or hydroxy-, cyano-, halo- or phenyl-substituted C₁-C₄alkyl;
R₉ is as defined for R₇; cyclohexyl or amino;
R₁₁ is C₁-C₄alkyl;
R₂, is C₁-C₄alkyl; C₁-C₄alkoxy; halogen; carboxy; C₁-C₄alkoxy-carbonyl or hydroxy; and
A′ is a halide ion, alkylsulfate ion or arylsulfate ion;
it being possible for the radicals —SO₂NHR′₆—X₃′¹⁺ A⁻ to be identical or different.

Further phthalocyanine compounds that can be used in the granulate G and G₁ correspond to formula

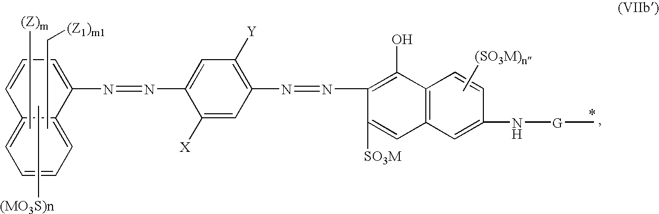

wherein
PC is the phthalocyanine ring system;
Me is Zn; Fe(II); Ca; Mg; Na; K; Al-Z₁; Si(IV); P(V); Ti(IV); Ge(IV); Cr(VI); Ga(III); Zr(IV); In(III); Sn(IV) or Hf(VI);
Z₁ is a halide ion, sulfate ion, nitrate ion, acetate ion or hydroxy ion;
q is 0; 1; or 2;
Y₃′ is hydrogen; or an alkali metal ion or ammonium ion; and
r is any number from 1 to 4.

Of those, very special preference is given to phthalocyanine compounds of formula (4) wherein

### Me is Zn or Al-Z₁; and

Z₁ is a halide ion, sulfate ion, nitrate ion, acetate ion or hydroxy ion.

Further phthalocyanine compounds of interest that can be used in the granulate G and G′ correspond to formula

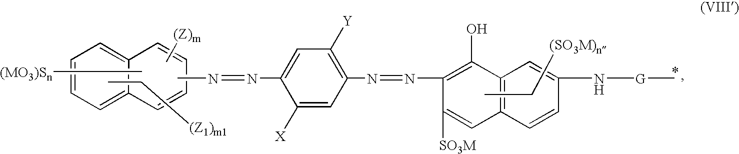

wherein
PC, Me and q are as defined for formula (4);
R₁₇′ and R₁₈′ are each independently of the other hydrogen; phenyl; sulfophenyl; carboxy-phenyl; C₁-C₆alkyl; hydroxy-C₁-C₆alkyl; cyano-C₁-C₆alkyl; sulfo-C₁-C₆alkyl; carboxy-C₁-C₆alkyl or halo-C₁-C₆alkyl or, together with the nitrogen atom, form a morpholine ring;
q′ is an integer from 2 to 6; and
r is a number from 1 to 4;

, R₁₇

it being possible, when r>1, for the radicals

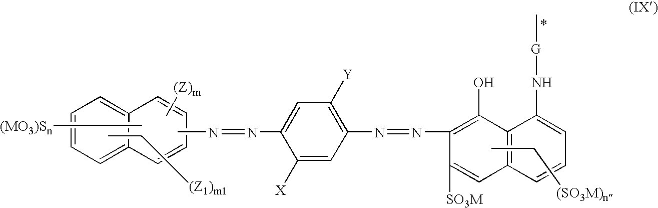

present in the molecule to be identical or different.

Further phthalocyanine compounds of interest that can be used in the granulate G and G₁ correspond to formula

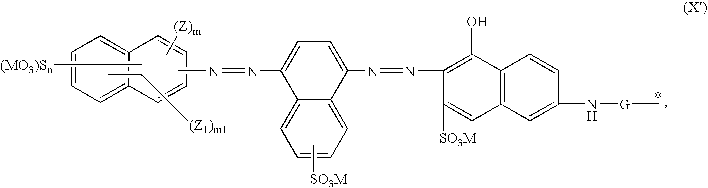

wherein
PC, Me and q are as defined for formula (4),
Y′₃ is hydrogen; or an alkali metal ion or ammonium ion,
q′ is an integer from 2 to 6;
R₁₇′ and R₁₈′ are each independently of the other hydrogen; phenyl; sulfophenyl; carboxy-phenyl; C₁-C₆alkyl; hydroxy-C₁-C₆alkyl; cyano-C₁-C₆alkyl; sulfo-C₁-C₆alkyl; carboxy-C₁-C₆alkyl or halo-C₁-C₆alkyl or, together with the nitrogen atom, form a morpholine ring,
m′ is 0 or 1; and
r and r₁ are each independently of the other any number from 0.5 to 3.5, the sum r+r₁ being a minimum of 1 and a maximum of 4.

Where the central atom Me in the phthalocyanine ring is Si(IV), the phthalocyanines used in the granulate G and G₁ may also contain, in addition to the substituents on the phenyl nucleus of the phthalocyanine ring, axial substituents (═R₂₄). Such phthalocyanines correspond, for example, to formula

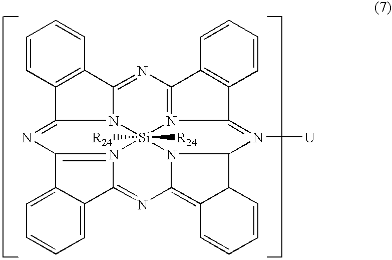

wherein
R₂₄ is hydroxy; C₁-C₂₂alkyl; branched C₃-C₂₂alkyl; C₂-C₂₂alkenyl; branched C₃-C₂₂alkenyl, or a mixture thereof; C₁-C₂₂alkoxy; a sulfo or carboxyl radical; a radical of formula

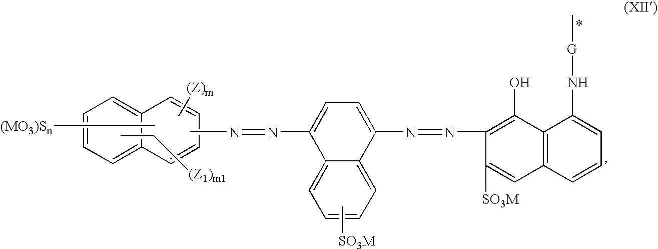

a branched alkoxy radical of formula

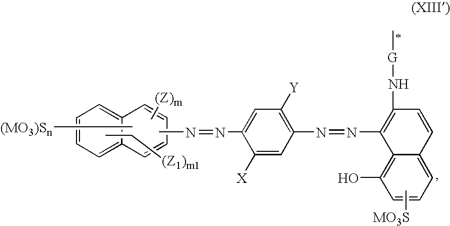

an alkylethyleneoxy unit of formula
-(T₁)_{d}—(CH₂)_{b}(OCH₂CH₂)ₐ—B₃ or an ester of formula COOR₂₃ and
   U is [Q₁]ᵣ⁺Aₛ⁻; or Q₂.

R₁₆, R₁₇, R₁₈, R₁₉, R₂₀, R₂₁, R₂₂, R₂₃, B₂, B₃, M, M₁, Q₁, Q₂, Aₛ, T₁, X₁, Y₂, Z₂, a, b, c, d, e, r, v and w therein are as defined for formulae (1a) and (1b).

Especially preferred phthalocyanine compounds are such compounds as are commercially available and used in washing agent compositions. Usually, the anionic phthalocyanine compounds are in the form of alkali metal salts, especially sodium salts.

These phthalocyanine compounds may be used on their own or in admixture with at least one azo dye and/or triphenylmethane dye. Preferred azo dyes and/or triphenylmethane dyes are described in WO 05/014769 (on pages 13-16). Especially preferred azo dyes and/or triphenylmethane dyes are compounds of the following structures

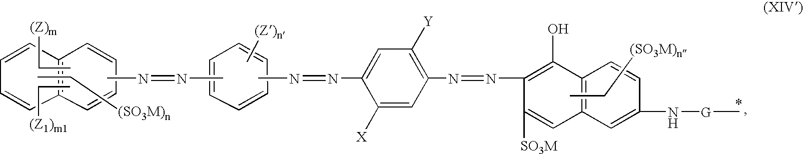

Mixtures of phthalocyanine compounds together with at least one azo dye and at least one triphenylmethane dye are, moreover, also suitable.

Further suitable phthalocyanine compounds are those which comprise at least one phthalocyanine to which at least one dye is covalently bonded. Preference is given to the use of compounds of the general structure (8a) and/or (8b)

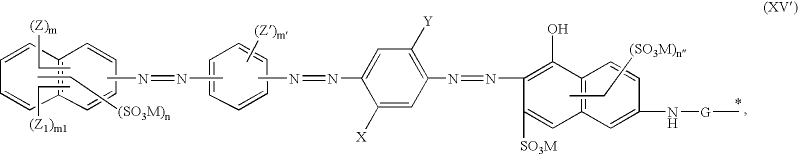

wherein
PC is the phthalocyanine system,
Me is Zn; Ca; Mg; Na; K; Al-Z₃; Si(IV)-(Z₃)₂; Ti(IV)-(Z₃)₂; Ge(IV)-(Z₃)₂; Ga(III)-Z₃; Zr(IV)-(Z₃)₂; In(III)-Z₃ or Sn(IV)-(Z₃)₂,
Z₃ is an alkanolate ion; a hydroxyl ion; R₂₅COO⁻; ClO₄⁻; BF₄⁻; PF₆⁻; R₂₅SO₃⁻; SO₄²⁻; NO₃⁻; F⁻; Cl⁻; Br⁻; I⁻; or a citrate, tartrate or oxalate ion,
   wherein R₂₅ is hydrogen; unsubstituted C₁-C₁₈alkyl; or C₁-C₁₈alkyl which is substituted by at least one substituent from the group hydroxy, cyano, carboxy, SO₃H, —NH₂, C₁-C₆alkoxy-carbonyl, C₁-C₆alkoxy, phenyl, naphthyl and pyridyl; unsubstituted aryl; or aryl which is substituted by at least one substituent from the group hydroxy, cyano, carboxy, SO₃H, —NH₂, C₁-C₆alkoxy-carbonyl, C₁-C₆alkoxy and C₁-C₄alkyl,
r″ is 0; 1; 2; 3 or 4,
r′″ is 1; 2; 3 or 4,
each Q″, independently of any other(s), is a sulfo or carboxy group or a radical of formula —SO₂X₅—R₂₆—X₆⁺; —O—R₂₆—X₆⁺; or —(CH₂)ₜ—Y₄⁺,
   wherein
   R₂₆ is straight-chain or branched C₁-C₈alkylene; 1,3-phenylene or 1,4-phenylene,
   X₅ is —NH— or —N(C₁-C₅alkyl)-,
   X₆+ is a radical of formula

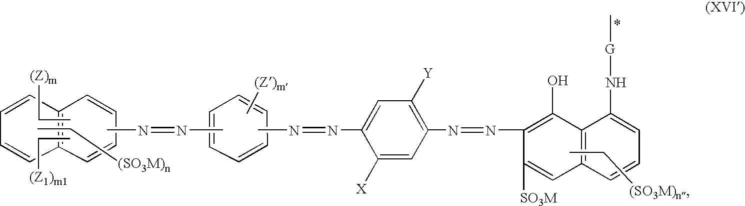

and, when R₂₆═C₁-C₈alkylene, X₆⁺ may also be

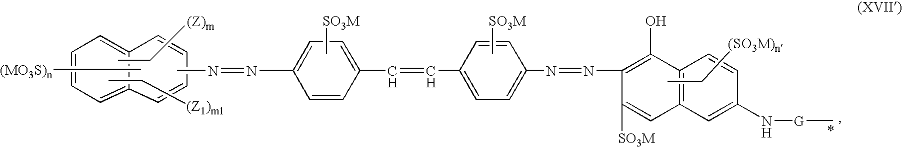

Y₄⁺ is a radical of formula

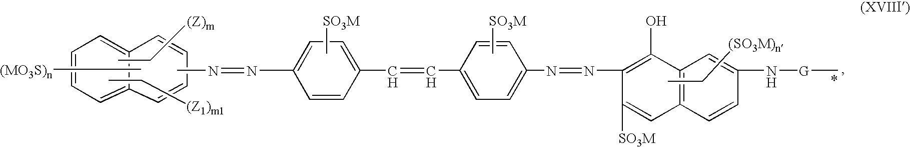

t′ is 0 or 1,
in which above formulae
R₂₇ and R₂₈ are each independently of the other C₁-C₆alkyl,
R₂₉ is C₁-C₆alkyl; C₅-C₇cycloalkyl or NR₃₂R₃₃,
R₃₀ and R₃, are each independently of the other C₁-C₅alkyl,
R₃₂ and R₃₃ are each independently of the other hydrogen or C₁-C₅alkyl,
R₃₄ and R₃₅ are each independently of the other unsubstituted C₁-C₆alkyl, or C₁-C₆-alkyl which is substituted by at least one substituent from the group hydroxy, cyano, carboxy, SO₃H, —NH₂, C₁-C₆alkoxy-carbonyl, C₁-C₆alkoxy, phenyl, naphthyl and pyridyl,
u is a number from 1 to 6,
A¹ is a unit which completes an aromatic 5- to 7-membered nitrogen-containing heterocyclic ring which may contain one or two further nitrogen atoms, and
B₁ is a unit which completes a saturated 5- to 7-membered nitrogen heterocycle which may contain 1 or 2 further nitrogen, oxygen and/or sulfur atoms as ring members,
each Q′, independently of any other(s), is a moiety of formula -L-D,
   wherein L is a direct bond or a bridging group and
   D is a dye radical,
each Q′″, independently of any other(s), is hydroxy; C₁-C₂₂alkyl; branched C₃-C₂₂alkyl; C₂-C₂₂alkenyl; branched C₃-C₂₂alkenyl or a mixture thereof; C₁-C₂₂alkoxy; a sulfo or carboxy radical; a radical of formula

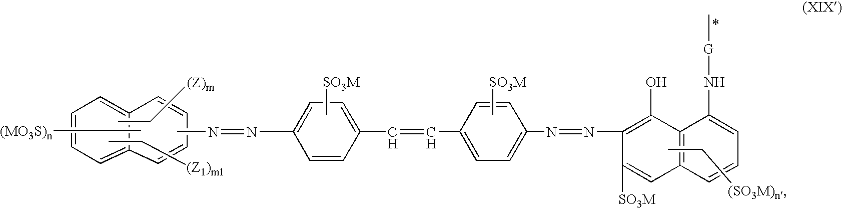

—SO₂(CH₂)ᵥ—OSO₃M; —SO₂(CH₂)ᵥ—SO₃M;

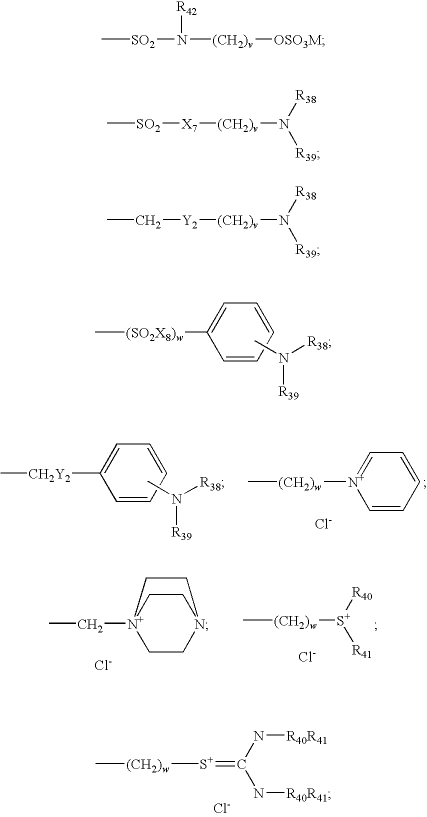

a branched alkoxy radical of formula

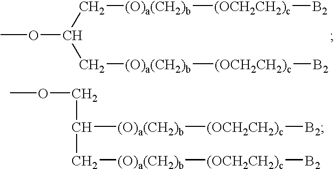

an alkylethyleneoxy unit of formula
-(T₁)_{d}-(CH₂)_{b}(OCH₂CH₂)ₐ—B₃ or an ester of formula COOR₁₈,
wherein
B₂ is hydrogen; hydroxy; C₁-C₃₀alkyl; C₁-C₃₀alkoxy; —CO₂H; —CH₂COOH; —SO₃⁻M₁; —OSO₃⁻M₁; —PO₃²⁻M₁; —OPO₃²⁻M₁; or a mixture thereof,
B₃ is hydrogen; hydroxy; —COOH; —SO₃⁻M₁; —OSO₃⁻M₁ or C₁-C₆alkoxy,
M₁ is a water-soluble cation,
T₁ is —O—; or —NH—;
X₇ and X₈ are each independently of the other —O—; —NH— or —N(C₁-C₅alkyl)-,
R₃₆ and R₃₇ are each independently of the other hydrogen; a sulfo group or a salt thereof; a carboxy group or a salt thereof, or a hydroxy group; at least one of the radicals R₃₆ and R₃₇ being a sulfo or carboxy group or a salt thereof,
Y₂ is —O—; —S—; —NH— or —N(C₁-C₅alkyl)-,
R₃₈ and R₃₉ are each independently of the other hydrogen; C₁-C₆alkyl; hydroxy-C₁-C₆alkyl; cyano-C₁-C₆alkyl; sulfo-C₁-C₆alkyl; carboxy or halo-C₁-C₆alkyl; unsubstituted phenyl or phenyl which is substituted by at least one substituent from the group halogen, C₁-C₄alkyl, C₁-C₄alkoxy, sulfo and carboxy; or R₃₈ and R₃₉, together with the nitrogen atom to which they are bonded, are a saturated 5- or 6-membered heterocyclic ring which may additionally contain a further nitrogen atom or oxygen atom as ring member,
R₄₀ and R₄₁ are each independently of the other C₁-C₆alkyl or aryl-C₁-C₆alkyl radicals,
R₄₂ is hydrogen, unsubstituted C₁-C₆alkyl, or C₁-C₆alkyl which is substituted by at least one substituent from the group halogen, hydroxy, cyano, SO₃H, —NH₂, phenyl, carboxy, C₁-C₆alkoxy-carbonyl and C₁-C₆alkoxy,
R⁴³ is C₁-C₂₂alkyl; branched C₃-C₂₂alkyl; C₂-C₂₂alkenyl or branched C₃-C₂₂-alkenyl; C₃-C₂₂glycol; C₁-C₂₂alkoxy; branched C₃-C₂₂alkoxy; or a mixture thereof,
M is hydrogen; or an alkali metal ion or ammonium ion,
a is 0 or 1,
b is from 0 to 6,
c is from 0 to 100,
d is 0; or 1;
e is from 0 to 22;
v is an integer from 2 to 12;
w is 0 or 1; and
A⁻ is an organic or inorganic anion,
   and
   s in the case of monovalent anions A⁻ is equal to r and in the case of polyvalent anions is ≦r, it being necessary for Aₛ⁻ to balance the positive charge; and when r≠1, the radicals Q″ may be identical or different,
      and wherein the phthalocyanine ring system may also contain further solubility-imparting groups.

Halogen is fluorine, bromine or, especially, chlorine.

Especially suitable groups

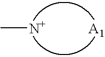

are:

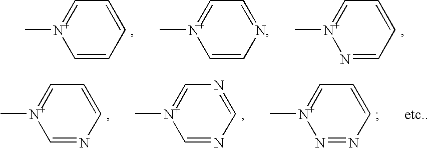

Preference is given to the group

As heterocyclic rings in the group

there likewise come into consideration the groups mentioned above, but with the bond to the remaining substituents being made by way of a carbon atom.

In all those substituents, phenyl, naphthyl and aromatic heterocyclic rings may be substituted by one or two further radicals, for example by C₁-C₆alkyl, C₁-C₆alkoxy, halogen, carboxy, C₁-C₆alkoxy-carbonyl, hydroxy, amino, cyano, sulfo, sulfonamido etc.

Preference is given to a substituent from the group C₁-C₆alkyl, C₁-C₆alkoxy, halogen, carboxy, C₁-C₆alkoxy-carbonyl and hydroxy.

Especially suitable groups

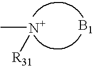

are:
etc., wherein
B₁ and R₃₁ are as defined hereinbefore.

All above-mentioned nitrogen heterocycles may, in addition, be substituted by alkyl groups, either at a carbon atom or at a further nitrogen atom located in the ring. The alkyl group is preferably a methyl group.

Aₛ⁻ in formula (8a) denotes, as counterion to the positive charge of the remainder of the molecule, any desired anion. It is generally introduced in the process of manufacture (quaternisation), in which case it preferably is an alkanolate ion; a hydroxyl ion; R₂₅COO⁻; ClO₄⁻; BF₄⁻; PF₆⁻; R₂₅SO₃⁻; SO₄²⁻; NO₃⁻; F⁻; Cl⁻; Br⁻; I⁻; or a citrate, tartrate or oxalate ion (wherein R₂₅ is hydrogen; or unsubstituted C₁-C₁₈alkyl; or C₁-C₁₈alkyl which is substituted by at least one substituent from the group hydroxy, cyano, carboxy, SO₃H, —NH₂, C₁-C₆alkoxy-carbonyl, C₁-C₆alkoxy, phenyl, naphthyl and pyridyl; unsubstituted aryl; or aryl which is substituted by at least one substituent from the group hydroxy, cyano, carboxy, —SO₃H, —NH₂, C₁-C₆alkoxy-carbonyl, C₁-C₆alkoxy and C₁-C₄alkyl). Among the arylsulfate ions mention should be made of the phenylsulfonate, p-tolylsulfonate and p-chlorophenylsulfonate ions. It is also possible, however, for any other anion to function as the anion, since the anions can readily be interchanged in known manner; accordingly, Aₛ⁻ may also be a sulfate, sulfite, carbonate, phosphate, nitrate, acetate, oxalate, citrate or lactate ion or another anion of an organic carboxylic acid. In the case of monovalent anions, the index s is equal to r. In the case of polyvalent anions, s assumes a value ≦r but must be such, depending on the conditions, that it exactly balances the positive charge of the remainder of the molecule.

C₁-C₆Alkyl and C₁-C₆alkoxy are straight-chain or branched alkyl and alkoxy radicals, respectively, for example methyl, ethyl, n-propyl, isopropyl, n-butyl, sec-butyl, tert-butyl, amyl, isoamyl, tert-amyl or hexyl, and methoxy, ethoxy, n-propoxy, isopropoxy, n-butoxy, sec-butoxy, tert-butoxy, amyloxy, isoamyloxy, tert-amyloxy or hexyloxy, respectively.

C₂-C₂₂Alkenyl is, for example, allyl, methallyl, isopropenyl, 2-butenyl, 3-butenyl, isobutenyl, n-penta-2,4-dienyl, 3-methyl-but-2-enyl, n-oct-2-enyl, n-dodec-2-enyl, isododecenyl, n-dodec-2-enyl or n-octadec-4-enyl.

Me preferably is Zn, AlZ₂, Si(IV)-(Z₂)₂ or Ti(IV)-(Z₂)₂, wherein Z₂ is as defined hereinbefore.

Me especially is Zn, AlZ₂, Si(IV)-(Z₂)₂ or Ti(IV)-(Z₂)₂, wherein Z₂ is chlorine, fluorine, bromine or hydroxy.

R₂₆ preferably is branched or unbranched C₁-C₄alkylene; or 1,3- or 1,4-phenylene.

X₅ preferably is —NH— or —N(C₁-C₄alkyl)-.

R₂₇ and R₂₈ preferably are each independently of the other C₁-C₄alkyl.

R₂₉ preferably is C₁-C₄alkyl; pentyl; hexyl or NR₃₂R₃₃.

R₃₀ and R₃₁ preferably are each independently of the other C₁-C₄alkyl.

R₃₂ and R₃₃ preferably are each independently of the other hydrogen or C₁-C₄alkyl.

R₃₄ and R₃₅ preferably are each independently of the other unsubstituted C₁-C₄alkyl, or

C₁-C₄alkyl which is substituted by at least one substituent from the group hydroxy, cyano,

SO₃H, —NH₂, carboxy, C₁-C₄alkoxy-carbonyl, C₁-C₄alkoxy, phenyl, naphthyl and pyridyl.

u preferably is 1; 2; 3 or 4.

A₁ preferably is a unit which completes a pyrrole, imidazole, pyridine, pyrazine, pyrimidine or pyridazine ring.

B₁ preferably is a unit which completes a morpholine, pyrrolidine, piperazine or piperidine ring.

L preferably is a direct bond; —SO₂—; —(CH₂)₁₋₄—SO₂—; —O—; —(CH₂)₁₋₄—O—; —OR₄₄—; —(CH₂)₁₋₄—OR₄₄—; —OR₄₄O—; —(CH₂)₁₋₄—OR₄₄O—; —OR₄₄N(R₄₅)—; —(CH₂)₁₋₄—OR₄₄N(R₄₅)—; —N(R₄₅)—; —(CH₂)₁₋₄—N(R₄₅)—; —(CH₂CH₂O—)ₙ—; —C(O)—; —(CH₂)₁₋₄—C(O)—; —C(O)N(R₄₅)—; —(CH₂)₁₋₄—C(O)N(R₄₅)—; —N(R₄₅)C(O)—; —(CH₂)₁₋₄—N(R₄₅)C(O)—; —OC(O)—; —(CH₂)₁₋₄—OC(O)—; —C(O)O—; —(CH₂)₁₋₄—C(O)O—; —S—; —(CH₂)₁₋₄—S—; unsubstituted, straight-chain or branched C₁-C₁₈alkylene;
straight-chain or branched C₁-C₁₈alkylene which is substituted by at least one substituent from the group hydroxy, cyano, —SO₃H, —NH₂, carboxy, C₁-C₄alkoxy-carbonyl, C₁-C₄alkoxy, phenyl, naphthyl and pyridyl;
unsubstituted C₅-C₁₈arylene;
C₅-C₁₈arylene which is substituted by at least one substituent from the group hydroxy, cyano, carboxy, C₁-C₄alkoxy-carbonyl, C₁-C₄alkoxy and C₁-C₄alkyl;
unsubstituted straight-chain or branched C₁-C₁₈alkylene-C₅-C₁₈aryl; straight-chain or branched C₁-C₁₈alkylene-C₅-C₁₈aryl which is substituted by at least one substituent from the group hydroxy, cyano, —SO₃H, —NH₂, carboxy, C₁-C₄alkoxy-carbonyl, C₁-C₄alkoxy, C₁-C₄alkyl, phenyl, naphthyl and pyridyl;
unsubstituted straight-chain or branched C₅-C₁₈arylene-C₁-C₁₈alkyl or straight-chain or branched C₅-C₁₈arylene-C₁-C₁₈alkyl which is substituted by at least one substituent from the group hydroxy, cyano, —SO₃H, —NH₂, carboxy, C₁-C₄alkoxy-carbonyl, C₁-C₄alkoxy, C₁-C₄alkyl, phenyl, naphthyl and pyridyl,

wherein
R₄₄ is unsubstituted straight-chain or branched C₁-C₁₈alkylene; straight-chain or branched C₁-C₁₈alkylene which is substituted by at least one substituent from the group hydroxy, cyano, —SO₃H, —NH₂, carboxy, C₁-C₄alkoxy-carbonyl, C₁-C₄-alkoxy, phenyl, naphthyl and pyridyl; unsubstituted C₅-C₁₈arylene; C₅-C₁₈arylene which is substituted by at least one substituent from the group hydroxy, cyano, —SO₃H, —NH₂, carboxy, C₁-C₄alkoxy-carbonyl, C₁-C₄alkoxy and C₁-C₄alkyl; unsubstituted straight-chain or branched C₁-C₁₈alkylene-C₅-C₁₈aryl; straight-chain or branched C₁-C₁₈alkylene-C₅-C₁₈aryl which is substituted by at least one substituent from the group hydroxy, cyano, SO₃H, —NH₂, carboxy, C₁-C₄alkoxy-carbonyl, C₁-C₄alkoxy, C₁-C₄alkyl, phenyl, naphthyl and pyridyl; unsubstituted straight-chain or branched C₅-C₁₈arylene-C₁-C₁₈alkyl, or straight-chain or branched C₅-C₁₈arylene-C₁-C₁₈alkyl which is substituted by at least one substituent from the group hydroxy, cyano, carboxy, C₁-C₄alkoxy-carbonyl, C₁-C₄alkoxy, C₁-C₄alkyl, phenyl, naphthyl and pyridyl,
R₄₅ is unsubstituted straight-chain or branched C₁-C₁₈alkyl; straight-chain or branched C₁-C₁₈alkyl which is substituted by at least one substituent from the group hydroxy, cyano, —SO₃H, —NH₂, carboxy, C₁-C₄alkoxy-carbonyl, C₁-C₄-alkoxy, phenyl, naphthyl and pyridyl; unsubstituted C₅-C₁₈aryl; C₅-C₁₈aryl which is substituted by at least one substituent from the group hydroxy, cyano, —SO₃H, —NH₂, carboxy, C₁-C₄alkoxy-carbonyl, C₁-C₄alkoxy and C₁-C₄alkyl; unsubstituted straight-chain or branched C₁-C₁₈alkoxy, or straight-chain or branched C₁-C₁₈-alkoxy which is substituted by at least one substituent from the group hydroxy, cyano, —SO₃H, —NH₂, carboxy, C₁-C₄alkoxy-carbonyl, C₁-C₄alkyl, phenyl, naphthyl and pyridyl,
D is the radical of an azo, diazo, trisazo, polyazo, azomethine, methine, anthraquino, dioxazine, phenazine, diphenylmethane, triphenylmethane, carbonyl, xanthene or thioxanthene dye.
B₂ preferably is hydrogen; hydroxy; C₁-C₁₈alkyl; C₁-C₁₈alkoxy; —CO₂H; —CH₂COOH; —SO₃⁻M₁; —OSO₃⁻M₁; —PO₃²⁻M₁; —OPO₃²⁻M₁; or a mixture thereof, wherein M¹ is as defined hereinbefore. B₃ preferably is hydrogen; hydroxy; —COOH; —SO₃⁻M₁; —OSO₃⁻M₁ or C₁-C₄alkoxy.
M₁ preferably is hydrogen; or an alkali metal ion or ammonium ion.
X₇ and X₈ preferably are each independently of the other —O—; —NH— or —N(C₁-C₄alkyl)-.
Y₂ preferably is —O—; —S—; —NH— or —N(C₁-C₄alkyl)-.
R₃₈ and R₃₉ preferably are each independently of the other hydrogen; C₁-C₄alkyl; hydroxy-C₁-C₄alkyl; cyano-C₁-C₄alkyl; sulfo-C₁-C₄alkyl; carboxy-C₁-C₄alkyl or halo-C₁-C₄alkyl; unsubstituted phenyl or halo-, C₁-C₄alkyl- or C₁-C₄alkoxy-substituted phenyl; sulfo or carboxy, or R₁₃ and R₁₄, together with the nitrogen atom to which they are bonded, form a morpholine, piperazine or piperidine ring.
R₄₀ and R₄₁ preferably are each independently of the other a C₁-C₄alkyl or aryl-C₁-C₄alkyl radical.
R₄₂ preferably is hydrogen; unsubstituted C₁-C₄alkyl, or C₁-C₄alkyl which is substituted by at least one substituent from the group halogen, hydroxy, cyano, SO₃H, —NH₂, phenyl, carboxy, C₁-C₄alkoxy-carbonyl and C₁-C₆alkoxy.
R₄₃ preferably is C₁-C₁₀alkyl; branched C₃-C₁₀alkyl; C₁-C₁₀alkenyl or branched C₃-C₁₀alkenyl; C₃-C₂₂ glycol; C₁-C₁₀alkoxy; branched C₃-C₁₀alkoxy; or a mixture thereof.
M preferably is hydrogen; Na⁺; K+ or an ammonium ion.
Z₃⁻ preferably is a chlorine, bromine, alkylsulfate or aralkylsulfate ion.
a preferably is 0 or 1.
b preferably is from 0 to 6.
c preferably is from 0 to 100.
d preferably is 0 or 1.
e preferably is from 0 to 22.
v preferably is an integer from 2 to 12.
w preferably is 0 or 1.
A⁻ preferably is a halogen, alkylsulfate or arylsulfate ion; a sulfate, sulfite, carbonate, phosphate, nitrate, acetate, oxalate, citrate or lactate ion or another anion of an organic carboxylic acid.

### Preferred Dye Radicals D Correspond to the Following Formulae (I)-(XXV):

wherein
* denotes the bond to the bridging group L,
X and Y are each independently of the other hydrogen; —SO₃M; unsubstituted straight-chain or branched C₁-C₄alkyl; straight-chain or branched C₁-C₄alkyl which is substituted by at least one substituent from the group hydroxy, cyano, —SO₃H, —NH₂, carboxy, C₁-C₄alkoxy-carbonyl, C₁-C₄alkoxy, phenyl, naphthyl and pyridyl; unsubstituted straight-chain or branched C₁-C₄alkoxy; straight-chain or branched C₁-C₄alkoxy which is substituted by at least one substituent from the group hydroxy, cyano, —SO₃H, —NH₂, carboxy, C₁-C₄alkoxy-carbonyl, C₁-C₄alkyl, phenyl, naphthyl and pyridyl; —COOH or —COOC₁-C₄alkyl;
R_{α} is hydrogen; unsubstituted straight-chain or branched C₁-C₄alkyl; straight-chain or branched C₁-C₄alkyl which is substituted by at least one substituent from the group hydroxy, cyano, —SO₃H, —NH₂, carboxy, C₁-C₄alkoxy-carbonyl, C₁-C₄alkoxy, phenyl, naphthyl and pyridyl; unsubstituted aryl, or aryl which is substituted by at least one substituent from the group hydroxy, cyano, —SO₃H, —NH₂, carboxy, C₁-C₄alkoxy-carbonyl, C₁-C₄alkoxy and C₁-C₄alkyl,
each R_{β}, independently of the other, is hydrogen; —SO₃M; unsubstituted straight-chain or branched C₁-C₄alkyl; straight-chain or branched C₁-C₄alkyl which is substituted by at least one substituent from the group hydroxy, cyano, —SO₃H, —NH₂, carboxy, C₁-C₄alkoxy-carbonyl, C₁-C₄alkoxy, phenyl, naphthyl and pyridyl; unsubstituted straight-chain or branched C₁-C₄alkoxy, or straight-chain or branched C₁-C₄alkoxy which is substituted by at least one substituent from the group hydroxy, cyano, —SO₃H, —NH₂, carboxy, C₁-C₄alkoxy-carbonyl, C₁-C₄alkyl, phenyl, naphthyl and pyridyl,
Z is unsubstituted straight-chain or branched C₁-C₄alkyl; straight-chain or branched C₁-C₄alkyl which is substituted by at least one substituent from the group hydroxy, cyano, —SO₃H, —NH₂, carboxy, C₁-C₄alkoxy-carbonyl, C₁-C₄alkoxy, phenyl, naphthyl and pyridyl; unsubstituted straight-chain or branched C₁-C₄alkoxy, or straight-chain or branched C₁-C₄alkoxy which is substituted by at least one substituent from the group hydroxy, cyano, —SO₃H, —NH₂, carboxy, C₁-C₄alkoxy-carbonyl, C₁-C₄alkyl, phenyl, naphthyl and pyridyl; halogen; —OH; —NO₂; —COOH; —COOC₁-C₄alkyl; —NH₂; —NHC₁-C₄alkyl wherein the alkyl group may be substituted by at least one substituent from the group —OH, —NH₂, C₁-C₄alkyl, —CN and —COOH; —N(C₁-C₄alkyl)C₁-C₄alkyl wherein the alkyl groups each independently of the other may be substituted by at least one substituent from the group —OH, —NH₂, C₁-C₄alkyl, —CN and —COOH; —NH-aryl; —NH-aryl wherein the aryl is substituted by at least one substituent from the group hydroxy, cyano, —SO₃H, —NH₂, carboxy, C₁-C₄alkoxy-carbonyl, C₁-C₄alkyl and C₁-C₄alkoxy; —NHCOC₁-C₄alkyl or —NHCOOC₁-C₄alkyl,
Z′ is —SO₃M; unsubstituted straight-chain or branched C₁-C₄alkyl; straight-chain or branched C₁-C₄alkyl which is substituted by at least one substituent from the group hydroxy, cyano, —SO₃H, —NH₂, carboxy, C₁-C₄alkoxy-carbonyl, C₁-C₄alkoxy, phenyl, naphthyl and pyridyl; unsubstituted straight-chain or branched C₁-C₄alkoxy, or straight-chain or branched C₁-C₄alkoxy which is substituted by at least one substituent from the group hydroxy, cyano, —SO₃H, —NH₂, carboxy, C₁-C₄alkoxy-carbonyl, C₁-C₄alkyl, phenyl, naphthyl and pyridyl; halogen; —OH; —NO₂; —COOH; —COOC₁-C₄alkyl; —NH₂; —NHC₁-C₄alkyl wherein the alkyl group may be substituted by at least one substituent from the group —OH, —NH₂, C₁-C₄alkyl, —CN and —COOH; —N(C₁-C₄alkyl)C₁-C₄alkyl wherein the alkyl groups each independently of the other may be substituted by at least one substituent from the group —OH, —NH₂, C₁-C₄alkyl, —CN and —COOH; —NH-aryl; —NH-aryl wherein the aryl is substituted by at least one substituent from the group hydroxy, cyano, —SO₃H, —NH₂, carboxy, C₁-C₄alkoxy-carbonyl, C₁-C₄alkyl and C₁-C₄alkoxy; —NHCOC₁-C₄alkyl or —NHCOOC₁-C₄alkyl,
Z₁ is unsubstituted straight-chain or branched C₁-C₄alkyl; straight-chain or branched C₁-C₄alkyl which is substituted by at least one substituent from the group hydroxy, cyano, —SO₃H, —NH₂, carboxy, C₁-C₄alkoxy-carbonyl, C₁-C₄alkoxy, phenyl, naphthyl and pyridyl; unsubstituted straight-chain or branched C₁-C₄alkoxy, or straight-chain or branched C₁-C₄alkoxy which is substituted by at least one substituent from the group hydroxy, cyano, —SO₃H, —NH₂, carboxy, C₁-C₄alkoxy-carbonyl, C₁-C₄alkyl, phenyl, naphthyl and pyridyl; halogen; —OH; —NO₂; —COOH; COOC₁-C₄alkyl; —NH₂; —NHC₁-C₄alkyl wherein the alkyl group may be substituted by at least one substituent from the group —OH, —NH₂, C₁-C₄alkyl, —CN and —COOH; —N(C₁-C₄alkyl)C₁-C₄alkyl wherein the alkyl groups each independently of the other may be substituted by at least one substituent from the group —OH, —NH₂, C₁-C₄alkyl, —CN and —COOH; —NH-aryl; —NH-aryl wherein the aryl is substituted by at least one substituent from the group hydroxy, cyano, —SO₃H, —NH₂, carboxy, C₁-C₄alkoxy-carbonyl, C₁-C₄alkyl and C₁-C₄alkoxy; —NHCOC₁-C₄alkyl or —NHCOOC₁-C₄alkyl,
G is a direct bond; —COOC₁-C₄alkylene; unsubstituted arylene; arylene which is substituted by at least one substituent from the group hydroxy, cyano, —NO₂, —SO₃H, —NH₂, carboxy, C₁-C₄alkoxy-carbonyl, C₁-C₄alkoxy and C₁-C₄alkyl; unsubstituted C₁-C₄alkylene, or C₁-C₄alkylene which is substituted by at least one substituent from the group hydroxy, cyano, —NO₂, —SO₃H, —NH₂, carboxy, C₁-C₄alkoxy-carbonyl, C₁-C₄alkoxy and C₁-C₄alkyl,
n is 0; 1 or 2,
n′ is 0; 1 or 2,
n″ is 0 or 1,
m is 0; 1 or 2,
m₁ is 0; 1 or 2,
each M, independently of any other(s), is hydrogen; or an alkali metal ion or ammonium ion.

Especially preferred dye radicals D correspond to the following formulae (I′)-(XIX′):

wherein
* denotes the bond to the bridging group L,
X and Y are each independently of the other unsubstituted straight-chain or branched C₁-C₄alkyl; straight-chain or branched C₁-C₄alkyl which is substituted by at least one substituent from the group hydroxy, cyano, —SO₃H, —NH₂, carboxy, C₁-C₂alkoxy-carbonyl, C₁-C₂alkoxy, phenyl, naphthyl and pyridyl; or unsubstituted straight-chain or branched C₁-C₄alkoxy,
Z is unsubstituted C₁-C₂alkyl; C₁-C₂alkyl which is substituted by at least one substituent from the group hydroxy, cyano, —SO₃H, —NH₂, carboxy, C₁-C₂alkoxy-carbonyl, C₁-C₂alkoxy, phenyl, naphthyl and pyridyl; unsubstituted straight-chain or branched C₁-C₄alkoxy; —OH; —NO₂; —COOH; or —COOC₁-C₂alkyl,
Z₁ —OH; —NO₂; —COOH or —COOC₁-C₄alkyl,
G is a direct bond; unsubstituted arylene; arylene which is substituted by at least one substituent from the group hydroxy, cyano, —NO₂, —SO₃H, —NH₂, carboxy, C₁-C₂-alkoxy-carbonyl, C₁-C₂alkoxy and C₁-C₂alkyl; unsubstituted C₁-C₄alkylene, or C₁-C₄alkylene which is substituted by at least one substituent from the group hydroxy, cyano, —NO₂, —SO₃H, —NH₂, carboxy, C₁-C₂alkoxy-carbonyl, C₁-C₂alkoxy and C₁-C₂alkyl,
n is 0 or 1,
m is 0 or 1,
m₁ is 0 or 1,
each M, independently of any other, is hydrogen; Na⁺ or K⁺;
   wherein
* denotes the bond to the bridging group L,
X and Y are each independently of the other unsubstituted straight-chain or branched C₁-C₄alkyl; straight-chain or branched C₁-C₄alkyl which is substituted by at least one substituent from the group hydroxy, cyano, —SO₃H, —NH₂, carboxy, C₁-C₂alkoxy-carbonyl, C₁-C₂alkoxy, phenyl, naphthyl and pyridyl; or unsubstituted straight-chain or branched C₁-C₄alkoxy,
Z is unsubstituted C₁-C₂alkyl; C₁-C₂alkyl which is substituted by at least one substituent from the group hydroxy, cyano, —SO₃H, —NH₂, carboxy, C₁-C₂alkoxy-carbonyl, C₁-C₂alkoxy, phenyl, naphthyl and pyridyl; unsubstituted straight-chain or branched C₁-C₄alkoxy; —OH; —NO₂; —COOH; or —COOC₁-C₂alkyl,
Z₁ is —OH; —NO₂; —COOH or —COOC₁-C₂alkyl,
G is a direct bond; unsubstituted arylene; arylene which is substituted by at least one substituent from the group hydroxy, cyano, —NO₂, —SO₃H, —NH₂, carboxy, C₁-C₂alkoxy-carbonyl, C₁-C₂alkoxy and C₁-C₂alkyl; unsubstituted C₁-C₄alkylene, or C₁-C₄alkylene which is substituted by at least one substituent from the group hydroxy, cyano, —NO₂, —SO₃H, —NH₂, carboxy, C₁-C₂alkoxy-carbonyl, C₁-C₂alkoxy and C₁-C₂alkyl,
n is 0 or 1,
n″ is 0 or 1,
m is 0 or 1,
m₁ is 0 or 1,
each M, independently of any other, is hydrogen; Na⁺ or K⁺;
   wherein
* denotes the bond to the bridging group L,
X and Y are each independently of the other unsubstituted straight-chain or branched C₁-C₄alkyl; straight-chain or branched C₁-C₄alkyl which is substituted by at least one substituent from the group hydroxy, cyano, —SO₃H, —NH₂, carboxy, C₁-C₂alkoxy-carbonyl, C₁-C₂alkoxy, phenyl, naphthyl and pyridyl; or unsubstituted straight-chain or branched C₁-C₄alkoxy,
Z is unsubstituted C₁-C₂alkyl; C₁-C₂alkyl which is substituted by at least one substituent from the group hydroxy, cyano, —SO₃H, —NH₂, carboxy, C₁-C₂alkoxy-carbonyl, C₁-C₂alkoxy, phenyl, naphthyl and pyridyl; unsubstituted straight-chain or branched C₁-C₄alkoxy; —OH; —NO₂; —COOH; or —COOC₁-C₂alkyl,
Z₁ is —OH; N—O₂; —COOH or —COOC₁-C₄alkyl,

G is a direct bond; unsubstituted arylene; arylene which is substituted by at least one substituent from the group hydroxy, cyano, —NO₂, —SO₃H, —NH₂, carboxy, C₁-C₂-alkoxy-carbonyl, C₁-C₂alkoxy and C₁-C₂alkyl; unsubstituted C₁-C₄alkylene, or C₁-C₄alkylene which is substituted by at least one substituent from the group hydroxy, cyano, —NO₂, —SO₃H, —NH₂, carboxy, C₁-C₂alkoxy-carbonyl, C₁-C₂alkoxy and C₁-C₂alkyl,
n is 0 or 1,
m is 0 or 1,
m₁ is 0 or 1,
   each M, independently of any other, is hydrogen; Na⁺ or K⁺;
   wherein
* denotes the bond to the bridging group L,
Z is unsubstituted C₁-C₂alkyl; C₁-C₂alkyl which is substituted by at least one substituent from the group hydroxy, cyano, —SO₃H, —NH₂, carboxy, C₁-C₂alkoxy-carbonyl, C₁-C₂alkoxy, phenyl, naphthyl and pyridyl; straight-chain or branched C₁-C₄alkoxy; —OH; —NO₂; —COOH; or —COOC₁-C₂alkyl,
Z₁ is —OH; —NO₂; —COOH or —COOC₁-C₂alkyl,
G is a direct bond or COOC₁-C₂alkylene,
n is 0 or 1,
m is 0 or 1,
m₁ is 0 or 1,
each M, independently of the other(s), is hydrogen; Na⁺ or K⁺;
   wherein
* denotes the bond to the bridging group L,
Z is unsubstituted C₁-C₂alkyl; C₁-C₂alkyl which is substituted by at least one substituent from the group hydroxy, cyano, —SO₃H, —NH₂, carboxy, C₁-C₂alkoxy-carbonyl, C₁-C₂alkoxy, phenyl, naphthyl and pyridyl; unsubstituted straight-chain or branched C₁-C₄alkoxy; —OH; —NO₂; —COOH; or —COOC₁-C₂alkyl,
G is a direct bond or —COOC₁-C₂alkylene,
n is 0 or 1,
n″ is 0 or 1,
m is 0 or 1,
each M, independently of the other(s), is hydrogen; Na⁺ or K⁺;
   wherein
* denotes the bond to the bridging group L,
Z is unsubstituted C₁-C₂alkyl; C₁-C₂alkyl which is substituted by at least one substituent from the group hydroxy, cyano, —SO₃H, —NH₂, carboxy, C₁-C₂alkoxy-carbonyl, C₁-C₂alkoxy, phenyl, naphthyl and pyridyl; unsubstituted straight-chain or branched C₁-C₄alkoxy; —OH; —NO₂; —COOH; or —COOC₁-C₂alkyl,
G is a direct bond or —COOC₁-C₂alkylene,
n is 0 or 1,
n″ is 0 or 1,
m is 0 or 1,
each M, independently of the other(s), is hydrogen; Na⁺ or K⁺;
   wherein
* denotes the bond to the bridging group L,
X is hydrogen; —SO₃M; unsubstituted straight-chain or branched C₁-C₂alkyl; straight-chain or branched C₁-C₂alkyl which is substituted by at least one substituent from the group hydroxy, cyano, —SO₃H and —NH₂; unsubstituted straight-chain or branched C₁-C₂alkoxy, or straight-chain or branched C₁-C₂alkoxy which is substituted by at least one substituent from the group hydroxy, cyano, —SO₃H and —NH₂,
Y is —SO₃M; unsubstituted straight-chain or branched C₁-C₂alkyl; straight-chain or branched C₁-C₂alkyl which is substituted by at least one substituent from the group hydroxy, cyano, —SO₃H and —NH₂; unsubstituted straight-chain or branched C₁-C₂alkoxy, or straight-chain or branched C₁-C₂alkoxy which is substituted by at least one substituent from the group hydroxy, cyano, —SO₃H and —NH₂,
Z is —NH₂ or —NHCOOC₁-C₄alkyl,
Z₁ is —OH or —NHCOC₁-C₄alkyl,
G is a direct bond; —COOC₁-C₂alkylene; unsubstituted arylene; arylene which is substituted by at least one substituent from the group hydroxy, cyano, —NO₂, —SO₃H, —NH₂, carboxy, C₁-C₄alkoxy-carbonyl, C₁-C₄alkoxy and C₁-C₄alkyl; unsubstituted C₁-C₂alkylene, or C₁-C₂alkylene which is substituted by at least one substituent from the group hydroxy, cyano, —NO₂, —SO₃H, —NH₂, carboxy, C₁-C₄alkoxy-carbonyl, C₁-C₄alkoxy and C₁-C₄alkyl,
n is 1 or 2,
n″ is 0 or 1,
m is 0 or 1,
m₁ is 0 or 1,
each M, independently of any other(s), is hydrogen; Na⁺ or K⁺;
   wherein
* denotes the bond to the bridging group L,
X is hydrogen; —SO₃M; unsubstituted straight-chain or branched C₁-C₂alkyl; straight-chain or branched C₁-C₂alkyl which is substituted by at least one substituent from the group hydroxy, cyano, —SO₃H and —NH₂; unsubstituted straight-chain or branched C₁-C₂alkoxy, or straight-chain or branched C₁-C₂alkoxy which is substituted by at least one substituent from the group hydroxy, cyano, —SO₃H and —NH₂,
Y is —SO₃M; unsubstituted straight-chain or branched C₁-C₂alkyl; straight-chain or branched C₁-C₂alkyl which is substituted by at least one substituent from the group hydroxy, cyano, —SO₃H and —NH₂; unsubstituted straight-chain or branched C₁-C₂-alkoxy, or straight-chain or branched C₁-C₂alkoxy which is substituted by at least one substituent from the group hydroxy, cyano, —SO₃H and —NH₂,
Z is —NH₂ or —NHCOOC₁-C₄alkyl,
Z₁ is —OH or —NHCOC₁-C₄alkyl,
G is a direct bond; —COOC₁-C₂alkylene; unsubstituted arylene; arylene which is substituted by at least one substituent from the group hydroxy, cyano, —NO₂, —SO₃H, —NH₂, carboxy, C₁-C₄alkoxy-carbonyl, C₁-C₄alkoxy and C₁-C₄alkyl; unsubstituted C₁-C₂alkylene, or C₁-C₂alkylene which is substituted by at least one substituent from the group hydroxy, cyano, —NO₂, —SO₃H, —NH₂, carboxy, C₁-C₄alkoxy-carbonyl, C₁-C₄alkoxy and C₁-C₄alkyl,
n is 1 or 2,
n″ is 0 or 1,
m is 0 or 1,
m₁ is 0 or 1,
each M, independently of the other(s), is hydrogen; Na⁺ or K⁺;
   wherein
* denotes the bond to the bridging group L,
X is hydrogen; SO₃M; unsubstituted straight-chain or branched C₁-C₂alkyl; straight-chain or branched C₁-C₂alkyl which is substituted by at least one substituent from the group hydroxy, cyano, —SO₃H and —NH₂; unsubstituted straight-chain or branched C₁-C₂alkoxy, or straight-chain or branched C₁-C₂alkoxy which is substituted by at least one substituent from the group hydroxy, cyano, —SO₃H and —NH₂,
Y is —SO₃M; unsubstituted straight-chain or branched C₁-C₂alkyl; straight-chain or branched C₁-C₂alkyl which is substituted by at least one substituent from the group hydroxy, cyano, —SO₃H and —NH₂; unsubstituted straight-chain or branched C₁-C₂-alkoxy, or straight-chain or branched C₁-C₂alkoxy which is substituted by at least one substituent from the group hydroxy, cyano, —SO₃H and —NH₂,
Z is —NH₂; —NH-aryl, or —NH-aryl wherein the aryl is substituted by at least one substituent from the group —SO₃H, carboxy, C₁-C₂alkoxy-carbonyl, C₁-C₂alkyl and C₁-C₂alkoxy,
Z₁ is —OH; —NHCOC₁-C₂alkyl or —NHCOOC₁-C₂alkyl,
G is a direct bond; —COOC₁-C₂alkylene; unsubstituted arylene; arylene which is substituted by at least one substituent from the group hydroxy, cyano, —NO₂, —SO₃H, —NH₂, carboxy, C₁-C₂alkoxy-carbonyl, C₁-C₂alkoxy and C₁-C₂alkyl; unsubstituted C₁-C₂alkylene, or C₁-C₂alkylene which is substituted by at least one substituent from the group hydroxy, cyano, —NO₂, —SO₃H, —NH₂, carboxy, C₁-C₂alkoxy-carbonyl, C₁-C₂alkoxy and C₁-C₂alkyl,
n is 1 or 2,
n″ is 0 or 1,
m is 0 or 1,
m₁ is 0 or 1,
each M, independently of the other(s), is hydrogen; Na⁺ or K⁺;
   wherein
* denotes the bond to the bridging group L,
X is hydrogen; —SO₃M; unsubstituted straight-chain or branched C₁-C₂alkyl; straight-chain or branched C₁-C₂alkyl which is substituted by at least one substituent from the group hydroxy, cyano, —SO₃H and —NH₂; unsubstituted straight-chain or branched C₁-C₂alkoxy, or straight-chain or branched C₁-C₂alkoxy which is substituted by at least one substituent from the group hydroxy, cyano, —SO₃H and —NH₂,
Y is —SO₃M; unsubstituted straight-chain or branched C₁-C₂alkyl; straight-chain or branched C₁-C₂alkyl which is substituted by at least one substituent from the group hydroxy, cyano, —SO₃H and —NH₂; unsubstituted straight-chain or branched C₁-C₂-alkoxy, or straight-chain or branched C₁-C₂alkoxy which is substituted by at least one substituent from the group hydroxy, cyano, —SO₃H and —NH₂,
Z is —NH₂; —NH-aryl, or —NH-aryl wherein the aryl is substituted by at least one substituent from the group —SO₃H, carboxy, C₁-C₂alkoxy-carbonyl, C₁-C₂alkyl and C₁-C₂alkoxy,
Z₁ is —OH; —NHCOC₁-C₂alkyl or —NHCOOC₁-C₂alkyl,
G is a direct bond; —COOC₁-C₂alkylene; unsubstituted arylene; arylene which is substituted by at least one substituent from the group hydroxy, cyano, —NO₂, —SO₃H, —NH₂, carboxy, C₁-C₂alkoxy-carbonyl, C₁-C₂alkoxy and C₁-C₂alkyl; unsubstituted C₁-C₂alkylene, or C₁-C₂alkylene which is substituted by at least one substituent from the group hydroxy, cyano, —NO₂, —SO₃H, —NH₂, carboxy, C₁-C₂alkoxy-carbonyl, C₁-C₂alkoxy and C₁-C₂alkyl,
n is 1 or 2,
n″ is 0 or 1,
m is 0 or 1,

m₁ is 0 or 1,
each M, independently of the other(s), is hydrogen; Na⁺ or K⁺;
   wherein
* denotes the bond to the bridging group L,
Z is —NH₂; —NHCOC₁-C₄alkyl or —NHCOOC₁-C₄alkyl, Z₁ is —OH; —NH-aryl, or —NH-aryl wherein the aryl is substituted by at least one substituent from the group hydroxy, cyano, —SO₃H, —NH₂, carboxy, C₁-C₄alkoxy-carbonyl, C₁-C₄alkyl and C₁-C₄alkoxy,
G is a direct bond; —COOC₁-C₄alkylene; unsubstituted arylene; arylene which is substituted by at least one substituent from the group hydroxy, cyano, —NO₂, —SO₃H, —NH₂, carboxy, C₁-C₄alkoxy-carbonyl, C₁-C₄alkoxy and C₁-C₄alkyl; unsubstituted C₁-C₄alkylene, or C₁-C₄alkylene which is substituted by at least one substituent from the group hydroxy, cyano, —NO₂, —SO₃H, —NH₂, carboxy, C₁-C₄alkoxy-carbonyl, C₁-C₄alkoxy and C₁-C₄alkyl,
n is 1 or 2,
m is 0 or 1,
m₁ is 0 or 1,
each M, independently of the others, is hydrogen; Na⁺ or K⁺;

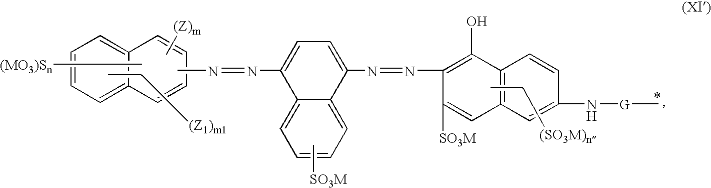

wherein
* denotes the bond to the bridging group L,
Z is —NH₂; —NHCOC₁-C₄alkyl or —NHCOOC₁-C₄alkyl, Z₁ is —OH; —NH-aryl, or —NH-aryl wherein the aryl is substituted by at least one substituent from the group hydroxy, cyano, —SO₃H, —NH₂, carboxy, C₁-C₄alkoxy-carbonyl, C₁-C₄alkyl and C₁-C₄alkoxy,
G is a direct bond; —COOC₁-C₄alkylene; unsubstituted arylene; arylene which is substituted by at least one substituent from the group hydroxy, cyano, —NO₂, —SO₃H, —NH₂, carboxy, C₁-C₄alkoxy-carbonyl, C₁-C₄alkoxy and C₁-C₄alkyl; unsubstituted C₁-C₄alkylene, or C₁-C₄alkylene which is substituted by at least one substituent from the group hydroxy, cyano, —NO₂, —SO₃H, —NH₂, carboxy, C₁-C₄alkoxy-carbonyl, C₁-C₄alkoxy and C₁-C₄alkyl,
n is 1 or 2,
m is 0 or 1,
m₁ is 0 or 1,
each M, independently of the others, is hydrogen; Na⁺ or K⁺;
   wherein
* denotes the bond to the bridging group L,
Z is —NH₂; —NHCOC₁-C₄alkyl or —NHCOOC₁-C₄alkyl,
Z₁ is —OH; —NH-aryl, or —NH-aryl wherein the aryl is substituted by at least one substituent from the group hydroxy, cyano, —SO₃H, —NH₂, carboxy, C₁-C₄alkoxy-carbonyl, C₁-C₄alkyl and C₁-C₄alkoxy,
G is a direct bond; —COOC₁-C₄alkylene; unsubstituted arylene; arylene which is substituted by at least one substituent from the group hydroxy, cyano, —NO₂, —SO₃H, —NH₂, carboxy, C₁-C₄alkoxy-carbonyl, C₁-C₄alkoxy and C₁-C₄alkyl; unsubstituted C₁-C₄alkylene, or C₁-C₄alkylene which is substituted by at least one substituent from the group hydroxy, cyano, —NO₂, —SO₃H, —NH₂, carboxy, C₁-C₄alkoxy-carbonyl, C₁-C₄alkoxy and C₁-C₄alkyl,
n is 1 or 2,
m is 0 or 1,
m₁ is 0 or 1,
each M, independently of the others, is hydrogen; Na⁺ or K⁺;
   wherein
* denotes the bond to the bridging group L,
X is hydrogen; —SO₃M; unsubstituted straight-chain or branched C₁-C₂alkyl; straight-chain or branched C₁-C₂alkyl which is substituted by at least one substituent from the group hydroxy, cyano, —SO₃H and —NH₂; unsubstituted straight-chain or branched C₁-C₂alkoxy, or straight-chain or branched C₁-C₂alkoxy which is substituted by at least one substituent from the group hydroxy, cyano, —SO₃H and —NH₂,
Y is —SO₃M; unsubstituted straight-chain or branched C₁-C₂alkyl; straight-chain or branched C₁-C₂alkyl which is substituted by at least one substituent from the group hydroxy, cyano, —SO₃H and —NH₂; unsubstituted straight-chain or branched C₁-C₂-alkoxy, or straight-chain or branched C₁-C₂alkoxy which is substituted by at least one substituent from the group hydroxy, cyano, —SO₃H and —NH₂,
Z is —NH₂; —NHCOC₁-C₄alkyl or —NHCOOC₁-C₄alkyl,
Z₁ is —OH; —NH-aryl, or —NH-aryl wherein the aryl is substituted by at least one substituent from the group hydroxy, cyano, —SO₃H, —NH₂, carboxy, C₁-C₄alkoxy-carbonyl, C₁-C₄alkyl and C₁-C₄alkoxy,
G is a direct bond; —COOC₁-C₄alkylene; unsubstituted arylene; arylene which is substituted by at least one substituent from the group hydroxy, cyano, —NO₂, —SO₃H, —NH₂, carboxy, C₁-C₄alkoxy-carbonyl, C₁-C₄alkoxy and C₁-C₄alkyl; unsubstituted C₁-C₄alkylene, or C₁-C₄alkylene which is substituted by at least one substituent from the group hydroxy, cyano, —NO₂, —SO₃H, —NH₂, carboxy, C₁-C₄alkoxy-carbonyl, C₁-C₄alkoxy and C₁-C₄alkyl,
n is 1 or 2,
m is 0 or 1,
m₁ is 0 or 1,
each M, independently of the other(s), is hydrogen; Na⁺ or K⁺;
   wherein
* denotes the bond to the bridging group L,
X is hydrogen; —SO₃M; unsubstituted straight-chain or branched C₁-C₂alkyl; straight-chain or branched C₁-C₄alkyl which is substituted by at least one substituent from the group hydroxy, cyano, SO₃H, —NH₂, carboxy, C₁-C₄alkoxy-carbonyl, C₁-C₄-alkoxy, phenyl, naphthyl and pyridyl; unsubstituted straight-chain or branched C₁-C₄alkoxy; straight-chain or branched C₁-C₄alkoxy which is substituted by at least one substituent from the group hydroxy, cyano, —SO₃H, —NH₂, carboxy, C₁-C₄alkoxy-carbonyl, C₁-C₄alkyl, phenyl, naphthyl and pyridyl; —COOH or —COOC₁-C₂alkyl,
Y is unsubstituted straight-chain or branched C₁-C₂alkyl; straight-chain or branched C₁-C₄alkyl which is substituted by at least one substituent from the group hydroxy, cyano, —SO₃H, —NH₂, carboxy, C₁-C₄alkoxy-carbonyl, C₁-C₄alkoxy, phenyl, naphthyl and pyridyl; unsubstituted straight-chain or branched C₁-C₄alkoxy; straight-chain or branched C₁-C₄alkoxy which is substituted by at least one substituent from the group hydroxy, cyano, —SO₃H, —NH₂, carboxy, C₁-C₄alkoxy-carbonyl, C₁-C₄alkyl, phenyl, naphthyl and pyridyl; COOH or COOC₁-C₂alkyl,
Z is —NH₂; —NH-aryl, or —NH-aryl wherein the aryl is substituted by at least one substituent from the group hydroxy, cyano, —SO₃H, —NH₂, carboxy, C₁-C₂alkoxy-carbonyl, C₁-C₂alkyl and C₁-C₂alkoxy,
Z′ is —SO₃M; —COOH or —COOC₁-C₂alkyl,
Z₁ is —OH; —NHCOC₁-C₂alkyl or —NHCOOC₁-C₂alkyl,
G is a direct bond; —COOC₁-C₂alkylene; unsubstituted arylene; arylene which is substituted by at least one substituent from the group hydroxy, cyano, —NO₂, —SO₃H, —NH₂, carboxy, C₁-C₂alkoxy-carbonyl, C₁-C₂alkoxy and C₁-C₂alkyl; unsubstituted C₁-C₂alkylene, or C₁-C₂alkylene which is substituted by at least one substituent from the group hydroxy, cyano, —NO₂, —SO₃H, —NH₂, carboxy, C₁-C₂alkoxy-carbonyl, C₁-C₂alkoxy and C₁-C₂alkyl,
n is 1 or 2,
n′ is 0 or 1,
n″ is 0 or 1,
m is 0 or 1,
m₁ is 0 or 1,
each M, independently of the other(s), is hydrogen; Na⁺ or K⁺;
   wherein
* denotes the bond to the bridging group L,
X is hydrogen; —SO₃M; unsubstituted straight-chain or branched C₁-C₂alkyl; straight-chain or branched C₁-C₄alkyl which is substituted by at least one substituent from the group hydroxy, cyano, —SO₃H, —NH₂, carboxy, C₁-C₄alkoxy-carbonyl, C₁-C₄-alkoxy, phenyl, naphthyl and pyridyl; unsubstituted straight-chain or branched C₁-C₄alkoxy; straight-chain or branched C₁-C₄alkoxy which is substituted by at least one substituent from the group hydroxy, cyano, —SO₃H, —NH₂, carboxy, C₁-C₄alkoxy-carbonyl, C₁-C₄alkyl, phenyl, naphthyl and pyridyl; —COOH or —COOC₁-C₂alkyl,
Y is unsubstituted straight-chain or branched C₁-C₂alkyl; straight-chain or branched C₁-C₄alkyl which is substituted by at least one substituent from the group hydroxy, cyano, —SO₃H, —NH₂, carboxy, C₁-C₄alkoxy-carbonyl, C₁-C₄alkoxy, phenyl, naphthyl and pyridyl; unsubstituted straight-chain or branched C₁-C₄alkoxy; straight-chain or branched C₁-C₄alkoxy which is substituted by at least one substituent from the group hydroxy, cyano, —SO₃H, —NH₂, carboxy, C₁-C₄alkoxy-carbonyl, C₁-C₄alkyl, phenyl, naphthyl and pyridyl; —COOH or —COOC₁-C₂alkyl,
Z is —NH₂; —NH-aryl, or —NH-aryl wherein the aryl is substituted by at least one substituent from the group hydroxy, cyano, —SO₃H, —NH₂, carboxy, C₁-C₂alkoxy-carbonyl, C₁-C₂alkyl and C₁-C₂alkoxy,
Z′ is —SO₃M; —COOH or —COOC₁-C₂alkyl,
Z₁ is —OH; —NHCOC₁-C₂alkyl or —NHCOOC₁-C₂alkyl,
G is a direct bond; —COOC₁-C₂alkylene; unsubstituted arylene; arylene which is substituted by at least one substituent from the group hydroxy, cyano, —NO₂, —SO₃H, —NH₂, carboxy, C₁-C₂alkoxy-carbonyl, C₁-C₂alkoxy and C₁-C₂alkyl; unsubstituted C₁-C₂alkylene, or C₁-C₂alkylene which is substituted by at least one substituent from the group hydroxy, cyano, —NO₂, —SO₃H, —NH₂, carboxy, C₁-C₂alkoxy-carbonyl, C₁-C₂alkoxy and C₁-C₂alkyl,
n is 1 or 2,
m′ is 0 or 1,
n″ is 0 or 1,
m is 0 or 1,
m₁ is 0 or 1,
each M, independently of the other(s), is hydrogen; Na⁺ or K⁺;
   wherein
* denotes the bond to the bridging group L,
X is hydrogen; —SO₃M; unsubstituted straight-chain or branched C₁-C₂alkyl; straight-chain or branched C₁-C₄alkyl which is substituted by at least one substituent from the group hydroxy, cyano, —SO₃H, —NH₂, carboxy, C₁-C₄alkoxy-carbonyl, C₁-C₄-alkoxy, phenyl, naphthyl and pyridyl; unsubstituted straight-chain or branched C₁-C₄alkoxy; straight-chain or branched C₁-C₄alkoxy which is substituted by at least one substituent from the group hydroxy, cyano, —SO₃H, —NH₂, carboxy, C₁-C₄alkoxy-carbonyl, C₁-C₄alkyl, phenyl, naphthyl and pyridyl; —COOH or —COOC₁-C₂alkyl,
Y is unsubstituted straight-chain or branched C₁-C₂alkyl; straight-chain or branched C₁-C₄alkyl which is substituted by at least one substituent from the group hydroxy, cyano, —SO₃H, —NH₂, carboxy, C₁-C₄alkoxy-carbonyl, C₁-C₄alkoxy, phenyl, naphthyl and pyridyl; unsubstituted straight-chain or branched C₁-C₄alkoxy; straight-chain or branched C₁-C₄alkoxy which is substituted by at least one substituent from the group hydroxy, cyano, —SO₃H, —NH₂, carboxy, C₁-C₄alkoxy-carbonyl, C₁-C₄alkyl, phenyl, naphthyl and pyridyl; —COOH or —COOC₁-C₂alkyl,
Z is —NH₂; —NH-aryl, or —NH-aryl wherein the aryl is substituted by at least one substituent from the group hydroxy, cyano, —SO₃H, —NH₂, carboxy, C₁-C₂alkoxy-carbonyl, C₁-C₂alkyl and C₁-C₂alkoxy,
Z′ is —SO₃M; —COOH or —COOC₁-C₂alkyl,
Z₁ is —OH; —NHCOC₁-C₂alkyl or —NHCOOC₁-C₂alkyl,
G is a direct bond; —COOC₁-C₂alkylene; unsubstituted arylene; arylene which is substituted by at least one substituent from the group hydroxy, cyano, —NO₂, —SO₃H, —NH₂, carboxy, C₁-C₂alkoxy-carbonyl, C₁-C₂alkoxy and C₁-C₂alkyl; unsubstituted C₁-C₂alkylene, or C₁-C₂alkylene which is substituted by at least one substituent from the group hydroxy, cyano, —NO₂, —SO₃H, —NH₂, carboxy, C₁-C₂alkoxy-carbonyl, C₁-C₂alkoxy and C₁-C₂alkyl,
n is 1 or 2,
m′ is 0 or 1,
n″ is 0 or 1,
m is 0 or 1,
m₁ is 0 or 1,
each M, independently of the other(s), is hydrogen; Na⁺ or K⁺;
   wherein
* denotes the bond to the bridging group L,
Z is —NH₂; —NH-aryl, or —NH-aryl wherein the aryl is substituted by at least one substituent from the group hydroxy, cyano, —SO₃H, —NH₂, carboxy, C₁-C₂alkoxy-carbonyl, C₁-C₂alkyl and C₁-C₂alkoxy,
Z₁ is —OH; —NHCOC₁-C₂alkyl or —NHCOOC₁-C₂alkyl,
G is a direct bond; COOC₁-C₂alkylene; unsubstituted arylene; arylene which is substituted by at least one substituent from the group hydroxy, cyano, —NO₂, —SO₃H, —NH₂, carboxy, C₁-C₂alkoxy-carbonyl, C₁-C₂alkoxy and C₁-C₂alkyl; unsubstituted C₁-C₂alkylene, or C₁-C₂alkylene which is substituted by at least one substituent from the group hydroxy, cyano, —NO₂, —SO₃H, —NH₂, carboxy, C₁-C₂alkoxy-carbonyl, C₁-C₂alkoxy and C₁-C₂alkyl,
n is 1 or 2,
n′ is 0 or 1,
m is 0 or 1,
m₁ is 0 or 1,
each M, independently of the others, is hydrogen; Na⁺ or K⁺;
   wherein
* denotes the bond to the bridging group L,
Z is —NH₂; —NH-aryl, or —NH-aryl wherein the aryl is substituted by at least one substituent from the group hydroxy, cyano, —SO₃H, —NH₂, carboxy, C₁-C₂alkoxy-carbonyl, C₁-C₂alkyl and C₁-C₂alkoxy,
Z₁ is —OH; —NHCOC₁-C₂alkyl or —NHCOOC₁-C₂alkyl,
G is a direct bond; COOC₁-C₂alkylene; unsubstituted arylene; arylene which is substituted by at least one substituent from the group hydroxy, cyano, —NO₂, —SO₃H, —NH₂, carboxy, C₁-C₂alkoxy-carbonyl, C₁-C₂alkoxy and C₁-C₂alkyl; unsubstituted C₁-C₂alkylene, or C₁-C₂alkylene which is substituted by at least one substituent from the group hydroxy, cyano, —NO₂, —SO₃H, —NH₂, carboxy, C₁-C₂alkoxy-carbonyl, C₁-C₂alkoxy and C₁-C₂alkyl,
n is 1 or 2,
n′ is 0 or 1,
m is 0 or 1,
m₁ is 0 or 1,
each M, independently of the others, is hydrogen; Na⁺ or K⁺;
   wherein
* denotes the bond to the bridging group L,
Z is —NH₂; —NH-aryl, or —NH-aryl wherein the aryl is substituted by at least one substituent from the group hydroxy, cyano, —SO₃H, —NH₂, carboxy, C₁-C₂alkoxy-carbonyl, C₁-C₂alkyl and C₁-C₂alkoxy,
Z₁ is —OH; —NHCOC₁-C₂alkyl or —NHCOOC₁-C₂alkyl,
G is a direct bond; —COOC₁-C₂alkylene; unsubstituted arylene; arylene which is substituted by at least one substituent from the group hydroxy, cyano, —NO₂, —SO₃H, —NH₂, carboxy, C₁-C₂alkoxy-carbonyl, C₁-C₂alkoxy and C₁-C₂alkyl; unsubstituted C₁-C₂alkylene, or C₁-C₂alkylene which is substituted by at least one substituent from the group hydroxy, cyano, —NO₂, —SO₃H, —NH₂, carboxy, C₁-C₂alkoxy-carbonyl, C₁-C₂alkoxy and C₁-C₂alkyl,
n is 1 or 2,
n′ is 0 or 1,
m is 0 or 1,
m₁ is 0 or 1,
each M, independently of the others, is hydrogen; Na⁺ or K;

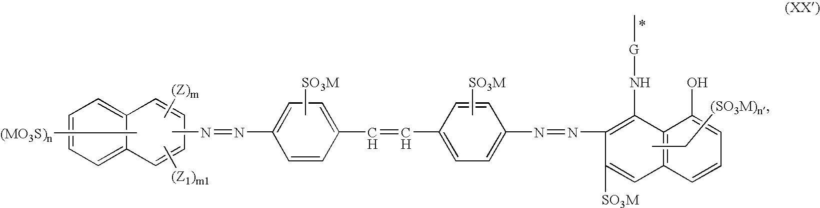

wherein
* denotes the bond to the bridging group L,
Z is —NH₂; —NH-aryl, or —NH-aryl wherein the aryl is substituted by at least one substituent from the group hydroxy, cyano, —SO₃H, —NH₂, carboxy, C₁-C₂alkoxy-carbonyl, C₁-C₂alkyl and C₁-C₂alkoxy,
Z₁ is —OH; —NHCOC₁-C₂alkyl or —NHCOOC₁-C₂alkyl,
G is a direct bond; —COOC₁-C₂alkylene; unsubstituted arylene; arylene which is substituted by at least one substituent from the group hydroxy, cyano, —NO₂, —SO₃H, —NH₂, carboxy, C₁-C₂alkoxy-carbonyl, C₁-C₂alkoxy and C₁-C₂alkyl; unsubstituted C₁-C₂alkylene, or C₁-C₂alkylene which is substituted by at least one substituent from the group hydroxy, cyano, —NO₂, —SO₃H, —NH₂, carboxy, C₁-C₂alkoxy-carbonyl, C₁-C₂alkoxy and C₁-C₂alkyl,
n is 1 or 2,
n′ is 0 or 1,
m is 0 or 1,
m₁ is 0 or 1,
each M, independently of the others, is hydrogen; Na⁺ or K⁺; or

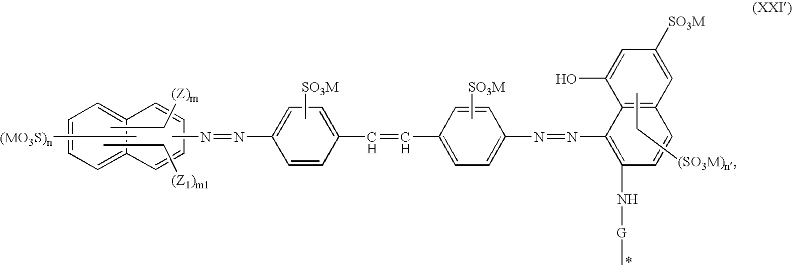

wherein
* denotes the bond to the bridging group L,
Z is —NH₂; —NH-aryl, or —NH-aryl wherein the aryl is substituted by at least one substituent from the group hydroxy, cyano, —SO₃H, —NH₂, carboxy, C₁-C₂alkoxy-carbonyl, C₁-C₂alkyl and C₁-C₂alkoxy,
Z₁ is —OH; —NHCOC₁-C₂alkyl or —NHCOOC₁-C₂alkyl,
G is a direct bond; —COOC₁-C₂alkylene; unsubstituted arylene; arylene which is substituted by at least one substituent from the group hydroxy, cyano, —NO₂, —SO₃H, —NH₂, carboxy, C₁-C₂alkoxy-carbonyl, C₁-C₂alkoxy and C₁-C₂alkyl; unsubstituted C₁-C₂alkylene, or C₁-C₂alkylene which is substituted by at least one substituent from the group hydroxy, cyano, —NO₂, —SO₃H, —NH₂, carboxy, C₁-C₂alkoxy-carbonyl, C₁-C₂alkoxy and C₁-C₂alkyl,
n is 1 or 2,
n′ is 0 or 1,
m is 0 or 1,
m₁ is 0 or 1,
each M, independently of the others, is hydrogen; Na⁺ or K⁺.

Especially preferred dye radicals D are those of the following formulae (XXVI)-(XXVIII):

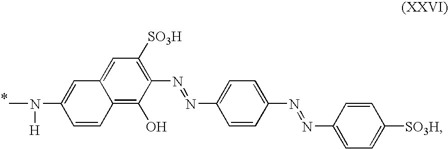

which is the radical of Bisazo Red 253,

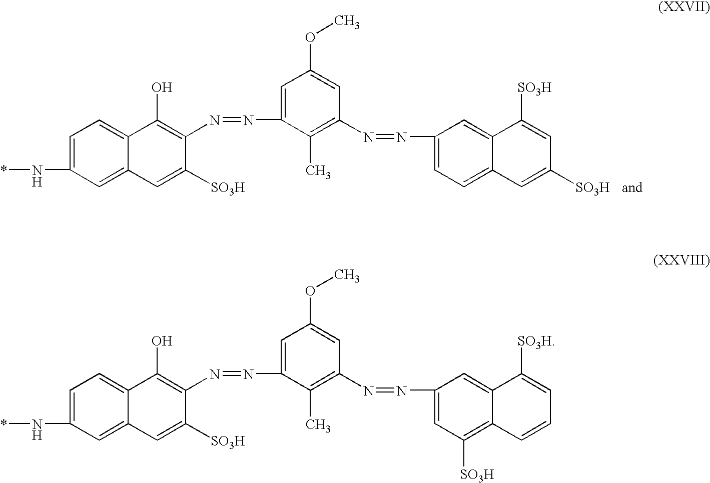

The mixture of the dyes of formulae (XXI) and (XXII) is known as Pontamine.

Preferred phthalocyanine compounds of formula (8a) correspond to formula

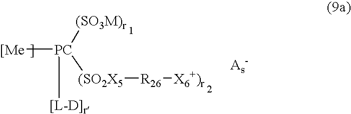

wherein
PC, X₅, X₆⁺, R₂₆, Me, L, D, r₁, r₂ and r′ are as defined hereinbefore (and have the preferred meanings given hereinbefore),
Me is Zn, AlZ₂, Si(IV)-(Z₂)₂ or Ti(IV)-(Z₂)₂, wherein Z₂ is chlorine, fluorine, bromine or hydroxy,
M is hydrogen; or an alkali metal ion, ammonium ion or amine salt ion, and the sum of numbers r₁, r₂ and r′ is from 1 to 8, and
Aₛ⁻ exactly balances the positive charge of the remainder of the molecule.

Especially preferred phthalocyanine compounds of formula (8a) correspond to formula

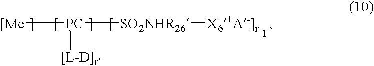

wherein
PC, L and D are as defined hereinbefore (and have the preferred meanings given herein before),
Me is Zn, AlZ₂, Si(IV)-(Z₂)₂ or Ti(IV)-(Z₂)₂, wherein Z₂ is chlorine, fluorine, bromine or hydroxy,
R₂₆′ is C₂-C₆alkylene,
r₁ is a number from 0 to 4, preferably from 1 to 4,
r′ is a number from 1 to 4,
X₆′⁺ is a group of formula

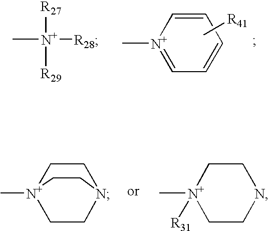

wherein
R₂₇ and R₂₈ are each independently of the other unsubstituted straight-chain or branched C₁-C₄alkyl, or straight-chain or branched C₁-C₄alkyl which is substituted by at least one substituent from the group hydroxy, cyano, halogen and phenyl,
R₂₉ is as defined for R₂₇; cyclohexyl or amino,
R₃₁ is C₁-C₄alkyl,
R₄₁ is C₁-C₄alkyl; C₁-C₄alkoxy; halogen; carboxy; C₁-C₄alkoxy-carbonyl or hydroxy, and
   A′⁻ is a halide ion; alkylsulfate ion or arylsulfate ion,
   it being possible for the radicals —SO₂NHR′₂₆—X₆′⁺A′⁻ to be the same or different.

Further photobleaching active ingredients that may be used in accordance with this invention correspond to formula

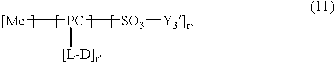

wherein
PC, L and D are as defined hereinbefore (and have the preferred meanings given herein before),
Me is Zn; Fe(II); Ca; Mg; Na; K; Al-Z₂; Si(IV)-(Z₂)₂; Ti(IV)-(Z₂)₂; Ge(IV)-(Z₂)₂; Ga(III)-Z₂; Zr(IV)-(Z₂)₂; In(III)-Z₂ or Sn(IV)-(Z₂)₂,
Z₂ is an alkanolate ion; a hydroxyl ion; R₂₅COO⁻; ClO₄⁻; BF₄⁻; PF₆⁻; R₂₅SO₃⁻; —SO₄²⁻; NO₃⁻; F⁻; Cl⁻; Br⁻; I⁻; or a citrate, tartrate or oxalate ion,
   wherein R₂₅ is hydrogen; or unsubstituted C₁-C₁₈alkyl; or C₁-C₁₈alkyl which is substituted by at least one substituent from the group hydroxy, cyano, carboxy, —SO₃H, —NH₂, C₁-C₆alkoxy-carbonyl, C₁-C₆alkoxy, phenyl, naphthyl and pyridyl; unsubstituted aryl, or aryl which is substituted by at least one substituent from the group hydroxy, cyano, carboxy, —SO₃H, —NH₂, C₁-C₆alkoxy-carbonyl, C₁-C₆alkoxy and C₁-C₄alkyl,
Y₃′ is hydrogen; or an alkali metal ion or ammonium ion, and
r is any number from 0 to 4, preferably from 1 to 4,
r′ is any number from 1 to 4.

Very especially preferred phthalocyanine compounds correspond to formula (11a),

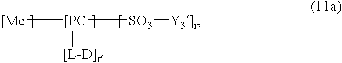

wherein
PC, L and D are as defined hereinbefore (and have the preferred meanings given herein before),
Me is Zn or A₁-Z₂,
Z₂ is an alkanolate ion; a hydroxyl ion; R₂₅COO⁻; ClO₄⁻; BF₄⁻; PF₆⁻; R₂₅SO₃⁻; SO₄²⁻; NO₃⁻; F⁻; Cl⁻; Br⁻; I⁻; or a citrate, tartrate or oxalate ion,
   wherein R₂₅ is hydrogen; or unsubstituted C₁-C₁₈alkyl; or C₁-C₁₈alkyl which is substituted by at least one substituent from the group hydroxy, cyano, carboxy, —SO₃H, —NH₂, C₁-C₆alkoxy-carbonyl, C₁-C₆alkoxy, phenyl, naphthyl and pyridyl; unsubstituted aryl, or aryl which is substituted by at least one substituent from the group hydroxy, cyano, carboxy, —SO₃H, —NH₂, C₁-C₆alkoxy-carbonyl, C₁-C₆alkoxy and C₁-C₄alkyl,
Y₃′ is hydrogen; or an alkali metal ion or ammonium ion, and
r is any number from 0 to 4, preferably from 1 to 4,
r′ is any number from 1 to 4.

Further phthalocyanine compounds of interest that may be used in accordance with this invention correspond to formula

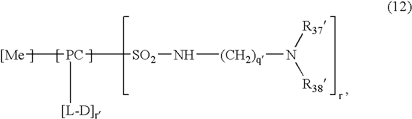

wherein
PC, Me, L and D are as defined for formula (11),
R₃₇′ and R₃₈′ are each independently of the other hydrogen; phenyl; sulfophenyl; carboxyphenyl; C₁-C₆alkyl; hydroxy-C₁-C₆alkyl; cyano-C₁-C₆alkyl; sulfo-C₁-C₆alkyl; carboxy-C₁-C₆alkyl or halo-C₁-C₆alkyl, or R₃₇′ and R₃₈′, together with the nitrogen atom, form a morpholine ring,
q′ is an integer from 2 to 6, and
r is a number from 1 to 4,
   wherein, when r>1, the radicals

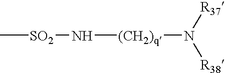

in the molecule may be the same or different.

Further phthalocyanine compounds of interest which may be used in accordance with this invention correspond to formula

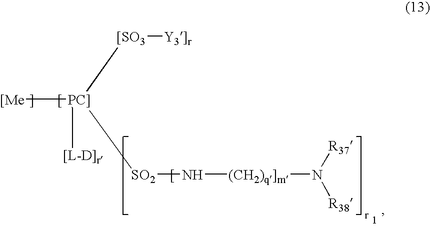

wherein
PC, Me, L and D are as defined for formula (11),
Y′₃ is hydrogen; or an alkali metal ion or ammonium ion,
q′ is an integer from 2 to 6;
R₃₇′ and R₃₈′ are each independently of the other hydrogen; phenyl; sulfophenyl; carboxyphenyl; C₁-C₆alkyl; hydroxy-C₁-C₆alkyl; cyano-C₁-C₆alkyl; sulfo-C₁-C₆alkyl; carboxy-C₁-C₆alkyl or halo-C₁-C₆alkyl, or R₃₇′ and R₃₈′, together with the nitrogen atom, form a morpholine ring;
m′ is 0 or 1; and
r′ is any number from 1 to 4,
r and r₁ are each independently of the other any number from 0.5 to 2, the sum r+r, being a minimum of 1 and a maximum of 3.

Where the central atom Me in the phthalocyanine ring is Si(IV), the phthalocyanines used in accordance with the invention may also contain, in addition to the substituents on the phenyl nucleus of the phthalocyanine ring, axial substituents (═R₄₆). Such phthalocyanines correspond, for example, to formula

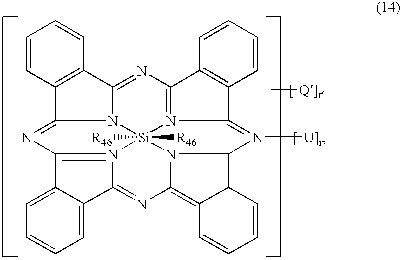

wherein
R₄₆ is hydroxy; C₁-C₂₂alkyl; branched C₃-C₂₂alkyl; C₁-C₂₂alkenyl; branched C₃-C₂₂alkenyl or a mixture thereof; C₁-C₂₂alkoxy; a sulfo or carboxy radical; a radical of formula

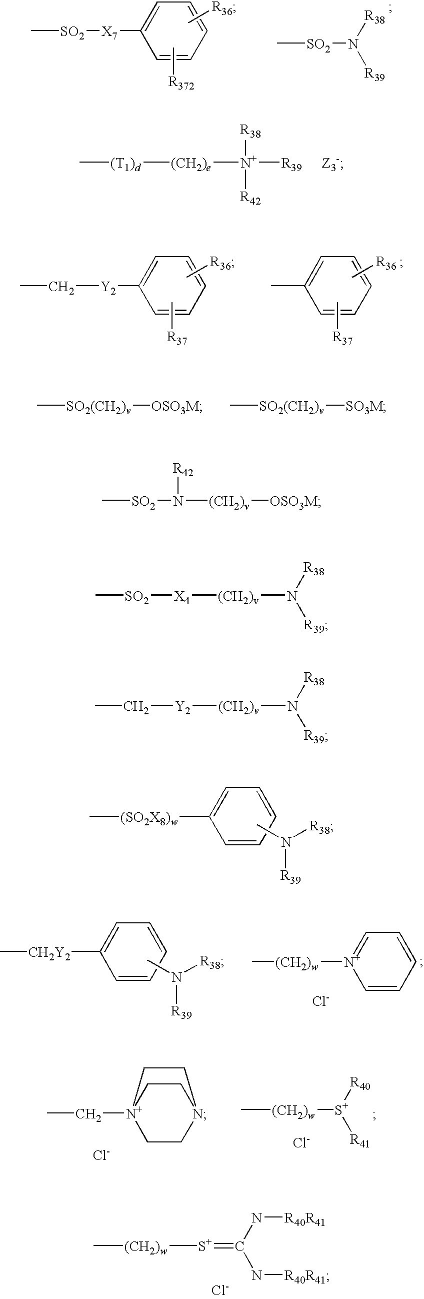

a branched alkoxy radical of formula

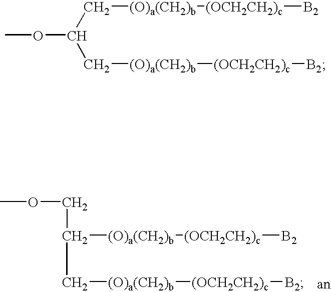

alkylethyleneoxy unit of formula -(T₁)_{d}-(CH₂)_{b}(OCH₂CH₂)ₐ—B₃ or an ester of formula COOR₁₈; and
   U is [Q″]⁺Aₛ⁻; or Q′″, wherein
   R₃₆, R₃₇, R₃₈, R₃₉, R₄₀, R₄₁, R₄₂, R₄₃, B₂, B₃, M, Q″, Q′″, T₁, X₇, X₈, Y₂, Z₃⁻, a, b, c, d, e, r, r′, s, v and w are as defined hereinbefore (and have the preferred meanings given hereinbefore).

Especially preferred compounds of formulae (8a) and (8b) correspond to formulae

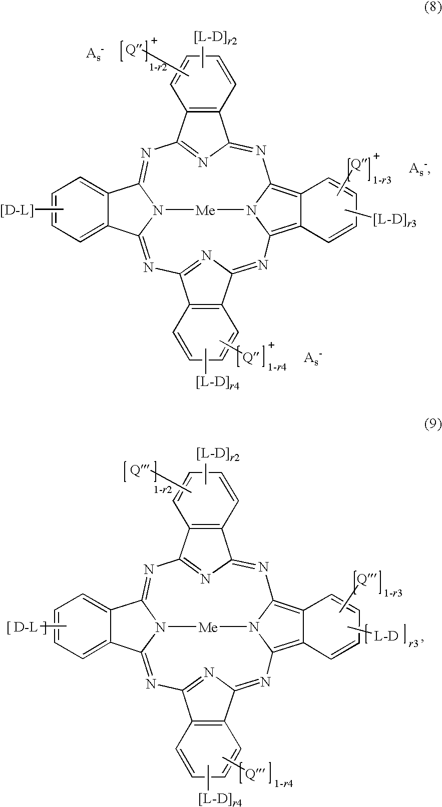

wherein
Me is Zn, AlZ₂, Si(IV)-(Z₂)₂ or Ti(IV)-(Z₂)₂, wherein Z₂ is chlorine, fluorine, bromine or hydroxy,
each Q″, independently of any other, is a sulfo or carboxy group; or a radical of formula —SO₂X₅—R₂₆—X₆⁺; —O—R₂₆—X₆⁺ or —(CH₂)ₜ—Y₁⁺,
   wherein
   R₂₆ is branched or unbranched C₁-C₄alkylene; 1,3-phenylene or 1,4-phenylene,
   X₅ is —NH— or —N(C₁-C₄alkyl)-,
   X₆⁺ is a group of formula

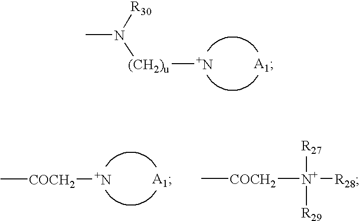

or, when R₂₆═C₁-C₄alkylene, also may be a group of formula

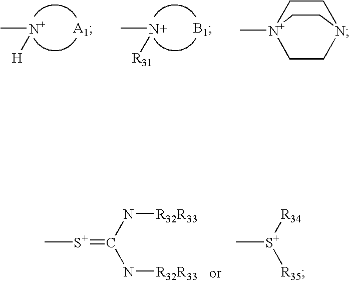

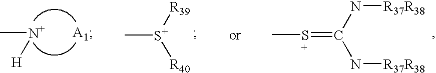

Y₁⁺ is a group of formula
t is 0 or 1,
in which above formulae
R₂₇ and R₂₈ are each independently of the other C₁-C₆alkyl,
R₂₉ is C₁-C₄alkyl; pentyl; hexyl or —NR₇R₈,
R₃₀ and R₃, are each independently of the other C₁-C₄alkyl,
R₃₂ and R₃₃ are each independently of the other hydrogen or C₁-C₄alkyl,
R₃₄ and R₃₅ are each independently of the other unsubstituted C₁-C₄alkyl, or C₁-C₄alkyl which is substituted by at least one substituent from the group hydroxy, cyano, carboxy, —SO₃H, —NH₂, C₁-C₄alkoxy-carbonyl, C₁-C₄alkoxy, phenyl, naphthyl and pyridyl,
u is from 1 to 6,
A₁ is a unit which completes a pyrrole, imidazole, pyridine, pyrazine, pyrimidine or pyridazine ring, and
B₁ is a unit which completes a morpholine, pyrrolidine, piperazine or piperidine ring,
each Q′″, independently of any other, is hydroxy; C₁-C₁₀alkyl; branched C₃-C₁₀alkyl; C₂-C₁₀-alkenyl; branched C₃-C₁₀alkenyl or a mixture thereof; C₁-C₁₀alkoxy; a sulfo or carboxy radical; a radical of formula

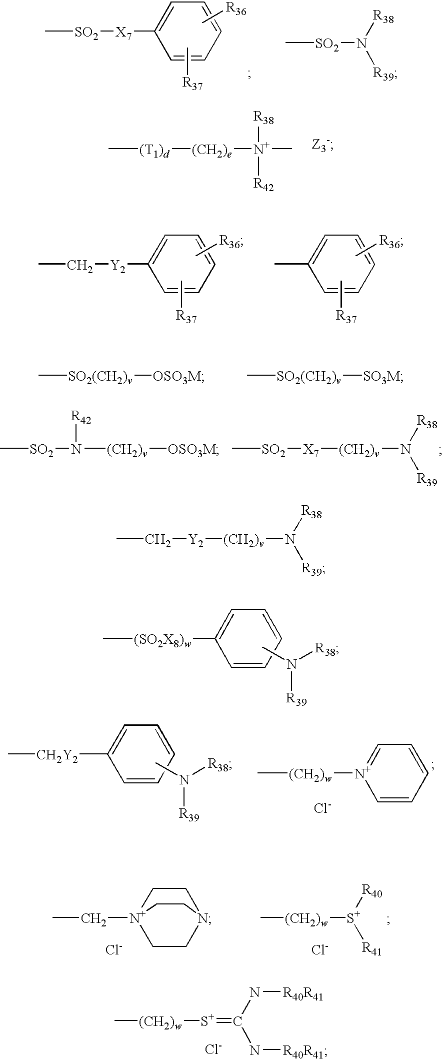

a branched alkoxy radical of formula

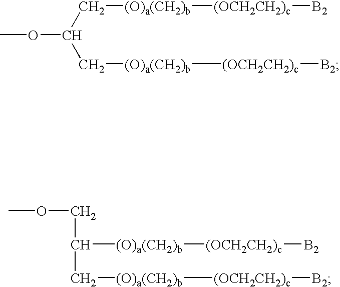

an alkylethyleneoxy unit of formula
-(T₁)_{d}—(CH₂)_{b}(OCH₂CH₂)ₐ—B₃ or an ester of formula —COOR₄₃,
wherein
B₂ is hydrogen; hydroxy; C₁-C₁₈alkyl; C₁-C₁₈alkoxy; —CO₂H; —CH₂COOH; —SO₃-M₁; —OSO₃-M₁; —PO₃²⁻M₁; —OPO₃²⁻M₁; or a mixture thereof,
B₃ is hydrogen; hydroxy; —COOH; —SO₃⁻M₁; —OSO₃⁻M₁ or C₁-C₄alkoxy,
M₁ is hydrogen; or an alkali metal ion or ammonium ion,
T₁ is —O—; or —NH—,
X₇ and X₈ are each independently of the other —O—; —NH— or —N(C₁-C₄alkyl)-,
R₃₆ and R₃₇ are each independently of the other hydrogen; a sulfo group or a salt thereof; a carboxy group or a salt thereof, or a hydroxy group; at least one of the radicals R₃₆ and R₃₇ being a sulfo group or carboxy group or a salt thereof,
Y₂ is —O—; —S—; —NH— or —N(C₁-C₄alkyl)-,
R₃₈ and R₃₉ are each independently of the other hydrogen; C₁-C₄alkyl; hydroxy-C₁-C₄alkyl; cyano-C₁-C₄alkyl; sulfo-C₁-C₄alkyl; carboxy-C₁-C₄alkyl or halo-C₁-C₄alkyl; unsubstituted phenyl, or phenyl which is substituted by at least one substituent from the group halogen, C₁-C₄alkyl and C₁-C₄-alkoxy; sulfo or carboxy, or R₃₈ and R₃₉, together with the nitrogen atom to which they are bonded, form a morpholine, piperazine or piperidine ring;
R₄₀ and R₄₁ are each independently of the other a C₁-C₄alkyl or aryl-C₁-C₄alkyl radical;
R₄₂ is hydrogen; unsubstituted C₁-C₄alkyl, or C₁-C₄alkyl which is substituted by at least one substituent from the group halogen, hydroxy, cyano, —SO₃H, —NH₂, phenyl, carboxy, C₁-C₄alkoxy-carbonyl and C₁-C₆alkoxy;
R⁴³ is C₁-C₁₀alkyl; branched C₃-C₁₀alkyl; C₁-C₁₀alkenyl, or branched C₃-C₁₀-alkenyl; C₃-C₂₂glycol; C₁-C₁₀alkoxy; branched C₃-C₁₀alkoxy; or a mixture thereof;
M is hydrogen; Na⁺; K+ or an ammonium ion,
Z₃⁻ is an alkanolate ion; a hydroxyl ion; R₂₅COO⁻; ClO₄⁻; BF₄⁻; PF₆⁻; R₂₅SO₃⁻; SO₄²⁻; —NO₃—; F⁻; Cl⁻; Br⁻; I⁻; or a citrate, tartrate or oxalate ion,
wherein R₂₅ is hydrogen; or unsubstituted C₁-C₁₈alkyl; or C₁-C₁₈alkyl which is substituted by at least one substituent from the group hydroxy, cyano, carboxy, —SO₃H, —NH₂, C₁-C₆alkoxy-carbonyl, C₁-C₆alkoxy, phenyl, naphthyl and pyridyl; unsubstituted aryl, or aryl which is substituted by at least one substituent from the group hydroxy, cyano, carboxy, —SO₃H, —NH₂, C₁-C₆alkoxy-carbonyl, C₁-C₆alkoxy and C₁-C₄alkyl,
a is 0 or 1,
b is from 0 to 6,
c is from 0 to 100,
d is 0; or 1,
e is from 0 to 22,
v is an integer from 2 to 12,
w is 0 or 1, and
A⁻ is an organic or inorganic anion, and
s in the case of monovalent anions A⁻ is equal to r₂, r₃, r₄ and r₅ and in the case of polyvalent anions is ≦r₂, r₃, r₄ and r₅, it being necessary for Aₛ⁻ to balance the positive charge; and when r₂, r₃, r₄ and r₅≠1, the radicals Q″ may be identical or different,
each L, independently of any other(s), is a direct bond; —SO₂—; —O—; —OR₄₄—; —OR₄₄O—; —OR₄₄N(R₄₅)—; —N(R₄₅)—; —(CH₂CH₂O—)ₙ—; —C(O)—; —C(O)N(R₄₅)—; —N(R₄₅)C(O)—; —OC(O)—; —C(O)O—; —S—; unsubstituted straight-chain or branched C₁-C₁₈alkylene; straight-chain or branched C₁-C₁₈alkylene which is substituted by at least one substituent from the group hydroxy, cyano, —SO₃H, —NH₂, carboxy, C₁-C₄alkoxy-carbonyl, C₁-C₄alkoxy, phenyl, naphthyl and pyridyl; unsubstituted C₅-C₁₈arylene; C₅-C₁₈arylene which is substituted by at least one substituent from the group hydroxy, cyano, carboxy, C₁-C₄alkoxy-carbonyl, C₁-C₄alkoxy and C₁-C₄alkyl; unsubstituted straight-chain or branched C₁-C₁₈alkylene-C₅-C₁₈aryl; straight-chain or branched C₁-C₁₈alkylene-C₅-C₁₈aryl which is substituted by at least one substituent from the group hydroxyl, cyano, —SO₃H, —NH₂, carboxy, C₁-C₄alkoxy-carbonyl, C₁-C₄alkoxy, C₁-C₄alkyl, phenyl, naphthyl and pyridyl; unsubstituted straight-chain or branched C₅-C₁₈arylene-C₁-C₁₈alkyl, or straight-chain or branched C₅-C₁₈arylene-C₁-C₁₈alkyl which is substituted by at least one substituent from the group hydroxy, cyano, —SO₃H, —NH₂, carboxy, C₁-C₄alkoxy-carbonyl, C₁-C₄alkoxy, C₁-C₄alkyl, phenyl, naphthyl and pyridyl,
   wherein
   R₄₄ is unsubstituted straight-chain or branched C₁-C₁₈alkylene; straight-chain or branched C₁-C₁₈alkylene which is substituted by at least one substituent from the group hydroxy, cyano, —SO₃H, —NH₂, carboxy, C₁-C₄alkoxy-carbonyl, C₁-C₄alkoxy, phenyl, naphthyl and pyridyl; unsubstituted C₅-C₁₈arylene; C₅-C₁₈-arylene which is substituted by at least one substituent from the group hydroxy, cyano, —SO₃H, —NH₂, carboxy, C₁-C₄alkoxy-carbonyl, C₁-C₄alkoxy and C₁-C₄-alkyl; unsubstituted straight-chain or branched C₁-C₁₈alkylene-C₅-C₁₈aryl; straight-chain or branched C₁-C₁₈alkylene-C₅-C₁₈aryl which is substituted by at least one substituent from the group hydroxy, cyano, SO₃H, —NH₂, carboxy, C₁-C₄alkoxy-carbonyl, C₁-C₄alkoxy, C₁-C₄alkyl, phenyl, naphthyl and pyridyl;

unsubstituted straight-chain or branched C₅-C₁₈arylene-C₁-C₁₈alkyl, or straight-chain or branched C₅-C₁₈arylene-C₁-C₁₈alkyl which is substituted by at least one substituent from the group hydroxy, cyano, carboxy, C₁-C₄alkoxy-carbonyl, C₁-C₄alkoxy, C₁-C₄alkyl, phenyl, naphthyl and pyridyl,
R₄₅ is unsubstituted straight-chain or branched C₁-C₁₈alkyl; straight-chain or branched C₁-C₁₈alkyl which is substituted by at least one substituent from the group hydroxy, cyano, —SO₃H, —NH₂, carboxy, C₁-C₄alkoxy-carbonyl, C₁-C₄-alkoxy, phenyl, naphthyl and pyridyl; unsubstituted C₅-C₁₈aryl; C₅-C₁₈aryl which is substituted by at least one substituent from the group hydroxy, cyano, —SO₃H, —NH₂, carboxy, C₁-C₄alkoxy-carbonyl, C₁-C₄alkoxy and C₁-C₄alkyl; unsubstituted straight-chain or branched C₁-C₁₈alkoxy, or straight-chain or branched C₁-C₁₈alkoxy which is substituted by at least one substituent from the group hydroxy, cyano, —SO₃H, —NH₂, carboxy, C₁-C₄alkoxy-carbonyl, C₁-C₄alkyl, phenyl, naphthyl and pyridyl,
each D, independently of any other(s), is a dye radical of formula (I), (II), (III), (IV), (V), (VI), (VII), (VIII), (IX), (X), (XI), (XII), (XIII), (XIV), (XV), (XVI), (XVII), (XVIII), (XIX), (XX), (XXI), (XXII), (XXIII), (XXIV) (I′), (II′), (III′), (IV′), (V′), (VI′), (VIIa′), (VIIb′), (VIII′), (IX′), (X′), (XI′), (XII′), (XIII′), (XIV′), (XV′), (XVI′), (XVII′), (XVIII′), (XIX′), (XX′) or (XXI′),
r₂ is 0 or 1,
r₃ is 0 or 1, and
r₄ is 0 or 1.

The compounds of formulae (8a) and (8b) can be prepared by conventional synthesis methods customary in organic chemistry.

For synthesis of the Me-phthalocyanines there are two methods: either the phthalocyanine ring is prepared first and is subsequently complexed with a metal salt, or the phthalocyanine ring is synthesised from simple benzenic precursors with simultaneous incorporation of the metal ion.

The substituents on the phthalocyanine ring can be introduced before or after ring synthesis. If the substituents are introduced before ring formation, this results in substitution of all four rings. When the substituents are introduced after ring synthesis, the substitution can be varied.

As a result of introduction of suitable substituents, it is possible to obtain, for example, water-soluble phthalocyanines. Such synthesis methods are described in, inter alia, DE1569783, DE1569729, DE2021257 and DE1794298. The synthesis of metal-containing phthalocyanines and their use as photoactivators is known, for example, from DE0081462.

A suitable method of obtaining water-soluble phthalocyanines is the introduction of sulfonate groups. It is known that such sulfonated phthalocyanines are not pure substances but are a mixture of positional isomers. In addition, the degree of sulfonation will also vary and, as a result, frequently may not be a whole number. In J. Griffiths et al., Dyes and Pigments, Vol 33, 65-78 (1997) and the literature cited therein there is described a method for the preparation of a tetrasodium salt of a zinc phthalocyanine.

The phthalocyanines which carry a covalently bonded dye are prepared in customary manner. For example, the covalent bonding is achieved by reacting a metal-containing phthalocyanine substituted by sulfonyl chloride groups with a suitable dye containing amino groups.

Synthesis of a metal-containing phthalocyanine substituted by sulfonyl chloride groups is carried out by sulfochlorination as is described in, inter alia, DE2812261 or DE0153278. The degree of sulfochloride substitution can be modified by varying the starting materials. Sulfochlorination of phthalocyanines usually results in a main product which can, however, also contain amounts of phthalocyanines substituted by a greater or lesser number of sulfonyl chloride groups.

Granulates G and G₁ contain from 2 to 50% by weight, based on the total weight of the granulate, of at least one of the mentioned phthalocyanine compounds (1a), (1b), (2a), (3), (4), (5), (6), (7), (8), (8a), (9), (9a), (10), (11), (11a), (12) and (13) and optionally a dye of formula (A), (B), (C), (D), (E), (F), (G), (H) and/or (I). Preferred granulates G and G₁ contain from 4 to 30% by weight and especially preferred granulates contain from 5 to 20% by weight of at least one of the mentioned phthalocyanine compounds (1a), (1b), (2a), (3), (4), (5), (6), (7), (8), (8a), (9), (9a), (10), (11), (11a), (12) and (13) and optionally a dye of formula (A), (B), (C), (D), (E), (F), (G), (H) and/or (I), based on the total weight of the granulate.

The granulates G and G₁ contain from 10 to 60% by weight, preferably from 12 to 60% by weight, especially from 12 to 55% by weight, based on the total weight of the granulate, of at least one anionic dispersing agent and/or at least one water-soluble organic polymer. In certain cases, less than 10% by weight or more than 70% by weight may also be used.

Such anionic dispersing agents and also the water-soluble organic polymers, which may also have dispersing properties, are described hereinbelow.

### Anionic Dispersing Agents:

The anionic dispersing agents used are, for example, the commercially available water-soluble anionic dispersing agents for dyes, pigments etc. The following products, especially,

come into consideration: condensation products of aromatic sulfonic acids and formaldehyde, condensation products of aromatic sulfonic acids with unsubstituted or chlorinated biphenyls or biphenyl oxides and optionally formaldehyde, (mono-/di-)alkyl-naphthalenesulfonates, sodium salts of polymerised organic sulfonic acids, sodium salts of polymerised alkylnaphthalenesulfonic acids, sodium salts of polymerised alkylbenzene-sulfonic acids, alkylarylsulfonates, sodium salts of alkyl polyglycol ether sulfates, polyalkylated polynuclear arylsulfonates, methylene-linked condensation products of arylsulfonic acids and hydroxyarylsulfonic acids, sodium salts of dialkylsulfosuccinic acids, sodium salts of alkyl diglycol ether sulfates, sodium salts of polynaphthalenemethane-sulfonates, ligno- or oxyligno-sulfonates or heterocyclic polysulfonic acids.

Especially suitable anionic dispersing agents are condensation products of naphthalene-sulfonic acids with formaldehyde, sodium salts of polymerised organic sulfonic acids, (mono-/di-)alkylnaphthalenesulfonates, polyalkylated polynuclear arylsulfonates, sodium salts of polymerised alkylbenzenesulfonic acid, lignosulfonates, oxylignosulfonates and condensation products of naphthalenesulfonic acid with a polychloromethylbiphenyl.

Instead of or in addition to the dispersing agent or agents, the granulates according to the invention may comprise a water-soluble organic polymer, which may also have dispersing properties. Such polymers may be used singly or as mixtures of two or more polymers. As water-soluble polymers (which may, but need not, have film-forming properties), there come into consideration, for example, gelatins, polyacrylates, polymethacrylates, copolymers of ethyl acrylate, methyl methacrylate and methacrylic acid (ammonium salt), polyvinyl-pyrrolidones, vinylpyrrolidones, vinyl acetates, copolymers of vinylpyrrolidone with long-chain olefins, poly(vinylpyrrolidone/dimethylaminoethyl methacrylates), copolymers of vinyl-pyrrolidone/dimethylaminopropyl methacrylamides, copolymers of vinylpyrrolidone/dimethyl-aminopropyl acrylamides, quaternised copolymers of vinylpyrrolidones and dimethylamino-ethyl methacrylates, terpolymers of vinylcaprolactam/vinylpyrrolidone/dimethylaminoethyl methacrylates, copolymers of vinylpyrrolidone and methacrylamidopropyltrimethylammonium chloride, terpolymers of caprolactam/vinylpyrrolidone/dimethylaminoethyl methacrylates, copolymers of styrene and acrylic acid, polycarboxylic acids, polyacrylamides, carboxymethyl cellulose, hydroxymethyl cellulose, polyvinyl alcohols, hydrolysed and non-hydrolysed polyvinyl acetate, copolymers of maleic acid with unsaturated hydrocarbons and also mixed polymerisation products of the mentioned polymers. Further suitable substances are polyethylene glycol (MW=4000−20 000), copolymers of ethylene oxide with propylene oxide (MW>3500), condensation products (block polymerisation products) of alkylene oxide, especially propylene oxide, copolymers of vinylpyrrolidone with vinyl acetate, ethylene oxide-propylene oxide addition products with diamines, especially ethylenediamine, polystyrene-sulfonic acid, polyethylenesulfonic acid, copolymers of acrylic acid with sulfonated styrenes, gum arabic, carboxymethyl cellulose, hydroxypropyl methylcellulose, sodium carboxymethyl cellulose, hydroxypropyl methylcellulose phthalate, maltodextrin, starch, sucrose, lactose, enzymatically modified and subsequently hydrogenated sugars, as are obtainable under the name “Isomalt”, cane sugar, polyaspartic acid, tragacanth and polyvinyl alcohols.

Among those water-soluble organic polymers, special preference is given to carboxymethyl cellulose, polyacrylamides, polyvinyl alcohols, polyvinylpyrrolidones, gelatins, hydrolysed polyvinyl acetates, copolymers of vinylpyrrolidone and vinyl acetate, maltodextrins, polyaspartic acid and also polyacrylates and polymethacrylates.

The granulates G and G₁ contain from 15 to 75% by weight, preferably from 20 to 75% by weight, especially from 25 to 70% by weight, based on the total weight of the granulate, of at least one inorganic salt and/or at least one low-molecular-weight organic acid and/or a salt thereof. In certain cases, less than 15% by weight or more than 75% by weight may also be used.

The mentioned components are described in detail hereinbelow:

### Inorganic Salts:

For use as inorganic salts there come into consideration carbonates, hydrogen carbonates, phosphates, polyphosphates, sulfates, silicates, sulfites, borates, halides and pyro-phosphates, preferably in the form of alkali salts. Preference is given to water-soluble salts such as, for example, alkali metal chlorides, alkali phosphates, alkali carbonates, alkali polyphosphates and alkali sulfates and water-soluble salts used in washing agent formulations.

### Low-Molecular-Weight Organic Acids and Salts Thereof:

As low-molecular-weight organic acids there come into consideration, for example, mono- or poly-carboxylic acids. Of special interest are aliphatic carboxylic acids, especially those having a total number of from 1 to 12 carbon atoms. Preferred acids are aliphatic C₁-C₁₂-mono- or -poly-carboxylic acids, the monocarboxylic acids being especially those having at least 3 carbon atoms in total. As substituents of the carboxylic acids there come into consideration, for example, hydroxy and amino, especially hydroxy. Special preference is given to aliphatic C₂-C₁₂polycarboxylic acids, especially aliphatic C₂-C₆polycarboxylic acids. Very special preference is given to hydroxy-substituted aliphatic C₂-C₆polycarboxylic acids. These compounds may be used in the form of the free acid or a salt, especially an alkali salt. There may also be used aminopolycarboxylates (e.g. sodium ethylenediaminetetraacetate), phytates, phosphonates, aminopolyphosphonates (e.g. sodium ethylenediaminetetra-phosphonate), aminoalkylenepoly(alkylenephosphonates), polyphosphonates, polycarb-oxylates or water-soluble polysiloxanes.

As examples of low-molecular-weight organic acids and salts thereof there may be mentioned oxalic acid, tartaric acid, acetic acid, propionic acid, succinic acid, maleic acid, citric acid, formic acid, gluconic acid, p-toluenesulfonic acid, terephthalic acid, benzoic acid, phthalic acid, acrylic acid and polyacrylic acid.

The granulates G and G₁ may comprise further additives, for example wetting agents, disintegrants such as, for example, powdered or fibrous cellulose, microcrystalline cellulose, fillers such as, for example, dextrin, water-insoluble or water-soluble dyes or pigments, and also dissolution accelerators, and optical brighteners such as, for example, bis(triazinyl-amino)stilbene disulfonic acid, bis(triazolyl)stilbene disulfonic acid, bis(styryl)biphenyl or bis(benzofuranyl)biphenyl, a bis(benzoxalyl) derivative, bis(benzimidazolyl) derivative, a coumarin derivative or a pyrazoline derivative. Suitable optical brighteners are described in WO 05/014769 on pages 26-47. Aluminium silicates such as zeolites, and also compounds such as talc, kaolin, TiO₂, SiO₂ or magnesium trisilicate may also be used in small amounts. Such additives are present in an amount of from 0 to 10% by weight, preferably from 0 to 5% by weight, based on the total weight of the granulate. In certain cases, more than 10% by weight may also be used.

As especially preferred additives, special emphasis is to be given to powdered or fibrous cellulose and to aluminium silicates. These are present in an amount of from 0 to 10% by weight, preferably from 0 to 5% by weight, based on the total weight of the granulate.

The granulates G and G₁ may contain from 3 to 15% water by weight, based on the total weight of the granulate.

The granulates G and G₁ contain from 1 to 60% by weight, based on the total weight of the granulate, of an encapsulation material consisting of at least one finely particulate solid and at least one hydrophobic coating material. Preferred granulates G and G₁ contain from 3 to 55% by weight, more preferred granulates contain from 3 to 50% by weight and especially preferred granulates contain from 4 to 50% by weight, based on the total weight of the granulate, of an encapsulation material consisting of at least one finely particulate solid and at least one hydrophobic coating material.

The granulates G and G₁ are encapsulated with a layer consisting of at least one hydrophobic coating material and at least one finely particulate solid. The finely particulate solid may both be present in the hydrophobic coating material and also be applied onto the hydrophobic coating material. The content of hydrophobic coating material is from 2 to 98% by weight, preferably from 15 to 98% by weight, very preferably from 40 to 95% by weight and more preferably from 50 to 95% by weight, based on the total weight of the encapsulating layer, and the content of the finely particulate solid is from 2 to 98% by weight, preferably from 2 to 85% by weight, very preferably from 5 to 60% by weight and more preferably from 5 to 50% by weight, based on the total weight of the encapsulating layer. The components are described in detail hereinbelow.

Meltable hydrophobic materials which are described in the literature for the encapsulation of washing agent components are suitable as the hydrophobic coating material of the encapsulating layer as understood by this invention. These coating materials are usually not present in chemically pure form and are therefore distinguished by a melting/solidification range. It may furthermore be advantageous to use a mixture of a plurality of coating materials. The mixture used has a solidification point range preferably above 30° C., especially above 40° C. It may furthermore be advantageous for solidification from the liquid phase to occur within a narrow temperature range of <5 Kelvin. In this context, the determination of melting/solidification ranges can be carried out using established test procedures such as differential thermal analysis, as is described, for example, in “The Analyst, 87 (1962), p. 420 ff.”.

Suitable coating materials are particular hydrocarbons (paraffins), long-chain saturated carboxylic acids or alcohols having fewer than 24 carbon atoms, their comparable esters and wax esters of natural or synthetic origin, fatty acid glycerides and also fatty acid alkanolamides and fatty alcohol ethers, with special preference being given to fatty acids and fatty acid blends, alkali metal salts of stearic or palmitic acid, glycerol monostearates or palmitates, solid fatty alcohols, PEG fatty alcohols or PEG stearates having a lipophilic character, solid paraffin, microcrystalline waxes, condensation products of stearic acid, triethanolamine and acrylamide, fatty acid mono-, di- or tri-esters or fatty acid mono-, di- or tri-glycerides, especially of stearic or palmitic acid, solid and semi-solid waxes such as beeswax or carnauba wax and their PEG derivatives.

As very especially preferred coating materials mention should be made of fatty acids and mixtures thereof, PEG ethoxylates of stearic acid, glyceryl monostearates, triglycerides and PEG derivatives of beeswax and mixtures of those substances.

A finely particulate solid is present in the encapsulating layer. As understood by the invention, finely particulate herein means an average particle size of <100 μm, preferably <50 μm and especially <10 μm. The solid is mixed together with the meltable material in suitable manner, and the resulting solid-containing melt is applied to the granulates according to the invention. The finely particulate solid may be present in the melt on its own or in admixture with a plurality of finely particulate solids.

To that applied encapsulating layer, which may not necessarily have solidified completely, it may furthermore be advantageous to apply further finely particulate solid. According to our understanding, finely particulate solid so applied contributes to a further improvement in storage stability of the washing agent composition because it reduces the number of direct contact points between the granulates according to the invention and the washing agent particles. In that case it is desirable for the superficially applied finely particulate solid to adhere sufficiently firmly for it not to be rubbed off during incorporation into the washing agent. The finely particulate solid in the encapsulating layer may have, but need not have, the same composition as the superficially applied finely particulate solid and likewise may also consist of a mixture of a plurality of finely particulate solids.

Suitable finely particulate solids include, for example, those disclosed in EP-A-133 562, for example the water-soluble inorganic and organic salts which may be textile washing agent constituents customary per se, but preferably excluding salt-type surfactants. They are primarily the customary washing agent builder substances, for example the alkali metal silicates, carbonates, hydrogen carbonates and borates also known as washing alkalis and also the alkali metal polyphosphates. Also suitable, however, are alkali metal sulfates, which are practically inert in the washing process, for example sodium sulfate, and also water-soluble salts of organic acids, especially alkali salts of hydroxycarboxylic acids, for example citric acid and tartaric acid, and also salts of polymeric polycarboxylates, for example homo- and co-polymerisation products of acrylic acid, hydroxyacrylic acid, maleic acid, methylenemalonic acid, and copolymerisation products of those acids with vinyl methyl ether or methacrylic acid.

A further class of finely particulate solids that can be used includes finely particulate organic solids that are capable of swelling or are partially soluble in water and absorbent polymeric powders, for example of the cellulose, methylcellulose or starch type, especially carboxymethyl starch, dextrins and also polyester, polyethylene and polyacrylonitrile.

Finally, a third class of suitable materials consists of very finely dispersed inorganic compound mixtures which are insoluble in water. These include the bentonites, such as sodium montmorillonite, layered silicates and also kieselguhr, talc, kaolin, mica, fuller's earth, feldspar and zeolites, and also hydrosodalite. Mention should also be made of very finely dispersed metal oxides or metal hydroxides or mixed oxides of silicon, aluminium, magnesium, zinc and titanium, and also the very finely particulate silicic acids produced by precipitation or pyrogenic means. Examples of suitable metal oxides include very finely dispersed magnesium oxide, titanium oxide, zinc oxide and aluminium oxide. Further suitable materials are finely particulate alkaline earth metal salts, for example calcium chloride and calcium sulfate. Further suitable materials are finely particulate alkali metal silicates, carbonates, polyphosphonates and sulfates.

Preferred finely particulate solids are alkali metal silicates, carbonates, polyphosphates and sulfates, layered silicates, talc, kaolin, zeolite, alkaline earth salts and titanium dioxide which are <50 μm.

A very preferred granulate G₂ consists of
a) from 4 to 30% by weight of at least one water-soluble phthalocyanine compound of formula (1a), (1b), (2a), (3), (4), (5), (6), (7), (8), (8a), (9), (9a), (10), (11), (11a), (12), (13) and/or (14), based on the total weight of the granulate,
b) from 12 to 60% by weight of at least one anionic dispersing agent and/or at least one water-soluble organic polymer, based on the total weight of the granulate,
c) from 20 to 75% by weight of at least one inorganic salt and/or at least one low-molecular-weight organic acid or salt thereof, based on the total weight of the granulate,
d) from 0 to 5% by weight of at least one further additive, based on the total weight of the granulate,
e) from 3 to 15% by weight water, based on the total weight of the granulate, and
f) from 1 to 50% by weight of an encapsulating layer consisting of from 2 to 98% by weight, preferably from 15 to 98% by weight, very preferably from 40 to 95% by weight, more preferably from 50 to 95% by weight, based on the total weight of the encapsulating layer, of at least one hydrophobic coating material and from 2 to 98% by weight, preferably from 2 to 85% by weight, very preferably from 5 to 60% by weight, more preferably from 5 to 50% by weight, based on the total weight of the encapsulating layer, of at least one finely particulate solid.

Preferably, the granulate G₂ does not contain any enzymes, whether in the core or in or on the encapsulation.

A likewise very preferred granulate G₃ consists of
a) from 4 to 30% by weight of at least one water-soluble phthalocyanine compound of formula (1a), (1b), (2a), (3), (4), (5), (6), (7), (8), (8a), (9), (9a), (10), (11), (11a), (12), (13) and/or (14) in admixture with at least one dye of formula (A), (B), (C), (D), (E), (F), (G), (H) and/or (I), based on the total weight of the granulate,
b) from 12 to 60% by weight of at least one anionic dispersing agent and/or at least one water-soluble organic polymer, based on the total weight of the granulate,
c) from 20 to 75% by weight of at least one inorganic salt and/or at least one low-molecular-weight organic acid or salt thereof, based on the total weight of the granulate,
d) from 0 to 5% by weight of at least one further additive, based on the total weight of the granulate,
e) from 3 to 15% by weight water, based on the total weight of the granulate, and
f) from 1 to 50% by weight of an encapsulating layer consisting of from 2 to 98% by weight, preferably from 15 to 98% by weight, very preferably from 40 to 95% by weight, more preferably from 50 to 95% by weight, based on the total weight of the encapsulating layer, of at least one hydrophobic coating material and from 2 to 98% by weight, preferably from 2 to 85% by weight, very preferably from 5 to 60% by weight, more preferably from 5 to 50% by weight, based on the total weight of the encapsulating layer, of at least one finely particulate solid.

Preferably, the granulate G₃ does not contain any enzymes, whether in the core or in or on the encapsulation.

An especially preferred granulate G₄ consists of
a) from 5 to 20% by weight of at least one water-soluble phthalocyanine compound of formula (1a), (1b), (2a), (3), (4), (5), (6), (7), (8), (8a), (9), (9a), (10), (11), (11a), (12), (13) and/or (14), based on the total weight of the granulate,
b) from 12 to 55% by weight of at least one anionic dispersing agent and/or at least one water-soluble organic polymer, based on the total weight of the granulate,
c) from 25 to 70% by weight of at least one inorganic salt and/or at least one low-molecular-weight organic acid or salt thereof, based on the total weight of the granulate,
d) from 0 to 5% by weight of at least one further additive, based on the total weight of the granulate,
e) from 3 to 15% by weight water, based on the total weight of the granulate, and
f) from 5 to 40% by weight of an encapsulating layer consisting of from 2 to 98% by weight, preferably from 15 to 98% by weight, very preferably from 40 to 95% by weight, more preferably from 50 to 95% by weight, based on the total weight of the encapsulating layer, of at least one hydrophobic coating material and from 2 to 98% by weight, preferably from 2 to 85% by weight, very preferably from 5 to 60% by weight, more preferably from 5 to 50% by weight, based on the total weight of the encapsulating layer, of at least one finely particulate solid.

Preferably, the granulate G₄ does not contain any enzymes, whether in the core or in or on the encapsulation.

An especially preferred granulate G₅ consists of
a) from 5 to 20% by weight of at least one water-soluble phthalocyanine compound of formula (1a), (1b), (2a), (3), (4), (5), (6), (7), (8), (8a), (9), (9a), (10), (11), (11a), (12), (13) and/or (14) in admixture with at least one dye of formula (A), (B), (C), (D), (E), (F), (G), (H) and/or (I), based on the total weight of the granulate,
b) from 12 to 55% by weight of at least one anionic dispersing agent and/or at least one water-soluble organic polymer, based on the total weight of the granulate,
c) from 25 to 70% by weight of at least one inorganic salt and/or at least one low-molecular-weight organic acid or salt thereof, based on the total weight of the granulate,
d) from 0 to 5% by weight of at least one further additive, based on the total weight of the granulate,
e) from 3 to 15% by weight water, based on the total weight of the granulate, and
f)from 5 to 40% by weight of an encapsulating layer consisting of from 2 to 98% by weight, preferably from 15 to 98% by weight, very preferably from 40 to 95% by weight, more preferably from 50 to 95% by weight, based on the total weight of the encapsulating layer, of at least one hydrophobic coating material and from 2 to 98% by weight, preferably from 2 to 85% by weight, very preferably from 5 to 60% by weight, more preferably from 5 to 50% by weight, based on the total weight of the encapsulating layer, of at least one finely particulate solid.

Preferably, the granulate G₅ does not contain any enzymes, whether in the core or in or on the encapsulation.

A particularly preferred granulate G₆ consists of
a) from 5 to 20% by weight of at least one water-soluble phthalocyanine compound of formula (1a), (1b), (2a), (3), (4), (5), (6), (7), (8), (8a), (9), (9a), (10), (11), (11a), (12), (13) and/or (14), based on the total weight of the granulate,
b) from 12 to 55% by weight of at least one anionic dispersing agent and/or at least one water-soluble organic polymer, based on the total weight of the granulate,
c) from 25 to 70% by weight of at least one inorganic salt and/or at least one low-molecular-weight organic acid or salt thereof, based on the total weight of the granulate,
d) from 0 to 5% by weight of at least one further additive, based on the total weight of the granulate,
e) from 3 to 15% by weight water, based on the total weight of the granulate, and
f) from 5 to 40% by weight of an encapsulating layer consisting of from 2 to 98% by weight, preferably from 15 to 98% by weight, very preferably from 40 to 95% by weight, more preferably from 50 to 95% by weight, based on the total weight of the encapsulating layer, of at least one hydrophobic coating material having a solidification point range above 40° C. and from 2 to 98% by weight, preferably from 2 to 85% by weight, very preferably from 5 to 60% by weight, more preferably from 5 to 50% by weight, based on the total weight of the encapsulating layer, of at least one finely particulate solid from the group consisting of alkali metal silicates, carbonates, polyphosphates and sulfates, layered silicates, talc, kaolin, zeolite, alkaline earth salts and titanium dioxide which are <50 μm.

Preferably, the granulate G₆ does not contain any enzymes, whether in the core or in or on the encapsulation.

A particularly preferred granulate G₇ consists of
a) from 5 to 20% by weight of at least one water-soluble phthalocyanine compound of formula (1a), (1b), (2a), (3), (4), (5), (6), (7), (8), (8a), (9), (9a), (10), (11), (11a), (12), (13) and/or (14) in admixture with at least one dye of formula (A), (B), (C), (D), (E), (F), (G), (H) and/or (I), based on the total weight of the granulate,
b) from 12 to 55% by weight of at least one anionic dispersing agent and/or at least one water-soluble organic polymer, based on the total weight of the granulate,
c) from 25 to 70% by weight of at least one inorganic salt and/or at least one low-molecular-weight organic acid or salt thereof, based on the total weight of the granulate,
d) from 0 to 5% by weight of at least one further additive, based on the total weight of the granulate,
e) from 3 to 15% by weight water, based on the total weight of the granulate,
f) from 5 to 40% by weight of an encapsulating layer consisting of from 2 to 98% by weight, preferably from 15 to 98% by weight, very preferably from 40 to 95% by weight, more preferably from 50 to 95% by weight, based on the total weight of the encapsulating layer, of at least one hydrophobic coating material and from 2 to 98% by weight, preferably from 2 to 85% by weight, very preferably from 5 to 60% by weight, more preferably from 5 to 50% by weight, based on the total weight of the encapsulating layer, of at least one finely particulate solid from the group consisting of alkali metal silicates, carbonates, polyphosphates and sulfates, layered silicates, talc, kaolin, zeolite, alkaline earth salts and titanium dioxide which are <50 μm.

Preferably, the granulate G₇ does not contain any enzymes, whether in the core or in or on the encapsulation.

The granulates G, G₁, G₂, G₃, G₄, G₅, G₆ and G₇ according to the invention are prepared by drying an aqueous solution or suspension of the phthalocyanine compound, as a result of which solid particles (granulates) are formed. That drying step, the procedures employed and also examples of granulates obtainable thereby and their characteristics are described in detail in WO 04/022693 and form part of, but do not limit, this invention. The granulates are resistant to abrasion, low in dust, free-flowing and can be readily metered and they are distinguished by very rapid solubility in water. However, depending on the composition of the washing agent and the prevailing storage conditions, those granulates can start to dissolve in the washing agent, which is associated with undesirable staining of the washing agent.

For that reason, in a further step, the granulates are encapsulated with a solid-containing melt. Established procedures are used for application of the encapsulating layer, for example batch-wise mixing of the granulate together with the solid-containing melt in a temperature-controlled mixer (e.g. a ploughshare mixer) or spraying the melt onto the granulate in a fluidised layer. Continuous procedures are also possible for forming the encapsulation, for example mixing together the melt and granulate in a continuous mixer or spraying the melt in a fluidised bed. Uniformity of the encapsulated granulate and control of its composition are benefited if the solid-containing melt is prepared separately and metered into the granulate.

After the granulate has been covered with the melt and solid, the product is brought, in controlled manner, to a temperature below the solidification temperature of the encapsulation material. In batch operation this can be done, in the simplest case, by cooling the mixing vessel or discharging the material into a cooled mixer. Cooling can also be carried out continuously, for example by using a fluidised bed cooler. The cooling process is generally so carried out that significant granulate agglomeration of the mixture is avoided.

Further finely particulate solid can be applied to the surface of the granulate during or after formation of the encapsulating layer depending on the procedure selected. In a batch-wise process procedure, further finely particulate solid can be added after intimate mixing of the granulate with the melt and formation of the encapsulating layer. When this is done during the cooling phase of the granulate it is possible both to obtain products in which the post-dosed solid is an integral part of the coating (in the case of addition during the solidification phase of the encapsulating layer) and also to obtain products in which the solid adheres to the surface of the coated granulate (when the addition is made after the coating has substantially solidified). The characteristics of the product and the stability of the granulates according to the invention are benefited if the additional solid is added before the encapsulating layer has to a very large extent solidified, in order to obtain the adhesion of the solid to the granulate which is necessary for a non-dusty product.

The granulates G, G₁, G₂, G₃, G₄, G₅, G₆ and G₇ preferably have a density in the range from 400 to 900 g/l and are rapidly soluble in water. They may be added directly to the washing agent formulation in the desired concentration of the phthalocyanine compound. Alternatively, the granulates according to the invention may be mixed with other washing agent components, such as phosphates, zeolites, brighteners or enzymes, for metering into a washing agent by means of a post-dosing step. Such a mixture for post-dosing of the granulates is distinguished by a homogeneous distribution of the granulates according to the invention in the mixture and may consist of, for example, from 1 to 50% granulate and from 99 to 50% sodium tripolyphosphate.

The granulates G, G₁, G₂, G₃, G₄, G₅, G₆ and G₇ in the washing agent formulations according to the invention preferably have an average particle size of <500 μm. More preferably, the particle size of the granulates is from 40 to 400 μm.

As already mentioned, the granulates G, G₁, G₂, G₃, G₄, G₅, G₆ and G₇ according to the invention are used especially as an additive in a washing agent formulation. Such a washing agent formulation may be in solid, liquid, gel-like or paste form, for example in the form of a liquid, non-aqueous washing agent composition containing not more than 5% by weight, preferably from 0 to 1% by weight, water and based on a suspension of a builder substance in a non-ionic surfactant, for example as described in GB-A-2 158 454.

The washing agent formulation may also be in the form of powders or (super-)compact powders, in the form of single- or multi-layer tablets (tabs), in the form of washing agent bars, washing agent blocks, washing agent sheets, washing agent pastes or washing agent gels, or in the form of powders, pastes, gels or liquids used in capsules or in pouches (sachets).

However, the washing agent formulations are preferably in the form of non-aqueous formulations, powders, tabs or granulates.

The present invention accordingly relates also to washing agent formulations containing
I) from 5 to 70% A) of at least one anionic surfactant and/or B) at least one non-ionic surfactant, based on the total weight of the washing agent formulation,
II) from 5 to 60% C) of at least one builder substance, based on the total weight of the washing agent formulation,
III) from 0 to 30% D) of at least one peroxide and, optionally, at least one activator, based on the total weight of the washing agent formulation, and
IV) from 0.001 to 1% E) of at least one granulate G₁ G., G₂, G₃, G₄, G₅, G₆ and/or G₇,
V) from 0 to 60% F) of at least one further additive, and
VI) from 0 to 5% G) water.

The sum of the percentages by weight of components I)-VI) in a formulation is always 100%.

All the preferences mentioned hereinbefore apply to the granulates G, G₁, G₂, G₃, G₄, G₅, G₆ and G₇.

The anionic surfactant A) may be, for example, a sulfate, sulfonate or carboxylate surfactant or a mixture of those surfactants. Preferred sulfates are those having from 12 to 22 carbon atoms in the alkyl radical, where appropriate in combination with alkyl ethoxysulfates having from 10 to 20 carbon atoms in the alkyl radical. Preferred sulfonates are, for example, alkylbenzenesulfonates having from 9 to 15 carbon atoms in the alkyl radical and/or alkylnaphthalenesulfonates having from 6 to 16 carbon atoms in the alkyl radical in question. The cation in the anionic surfactant is preferably an alkali metal cation, especially sodium. Preferred carboxylates are alkali metal sarcosinates of the formula R—CO—N(R¹)—CH₂COOM¹, wherein R is alkyl or alkenyl having from 8 to 18 carbon atoms in the alkyl or alkenyl radical, R¹ is C₁-C₄alkyl and M¹ is an alkali metal.

The non-ionic surfactant B) may be, for example, a condensation product of from 3 to 8 mol of ethylene oxide with 1 mol of primary alcohol containing from 9 to 15 carbon atoms.

As builder substance C) there come into consideration, for example, alkali metal phosphates, especially tripolyphosphates, carbonates or hydrogen carbonates, especially the sodium salts thereof, silicates, aluminium silicates, polycarboxylates, polycarboxylic acids, organic phosphonates, aminoalkylenepoly(alkylenephosphonates) or mixtures of those compounds. Especially suitable silicates are sodium salts of crystalline layered silicates of the formula NaHSiₜO₂ₜ₊₁.pH₂O or Na₂SiₜO₂ₜ₊₁.pH₂O, wherein t is a number from 1.9 to 4 and p is a number from 0 to 20. Among the aluminium silicates, preference is given to those obtainable commercially under the names zeolite A, B, X and HS, and also to mixtures comprising two or more of those components.

Among the polycarboxylates, preference is given to polyhydroxycarboxylates, especially citrates, and acrylates and also copolymers thereof with maleic anhydride. Preferred polycarboxylic acids are nitrilotriacetic acid, ethylenediaminetetraacetic acid and ethylene-diamine disuccinate either in racemic form or in the enantiomerically pure S,S form. Phosphonates and aminoalkylenepoly(alkylenephosphonates) that are especially suitable are alkali metal salts of 1-hydroxyethane-1,1-diphosphonic acid, nitrilotris(methylene-phosphonic acid), ethylenediaminetetramethylenephosphonic acid and diethylenetriamine-pentamethylenephosphonic acid.

As the peroxide component D) there come into consideration, for example, the organic and inorganic peroxides known in the literature and available commercially that bleach textile materials at conventional washing temperatures, for example at from 10 to 95° C. The organic peroxides are, for example, mono- or poly-peroxides, especially organic peracids or salts thereof, such as phthalimidoperoxycaproic acid, peroxybenzoic acid, diperoxy-dodecanedioic acid, diperoxynonanedioic acid, diperoxydecanedioic acid, diperoxyphthalic acid or salts thereof. Preferably, however, inorganic peroxides are used, such as, for example, persulfates, perborates, percarbonates and/or persilicates. It will be understood that mixtures of inorganic and/or organic peroxides can also be used. The peroxides may be in a variety of crystalline forms and have different water contents, and they may also be used together with other inorganic or organic compounds in order to improve their storage stability. The peroxides are added to the washing agent composition preferably by mixing the components, for example using a screw metering system and/or a fluidised bed mixer.

The washing agent compositions may comprise, in addition to the combination according to the invention, one or more optical brighteners, for example from the classes bis(triazinylamino)stilbene disulfonic acid, bis(triazolyl)stilbene disulfonic acid, bis(styryl)-biphenyl and bis(benzofuranyl)biphenyl, a bis(benzoxalyl) derivative, bis(benzimidazolyl) derivative, coumarin derivative or a pyrazoline derivative.

The washing agent compositions may also comprise suspending agents for dirt, e.g. sodium carboxymethyl cellulose, pH regulators, e.g. alkali metal or alkaline earth metal silicates, foam regulators, e.g. soap, salts for regulating the spray-drying and the granulating properties, e.g. sodium sulfate, fragrances and, optionally, antistatic agents and fabric conditioners, enzymes, such as amylase, bleaching agents, pigments and/or toning agents. It will be understood that such constituents must be stable towards the bleaching agent used.

Further preferred additives to the washing agent compositions according to the invention are polymers which, during the washing of textiles, prevent staining caused by dyes in the washing liquor which have been released from the textiles under the washing conditions. Such polymers are preferably polyvinylpyrrolidones which may have been modified by the incorporation of anionic or cationic substituents, especially those polyvinylpyrrolidones having a molecular weight in the range from 5000 to 60 000, more especially from 10 000 to 50 000. Such polymers are preferably used in an amount of from 0.05 to 5% by weight, especially from 0.2 to 1.7% by weight, based on the total weight of the washing agent composition.

In addition, the washing agent compositions according to the invention may also comprise so-called perborate activators, such as, for example, TAED or TAGU. Preference is given to TAED, which is preferably used in an amount of from 0.05 to 5% by weight, especially from 0.2 to 1.7% by weight, based on the total weight of the washing agent composition.

The percentages of components 1) to VI) in the washing agent formulations hereinbelow are in all cases based on the total weight of the washing agent formulation.

A preferred washing agent formulation according to the invention consists of
I) from 5 to 70% A) of at least one anionic surfactant from the group consisting of alkylbenzenesulfonates having from 9 to carbon atoms in the alkyl radical; alkyl-naphthalenesulfonates having from 6 to 16 carbon atoms in the alkyl radical in question; and alkali metal sarcosinates of the formula R—CO—N(R₁)—CH₂COOM₁,
   wherein R is alkyl or alkenyl having from 8 to 18 carbon atoms in the alkyl or alkenyl radical,
   R₁ is C₁-C₄alkyl and
   M¹ is an alkali metal and/or
   B) at least one non-ionic surfactant from the group consisting of condensation products of from 3 to 8 mol of ethylene oxide with 1 mol of primary alcohol containing from 9 to 15 carbon atoms,
II) from 5 to 60% C) of a builder substance from the group consisting of alkali metal phosphates; carbonates; hydrogencarbonates; silicates; aluminium silicates; polycarboxylates; poly-carboxylic acids; organic phosphonates and amino-alkylenepoly(alkylenephosphonates), and
II) from 0 to 30% D) of a peroxide from the group consisting of organic mono- or poly-peroxides; organic peracids and salts thereof; persulfates; perborates; percarbonates and persilicates,
IV) from 0.001 to 1% E) of at least one granulate G, G₁, G₂, G₃, G₄, G₅, G₆ and/or G₇,

V) from 0 to 60% F) of further additives from the group consisting of optical brighteners; suspending agents for dirt; pH regulators; foam regulators; salts for regulating the spray-drying and granulating properties; fragrances; antistatic agents; fabric conditioners; enzymes; bleaching agents; pigments; toning agents; polymers which, during the washing of textiles, prevent staining caused by dyes in the washing liquor which have been released from the textiles under the washing conditions; and perborate activators, and
VI) from 0 to 5% G) water.

The content of granulates G, G₁, G₂, G₃, G₄, G₅, G₆ and G₇ in accordance with the invention in the washing agent composition is from to 0.001 to 1% by weight, preferably from 0.001 to 0.05% by weight and very especially from 0.005 to 0.03% by weight.

As already mentioned, the washing agent formulation may be in solid or liquid form.

Preferably, however, the washing agent formulations are in the form of powders, tabs or granulates. These can be prepared, for example, by first preparing an initial powder by means of spray-drying an aqueous slurry comprising all of the afore-mentioned components except for components D) and E) and then adding the dry components D) and E) and mixing them all together. It is also possible to start from an aqueous slurry which, although comprising components A) and C), comprises none of or only some of component B). The slurry is spray-dried; component E) is then mixed with component B) and added; and then component D) is mixed in dry. The components are preferably mixed with one another in such amounts that a solid compact washing agent composition in granule form is obtained, having a specific weight of at least 500 g/l.

In another preferred embodiment, the production of the washing agent composition is carried out in three steps. In the first step a mixture of anionic surfactant (and, where appropriate, a small amount of non-ionic surfactant) and builder substance is prepared. In the second step the major portion of the non-ionic surfactant is sprayed onto that mixture and then, in the third step, peroxide and, where appropriate, catalyst, and the granulate according to the invention are added. That method is usually carried out in a fluidised bed. In a further preferred embodiment, the individual steps are not carried out completely separately, so that there is a certain amount of overlap between them. Such a method is usually carried out in an extruder, in order to obtain granulates in the form of “megapearls”.

The following Examples serve to illustrate the invention, but do not limit the invention thereto. Unless otherwise specified, parts and percentages are based on weight. Temperatures are, unless otherwise specified, in degrees Celsius.

### EXAMPLE 1

1500 g of an FSD granulate consisting of 13% (dry content) photocatalyst active ingredient (zinc and aluminium phthalocyanine compounds), 42% of an inorganic dispersing agent, 37% inorganic and organic salts, 3% of a toning dye (azo compound) and a residual moisture content of 5% are heated to 65° C. in a heatable Lödige ploughshare mixture. 375 g of a triglyceride (Edenor NHTI V, Cognis) are melted at 70° C. and homogeneously mixed together with 125 g of finely particulate talc (particle size: 600 mesh). The solid-containing melt is added to the granulate, with slow continuous mixing by means of the Lödige, and homogeneously distributed within 10 minutes. The encapsulated granulate is discharged continuously into a fluidised bed and cooled to room temperature using cold air. The desired particle size fraction obtained (50-400μ) is separated off by sieving. A product containing 10% photocatalyst and an encapsulating layer of 19% triglyceride and 6% talc, each based on the total weight of the product, is obtained.

### EXAMPLES 2 TO 11

Using the same procedure, granulates comprising phthalocyanine compounds are encapsulated with an encapsulating layer comprising solid and coating agent, cooled and classified. Table 1 gives the percentage contents of the respective components in the encapsulated granulate.

TABLE 1
Examples 2-11

| Example | 2 | 3 | 4 | 5 | 6 | 7 | 8 | 9 | 10 | 11 |
|---|---|---|---|---|---|---|---|---|---|---|
| a) Phthalocyanine compound | | | | | | | | | | |
| Aluminium phthalocyanine | 3 | | 3 | 2 | | | 4 | 1 | | |
| Zinc phthalocyanine | 7 | 11 | 12 | 8 | 3 | 3 | | 3 | | 2 |
| Aluminium phthalocyanine covalently bonded | | | | | | | 8 | 3 | | |
| to Direct Violet 99 | | | | | | | | | | |
| Zinc phthalocyanine covalently bonded to | | | | | 11 | 11 | | 9 | | |
| Direct Violet 99 | | | | | | | | | | |
| Aluminium phthalocyanine covalently bonded | | | | | | | | | 12 | |
| to Bisazo Red 253 dye | | | | | | | | | | |
| Zinc phthalocyanine covalently bonded to | | | | | | | | | | 12 |
| Bisazo Red 253 dye | | | | | | | | | | |
| b) Toning dye | | | | | | | | | | |
| Azo dye as on page 13-14 (A)-(C) | | | 3 | | | | | | 4 | 4 |
| Triphenylmethane dye as on page 14-15 | | | | 2 | | | | | | |
| (D)-(I) | | | | | | | | | | |
| c) Dispersing agent/polymer according to | 30 | 41 | 38 | 22 | 25 | 22 | 32 | 41 | 28 | 26 |
| WO04022693 | | | | | | | | | | |
| d) Salt/acid according to WO04022693 | 20 | 28 | 16 | 20 | 28 | 40 | 30 | 21 | 18 | 44 |
| e) Additive according to WO04022693 | 1 | | | 5 | | | | 1 | | |
| f) Water | 3 | 5 | 4 | 4 | 3 | 3 | 4 | 3 | 3 | |
| g) Meltable encapsulation agent | | | | | | | | | | |
| Triglyceride | 20 | 10 | 16 | | 27 | | | | | 8 |
| Fatty acid blend | | | | | | | | | 25 | |
| Stearic acid | | | | | | | 15 | 5 | | |
| PEG stearate | | | | 20 | | 15 | | 10 | | |
| h) Finely particulate solid | | | | | | | | | | |
| Talc | 8 | 5 | 8 | 5 | 3 | 6 | 7 | 3 | 5 | 4 |
| Titanium dioxide | 8 | | | | | | | | 5 | |
| Zeolite | | | | 12 | | | | | | |

### EXAMPLE 12

For preparation of the spraying liquid, 400 g of a stearic acid (Cutina FS45, Cognis) are melted at 70° C. 100 g of finely particulate talc (Talc TPM, d(50)=4μ, Scheruhn) are introduced and homogeneously mixed in. The mixture is transferred to the spray reservoir of the fluidised bed apparatus and held at 70° C. The melting range of this mixture is around 58° C., and the solidification temperature around 52° C.

1000 g of a granulate containing 14% active ingredient (dry content) and having an average particle size of 180 μm are introduced into a laboratory fluidised bed apparatus provided with a heatable binary nozzle. The active ingredient contained in the granulate is a zinc phthalocyanine covalently bonded to Direct Violet 99. The temperature of the bed air is regulated to 70° C. As soon as the temperature of the granulate bed has reached 70° C. spraying of the fluidised bed with the spray mixture is started. The spraying rate is about 10 g/min. After spraying 90 g of the melt onto the granulate, the apparatus is switched over to cold air supply and the granulate in the fluidised bed is cooled down to room temperature. After the oversized product (>400μ) has been sieved off, a free-flowing product having an average particle size of 190μ, a coating amount of about 8% and an active ingredient content of 12.8% is obtained.

### EXAMPLES 13 TO 22

Using the same procedure, granulates comprising phthalocyanine compounds are encapsulated with an encapsulating layer comprising solid and coating agent, cooled and classified. Table 2 gives the percentage contents of the respective components in the encapsulated granulate.

TABLE 2
Examples 13-22

| Example | 13 | 14 | 15 | 16 | 17 | 18 | 19 | 20 | 21 | 22 |
|---|---|---|---|---|---|---|---|---|---|---|
| a) Phthalocyanine compound | | | | | | | | | | |
| Aluminium phthalocyanine | 3 | | 3 | | | | 4 | 1 | | |
| Zinc phthalocyanine | 10 | 6 | 12 | 15 | 1 | 3 | | 3 | | 3 |
| Aluminium phthalocyanine covalently bonded | | | | | | | 7 | 3 | | |
| to Direct Violet 99 | | | | | | | | | | |
| Zinc phthalocyanine covalently bonded to | | | | | 11 | 11 | | 9 | | |
| Direct Violet 99 | | | | | | | | | | |
| Aluminium phthalocyanine covalently bonded | | | | | | | | | 14 | |
| to Bisazo Red 253 dye | | | | | | | | | | |
| Zinc phthalocyanine covalently bonded to | | | | | | | | | | 12 |
| Bisazo Red 253 dye | | | | | | | | | | |
| b) Toning dye | | | | | | | | | | |
| Azo dye | | | 3 | 2 | | | | | | 4 |
| Triphenylmethane dye | | | | | | | | | 3 | |
| c) Dispersing agent/polymer according to | 39 | 43 | 39 | 24 | 32 | 26 | 42 | 45 | 39 | 26 |
| WO04022693 | | | | | | | | | | |
| d) Salt/acid according to WO04022693 | 25 | 35 | 31 | 38 | 39 | 35 | 23 | 24 | 28 | 47 |
| e) Additive according to WO04022693 | 4 | | | 2 | | 4 | | 1 | 3 | |
| f) Water | 3 | 5 | 4 | 5 | 3 | 4 | 4 | 3 | 4 | |
| g) Meltable encapsulation agent | | | | | | | | | | |
| Triglyceride | | 9 | | | 11 | | | | | 6 |
| Fatty acid blend | | | | | | 12 | | | 8 | |
| Stearic acid | 12 | | 7 | | | | 15 | 3 | | |
| PEG stearate | | | | 10 | | | | 6 | | |
| h) Finely particulate solid | | | | | | | | | | |
| Talc | 4 | 2 | 1 | 2 | 3 | 5 | 5 | | 1 | 2 |
| Titanium dioxide | | | | | | | | 2 | | |
| Zeolite | | | | 2 | | | | | | |

### Washing Agent Preparations Comprising the Granulates According to the Invention

Examples 23-32 illustrate, but do not limit, the use of the granulates according to the invention in washing agent preparations.

TABLE 3
Examples 23-32

| Constituents (% by | | | | | | | | | | |
|---|---|---|---|---|---|---|---|---|---|---|
| weight) | 23 | 24 | 25 | 26 | 27 | 28 | 29 | 30 | 31 | 32 |
| A) | | | | | | | | | | |
| Sodium laurylbenzene- | 10 | 10 | 10 | 10 | 10 | 10 | 10 | 10 | 10 | 10 |
| sulfonic acid | | | | | | | | | | |
| Sodium lauryl ether | 3 | 3 | 3 | 3 | 3 | 3 | 3 | 3 | 3 | 3 |
| sulfate (AES) | | | | | | | | | | |
| B) | | | | | | | | | | |
| Neodol 23-6.5E | 4 | 4 | 4 | 4 | 4 | 4 | 4 | 4 | 4 | 4 |
| (alcohol ethoxylate) | | | | | | | | | | |
| C) | | | | | | | | | | |
| Zeolite A (sodium | 25 | 20 | 22 | 35 | 10 | 25 | | 32 | 25 | |
| aluminium silicate) | | | | | | | | | | |
| Sodium tripolyphosphate | | 10 | | | 30 | | 35 | | 5 | 32 |
| D) | | | | | | | | | | |
| Sodium percarbonate | 20 | 20 | 20 | 5 | | 20 | | | | |
| Sodium perborate | | | | | | | 20 | | 20 | 20 |
| NOBS (p-nonanoyl- | | | | | | 3 | 3 | | 3 | |
| oxybenzenesulfonate) | | | | | | | | | | |
| TAED (tetraacetyl- | 3 | 3 | 3 | 1 | | | | | | 3 |
| ethylenediamine) | | | | | | | | | | |
| E) | | | | | | | | | | |
| Granulate from Ex. 1 | 0.03 | 0.01 | 0.01 | 0.02 | 0.02 | 0.005 | 0.02 | 0.005 | 0.01 | 0.02 |
| F) Further additives | | | | | | | | | | |
| Perfume | 0.1 | 0.1 | 0.1 | 0.1 | 0.1 | 0.1 | 0.1 | 0.1 | 0.1 | 0.1 |
| Cellulase | 1.5 | | 1.5 | 1.5 | 1.5 | | | | | |
| Protease | | 1.5 | | | | 1.5 | 1.5 | 1.5 | 1.5 | 1.5 |
| Polycarboxylate | | 4 | | | | 4 | 4 | 4 | 4 | 4 |
| Carboxymethylcellulose | 2 | 2 | 2 | 2 | 2 | 2 | 2 | 2 | 2 | 2 |
| Sodium sulfate | 15 | 13 | 18 | 25 | 22 | 20 | 9 | 25 | 8 | 10 |
| Sodium carbonate | 10 | 7 | 10 | 7 | 7 | | 5 | 13 | 8 | 6 |

Small amounts of further additives (foam inhibitors etc.) and the residual moisture content of the washing agent make the composition up to 100%.

The granulates from Examples 2-22 may also be used instead of the granulate from Example 1.

TABLE 4
Examples 33-40

| | 33 | 34 | 35 | 36 | 37 | 38 | 39 | 40 |
|---|---|---|---|---|---|---|---|---|
| Sodium laurylbenzenesulfonic | 8% | 8% | 8% | 8% | 8% | 8% | 8% | 8% |
| acid | | | | | | | | |
| Sodium lauryl ether sulfate | 3% | 3% | 3% | 3% | 3% | 3% | 3% | 3% |
| (AES) | | | | | | | | |
| Neodol 23-6.5E (non-ionic | 5% | 5% | 5% | 5% | 5% | 5% | 5% | 5% |
| alcohol ethoxylate) | | | | | | | | |
| Zeolite A | 20% | 20% | 20% | 20% | 20% | 20% | 20% | 20% |
| Polycarboxylate (co-builder) | 5% | 5% | 5% | 5% | 5% | 5% | 5% | 5% |
| Sodium carbonate | 18% | 18% | 18% | 18% | 18% | 18% | 18% | 18% |
| Sodium silicate | 4% | 4% | 4% | 4% | 4% | 4% | 4% | 4% |
| Sodium sulfate | 5% | 5% | 5% | 5% | 5% | 5% | 5% | 5% |
| Hydroxyethane diphosphonic | 0.5% | 0.5% | 0.5% | 0.5% | 0.5% | 0.5% | 0.5% | 0.5% |
| acid (complexing agent) | | | | | | | | |
| Cellulase | 1.5% | 1.5% | | 1.5% | 1.5% | | 1.5% | 1.5% |
| Protease | | | 1.5% | | | 1.5% | | |
| Carboxymethylcellulose | 1% | 1% | 1% | 1% | 1% | 1% | 1% | 1% |
| Sodium perborate | 15% | 15% | 15% | 15% | 15% | 15% | 15% | 15% |
| monohydrate | | | | | | | | |
| TAED | 5% | 5% | 5% | 5% | 5% | 5% | 5% | 5% |
| Soap | 2% | 2% | 2% | 2% | 2% | 2% | 2% | 2% |
| Granulate from Example 1 | 0.03 | 0.005 | 0.02 | 0.008 | 0.01 | 0.03 | 0.02 | 0.02 |

Small amounts of further additives and the residual moisture content of the washing agent make the composition up to 100%.

The granulates from Examples 2-22 may also be used instead of the granulate from Example 1.

1. An encapsulated granulate comprising a phthalocyanine compound, wherein said granulate comprises an encapsulating layer consisting of at least one finely particulate solid and at least one hydrophobic coating material.

2. An encapsulated granulate according to claim 1, wherein the granulate does not contain any enzymes.

3. An encapsulated granulate according to claim 1 comprising
a) from 2 to 50% by weight of at least one water-soluble phthalocyanine compound, based on the total weight of the granulate,
b) from 10 to 60% by weight of at least one anionic dispersing agent and/or at least one water-soluble organic polymer, based on the total weight of the granulate,
c) from 15 to 75% by weight of at least one inorganic salt and/or at least one low-molecular-weight organic acid or salt thereof, based on the total weight of the granulate,
d) from 0 to 10% by weight of at least one further additive, based on the total weight of the granulate,
e) from 3 to 15% by weight water, based on the total weight of the granulate.

4. An encapsulated granulate according to claim 1, which comprises a phthalocyanine compound of formula (1a) and/or (1b) 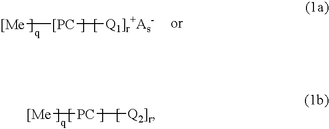
wherein
PC is the phthalocyanine ring system;
Me is Zn; Fe(II); Ca; Mg; Na; K; Al-Z₁; Si(IV); P(V); Ti(IV); Ge(IV); Cr(VI); Ga(III); Zr(IV); In(III); Sn(IV) or Hf(VI);
Z₁ is a halide ion, sulfate ion, nitrate ion, acetate ion or hydroxy ion;
q is 0, 1 or 2;
r is from 1 to 4;
Q₁ is a sulfo or carboxyl group; or is a radical of formula —SO₂X₂—R₆⁻X₃⁺; —O—R₆—X₃⁺; or —(CH₂)ₜ—Y₁⁺;
wherein
R₆ is branched or unbranched C₁-C₈alkylene; or 1,3- or 1,4-phenylene;
X₂ is —NH—; or —N—C₁-C₅alkyl-;
X₃⁺ is a group of formula 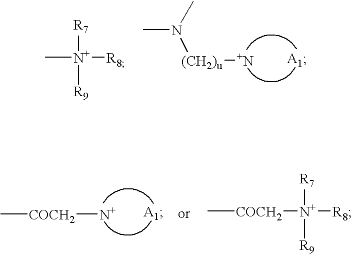
and, in the case where R₆═C₁-C₈alkylene, may also be a group of formula 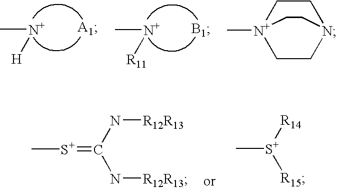
Y₁⁺ is a group of formula 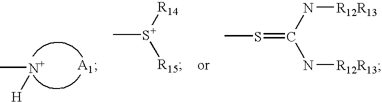
t is 0 or 1;
in which above formulae
R₇ and R⁸ are each independently of the other C₁-C₆alkyl;
R₉ is C₁-C₆alkyl; C₅-C₇cycloalkyl; or NR₁₁R₁₂;
R₁₀ and R₁₁ are each independently of the other C₁-C₅alkyl;
R₁₂ and R₁₃ are each independently of the other hydrogen or C₁-C₅alkyl;
R₁₄ and R₁₅ are each independently of the other unsubstituted or hydroxy-, cyano-, carboxy-, C₁-C₆alkoxy-carbonyl-, C₁-C₆alkoxy-, phenyl-, naphthyl- or pyridyl-substituted C₁-C₆alkyl;
u is from 1 to 6;
A₁ is the balance of an aromatic 5- to 7-membered nitrogen heterocycle which may contain one or two further nitrogen atoms as ring members, and
B₁ is the balance of a saturated 5- to 7-membered nitrogen heterocycle which may contain 1 or 2 further nitrogen, oxygen and/or sulfur atoms as ring members;
Q₂ is hydroxy; C₁-C₂₂alkyl; branched C₄-C₂₂alkyl; C₂-C₂₂alkenyl; branched C₄-C₂₂alkenyl or a mixture thereof; C₁-C₂₂alkoxy; a sulfo or carboxyl radical; a radical of formula 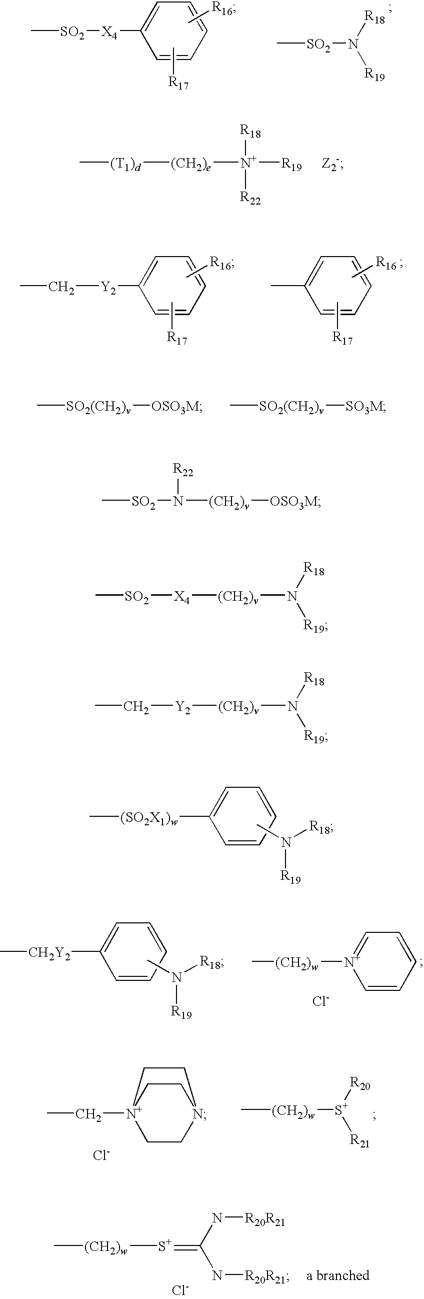
alkoxy radical of formula 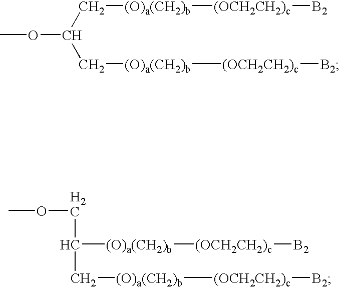
an alkylethyleneoxy unit of formula -(T₁)_{d}—(CH₂)_{b}(OCH₂CH₂)ₐ—B₃ or an ester of formula COOR₂₃,
wherein
B₂ is hydrogen; hydroxy; C₁-C₃₀alkyl; C₁-C₃₀alkoxy; —CO₂H; —CH₂COOH; SO₃⁻M₁⁺; —OSO₃⁻M₁⁺; PO₃²⁻M₁²⁺; —OPO₃²⁻M₁²⁺; or a mixture thereof;
B₃ is hydrogen; hydroxy; —COOH; —SO₃⁻M₁; —OSO₃⁻M₁⁺; or C₁-C₆alkoxy;
M₁ is a water-soluble cation;
T₁ is —O—; or —NH—;
X₁ and X₄ are each independently of the other —O—; —NH—; or —N—C₁-C₅alkyl;
R₁₆ and R₁₇ are each independently of the other hydrogen; a sulfo group or a salt thereof; a carboxyl group or a salt thereof, or a hydroxyl group, at least one of the radicals R₁₆ and R₁₇ being a sulfo or carboxyl group or a salt thereof,
Y₂ is —O—; —S—; —NH— or —N—C₁-C₅alkyl;
R₁₈ and R₁₉ are each independently of the other hydrogen; C₁-C₆alkyl; hydroxy-C₁-C₆alkyl; cyano-C₁-C₆alkyl; sulfo-C₁-C₆alkyl; carboxy-C₁-C₆alkyl or halo-C₁-C₆alkyl; unsubstituted or halo-, C₁-C₄alkyl-, C₁-C₄alkoxy-, sulfo- or carboxy-substituted phenyl; or R₁₈ and R₁₉, together with the nitrogen atom to which they are bonded, are a saturated 5- or 6-membered heterocyclic ring which may additionally contain a further nitrogen or oxygen atom as ring member;
R₂₀ and R₂₁ are each independently of the other a C₁-C₆alkyl or aryl-C₁-C₆alkyl radical;
R₂₂ is hydrogen; or unsubstituted or halo-, hydroxy-, cyano-, phenyl-, carboxy-, C₁-C₆alkoxy-carbonyl- or C₁-C₆alkoxy-substituted C₁-C₆alkyl;
R₂₃ is C₁-C₂₂alkyl; branched C₃-C₂₂alkyl; C₂-C₂₂alkenyl or branched C₃-C₂₂alkenyl; C₃-C₂₂glycol; C₁-C₂₂alkoxy; branched C₄-C₂₂alkoxy; or a mixture thereof;
M is hydrogen; or an alkali metal ion or ammonium ion,
Z₂ is a chlorine ion, bromine ion, alkylsulfate ion or aralkylsulfate ion;
a is 0 or 1;
b is from 0 to 6;
c is from 0 to 100;
d is 0 or 1;
e is from 0 to 22;
v is an integer from 2 to 12;
w is 0 or 1; and
A is an organic or inorganic anion,
and
in the case of monovalent anions A⁻ is equal to r and in the case of polyvalent anions is ≦r, it being necessary for Aₛ⁻ to balance the positive charge; and when r≠1, the radicals Q₁ may be identical or different,
and wherein the phthalocyanine ring system may also contain further solubility-imparting groups.

5. An encapsulated granulate according to claim 3, wherein the phthalocyanine component a) comprises at least one dye selected from the group consisting of formulae (A)-(I)

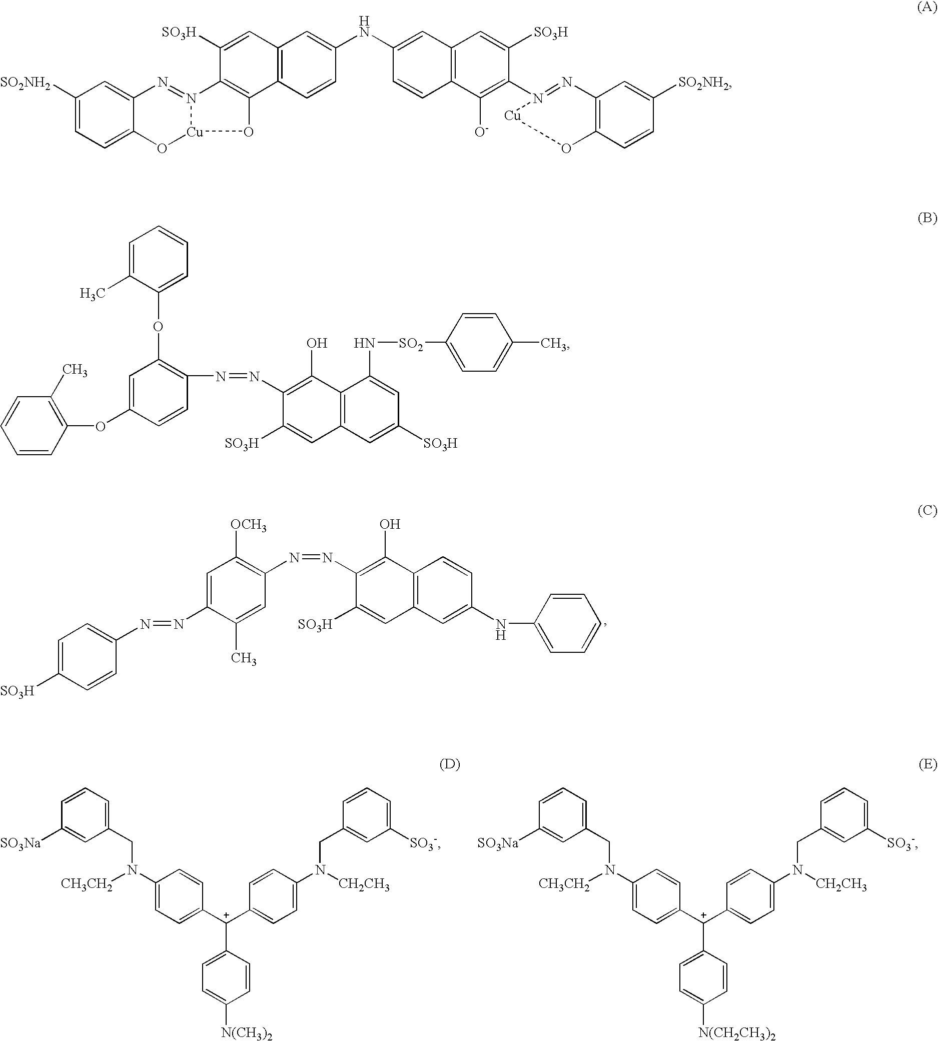

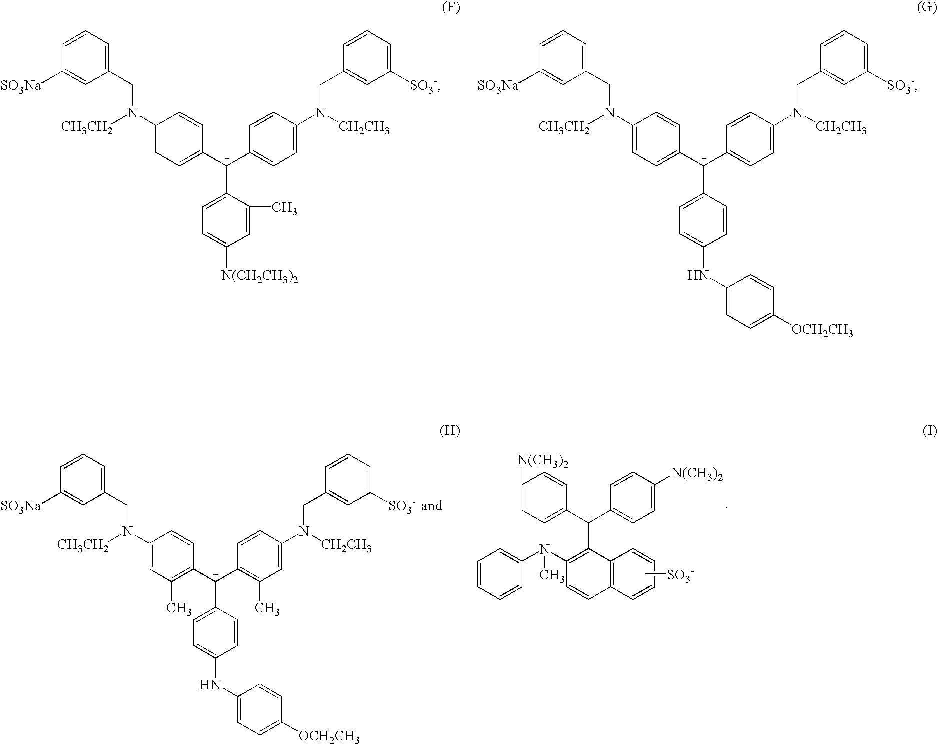

6. An encapsulated granulate according to claim 1, which comprises at least one phthalocyanine to which at least one dye is covalently bonded.

7. An encapsulated granulate according to claim 6, wherein the phthalocyanine to which at least one dye is covalently bonded corresponds to formula (8a) and/or (8b) 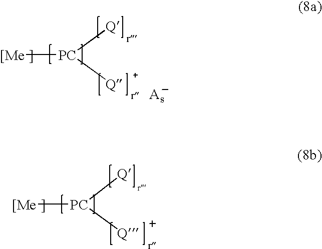
wherein
PC is the phthalocyanine system,
Me is Zn; Ca; Mg; Na; K; Al-Z₃; Si(IV)-(Z₃)₂; Ti(IV)-(Z₃)₂; Ge(IV)-(Z₃)₂; Ga(II)-Z₃; Zr(IV)-(Z₃)₂; In(III)-Z₃ or Sn(IV)-(Z₃)₂,
Z₃ is an alkanolate ion; a hydroxyl ion; R₂₅COO⁻; ClO₄⁻; BF₄⁻; PF₆⁻; R₂₅SO₃⁻; SO₄²⁻; NO₃⁻; F⁻; Cl⁻; Br⁻; I⁻; or a citrate, tartrate or oxalate ion,
wherein R₂₅ is hydrogen; unsubstituted C₁-C₁₈alkyl; or C₁-C₁₈alkyl which is substituted by at least one substituent from the group hydroxy, cyano, carboxy, SO₃H, —NH₂, C₁-C₆alkoxy-carbonyl, C₁-C₆alkoxy, phenyl, naphthyl and pyridyl; unsubstituted aryl; or aryl which is substituted by at least one substituent from the group hydroxy, cyano, carboxy, SO₃H, —NH₂, C₁-C₆alkoxy-carbonyl, C₁-C₆alkoxy and C₁-C₄alkyl,
r″ is 0; 1; 2; 3 or 4,
r′″ is 1; 2; 3 or 4,
each Q⁻, independently of any other(s), is a sulfo or carboxy group or a radical of formula —SO₂X₅—R₂₆—X₆⁺; —O—R₂₆—X₆+ or —(CH₂)ₜ—Y₄⁺,
wherein
R₂₆ is straight-chain or branched C₁-C₈alkylene; 1,3-phenylene or 1,4-phenylene,
X₅ is —NH— or —N(C₁-C₅alkyl)-,
X₆⁺ is a radical of formula 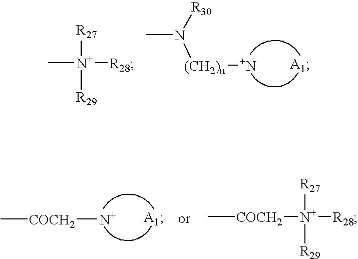
and, when R₂₆═C₁-C₈alkylene, X₆⁺ may also be 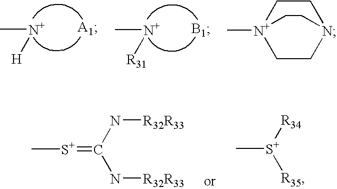
Y₄⁺ is a radical of formula 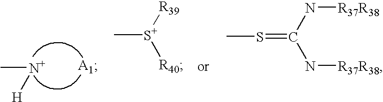
t′ is 0 or 1,
in which above formulae
R₂₇ and R₂₈ are each independently of the other C₁-C₆alkyl,
R₂₉ is C₁-C₆alkyl; C₅-C₇cycloalkyl or NR₃₂R₃₃,
R₃₀ and R₃₁ are each independently of the other C₁-C₅alkyl,
R₃₂ and R₃₃ are each independently of the other hydrogen or C₁-C₅alkyl,
R₃₄ and R₃₅ are each independently of the other unsubstituted C₁-C₆alkyl, or C₁-C₆alkyl which is substituted by at least one substituent from the group hydroxy, cyano, carboxy, SO₃H, —NH₂, C₁-C₆alkoxy-carbonyl, C₁-C₆alkoxy, phenyl, naphthyl and pyridyl,
u is a number from 1 to 6,
A¹ is a unit which completes an aromatic 5- to 7-membered nitrogen-containing heterocyclic ring which may contain one or two further nitrogen atoms, and
B₁ is a unit which completes a saturated 5- to 7-membered nitrogen heterocycle which may contain 1 or 2 further nitrogen, oxygen and/or sulfur atoms as ring members,
each Q′, independently of any other(s), is a moiety of formula -L-D,
wherein L is a direct bond or a bridging group and
D is the radical of a dye,
each Q′″, independently of any other(s), is hydroxy; C₁-C₂₂alkyl; branched C₃-C₂₂alkyl; C₂-C₂₂alkenyl; branched C₃-C₂₂alkenyl or a mixture thereof; C₁-C₂₂alkoxy; a sulfo or carboxy radical; a radical of formula 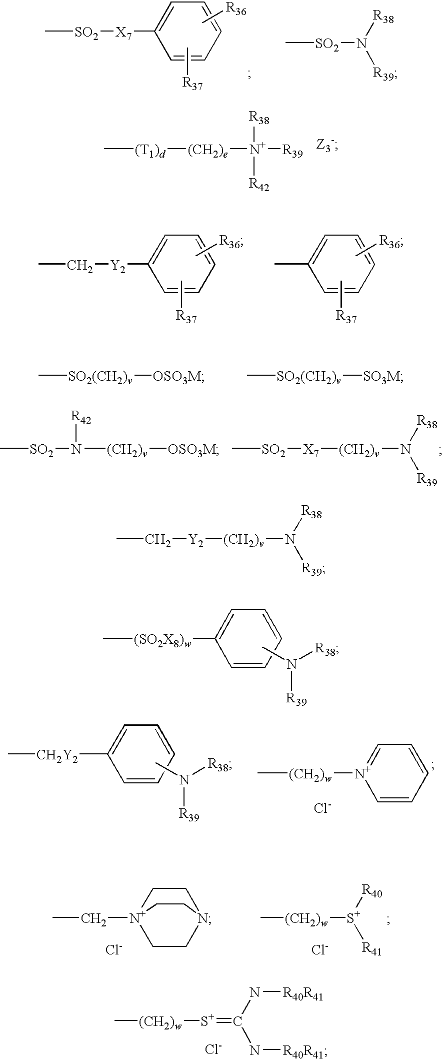
a branched alkoxy radical of formula 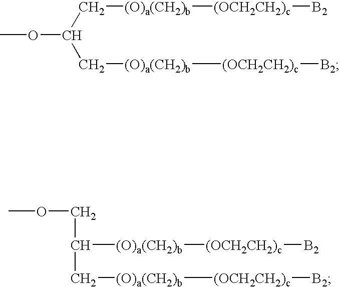
an alkylethyleneoxy unit of formula
-(T₁)_{d}—(CH₂)_{b}(OCH₂CH₂)ₐ—B₃ or an ester of formula COOR₁₈,
wherein
B₂ is hydrogen; hydroxy; C₁-C₃₀alkyl; C₁-C₃₀alkoxy; —CO₂H; —CH₂COOH; —SO₃⁻M₁; —OSO₃⁻M₁; —PO₃²⁻M; —OPO₃²⁻M₁; or a mixture thereof,
B₃ is hydrogen; hydroxy; —COOH; —SO₃-M₁; —OSO₃-M₁ or C₁-C₆alkoxy,
M₁ is a water-soluble cation,
T₁ is —O—; or —NH—;
X₇ and X₈ are each independently of the other —O—; —NH— or —N(C₁-C₅alkyl)-,
R₃₆ and R₃₇ are each independently of the other hydrogen; a sulfo group or a salt thereof; a carboxy group or a salt thereof, or a hydroxy group; at least one of the radicals R₃₆ and R₃₇ being a sulfo or carboxy group or a salt thereof,
Y₂ is —O—; —S—; —NH— or —N(C₁-C₅alkyl)-,
R₃₈ and R₃₉ are each independently of the other hydrogen; C₁-C₆alkyl; hydroxy-C₁-C₆alkyl; cyano-C₁-C₆alkyl; sulfo-C₁-C₆alkyl; carboxy or halo-C₁-C₆alkyl; unsubstituted phenyl or phenyl which is substituted by at least one substituent from the group halogen, C₁-C₄alkyl, C₁-C₄alkoxy, sulfo and carboxy; or R₃₈ and R₃₉, together with the nitrogen atom to which they are bonded, are a saturated 5- or 6-membered heterocyclic ring which may additionally contain a further nitrogen atom or oxygen atom as ring member,
R₄₀ and R₄₁ are each independently of the other C₁-C₆alkyl or aryl-C₁-C₆alkyl radicals,
R₄₂ is hydrogen, unsubstituted C₁-C₆alkyl, or C₁-C₆alkyl which is substituted by at least one substituent from the group halogen, hydroxy, cyano, SO₃H, —NH₂, phenyl, carboxy, C₁-C₆alkoxy-carbonyl and C₁-C₆alkoxy,
R₄₃ is C₁-C₂₂alkyl; branched C₃-C₂₂alkyl; C₁-C₂₂alkenyl or branched C₃-C₂₂alkenyl; C₃-C₂₂glycol; C₁-C₂₂alkoxy; branched C₃-C₂₂alkoxy; or a mixture thereof,
M is hydrogen; or an alkali metal ion or ammonium ion,
Z₃ is an alkanolate ion; a hydroxyl ion; R₂₅COO⁻; ClO₄⁻; BF₄⁻; PF₆⁻; R₂₅SO₃⁻; SO₄²⁻; NO₃⁻; F⁻; Cl⁻; Br⁻; I⁻; citrate, tartrate or oxalate ion,
wherein R₂₅ is hydrogen; or unsubstituted C₁-C₁₈alkyl; or C₁-C₁₈alkyl which is substituted by at least one substituent from the group hydroxy, cyano, carboxy, SO₃H, —NH₂, C₁-C₆alkoxy-carbonyl, C₁-C₆alkoxy, phenyl, naphthyl and pyridyl; unsubstituted aryl; or aryl which is substituted by at least one substituent from the group hydroxy, cyano, carboxy, SO₃H, —NH₂, C₁-C₆alkoxy-carbonyl, C₁-C₆alkoxy and C₁-C₄alkyl,
a is 0 or 1,
b is from 0 to 6,
c is from 0 to 100,
d is 0; or 1;
e is from 0 to 22;
v is an integer from 2 to 12;
w is 0 or 1; and
A⁻ is an organic or inorganic anion,
and
s in the case of monovalent anions A⁻ is equal to r and in the case of polyvalent anions is <r, it being necessary for Aₛ⁻ to balance the positive charge; and when r # 1, the radicals Q″ may be identical or different,
and wherein the phthalocyanine ring system may also contain further solubility-imparting groups.

8. An encapsulated granulate according to claim 7, wherein D is a radical of formula (I)-(XXV): 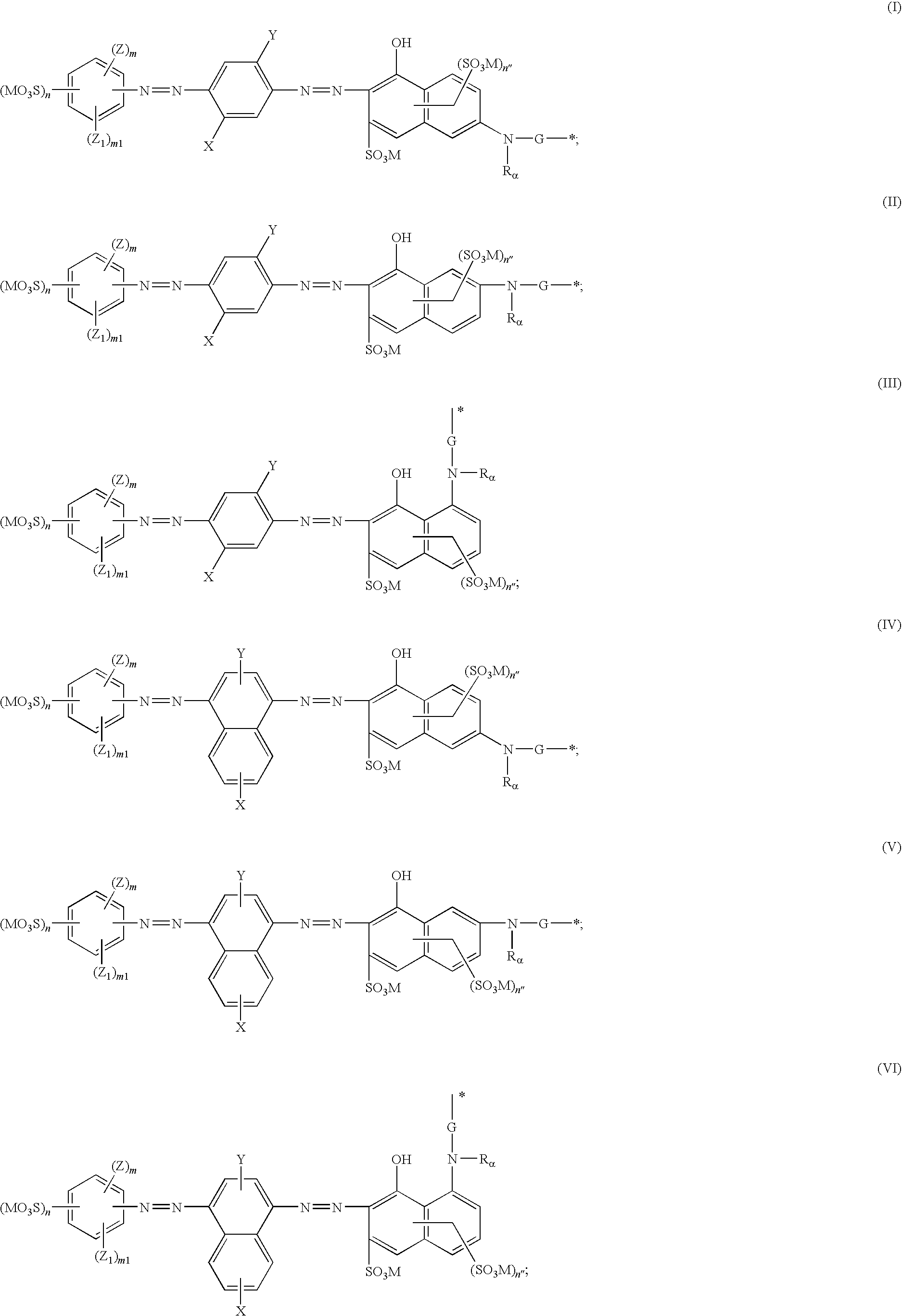 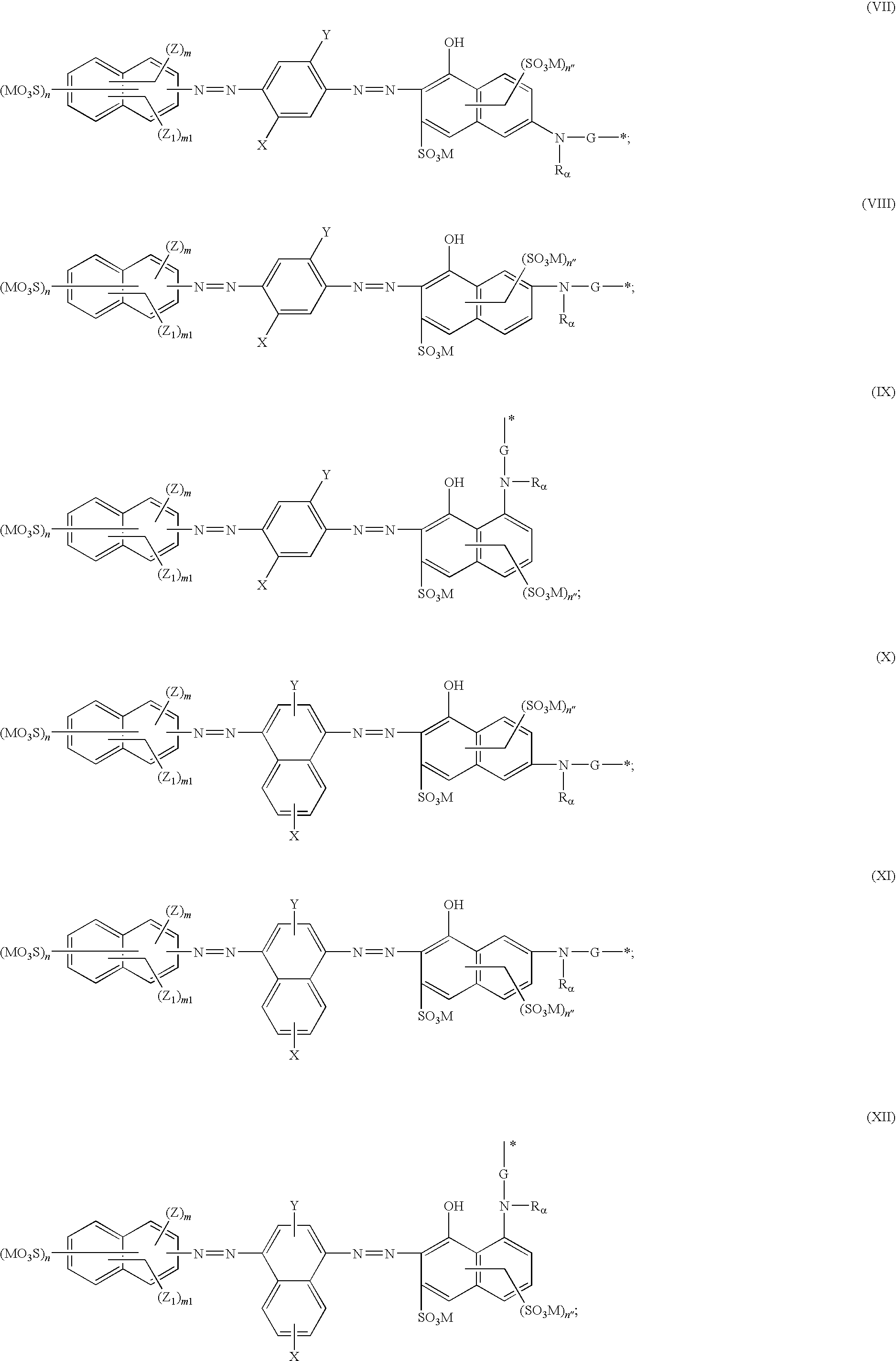 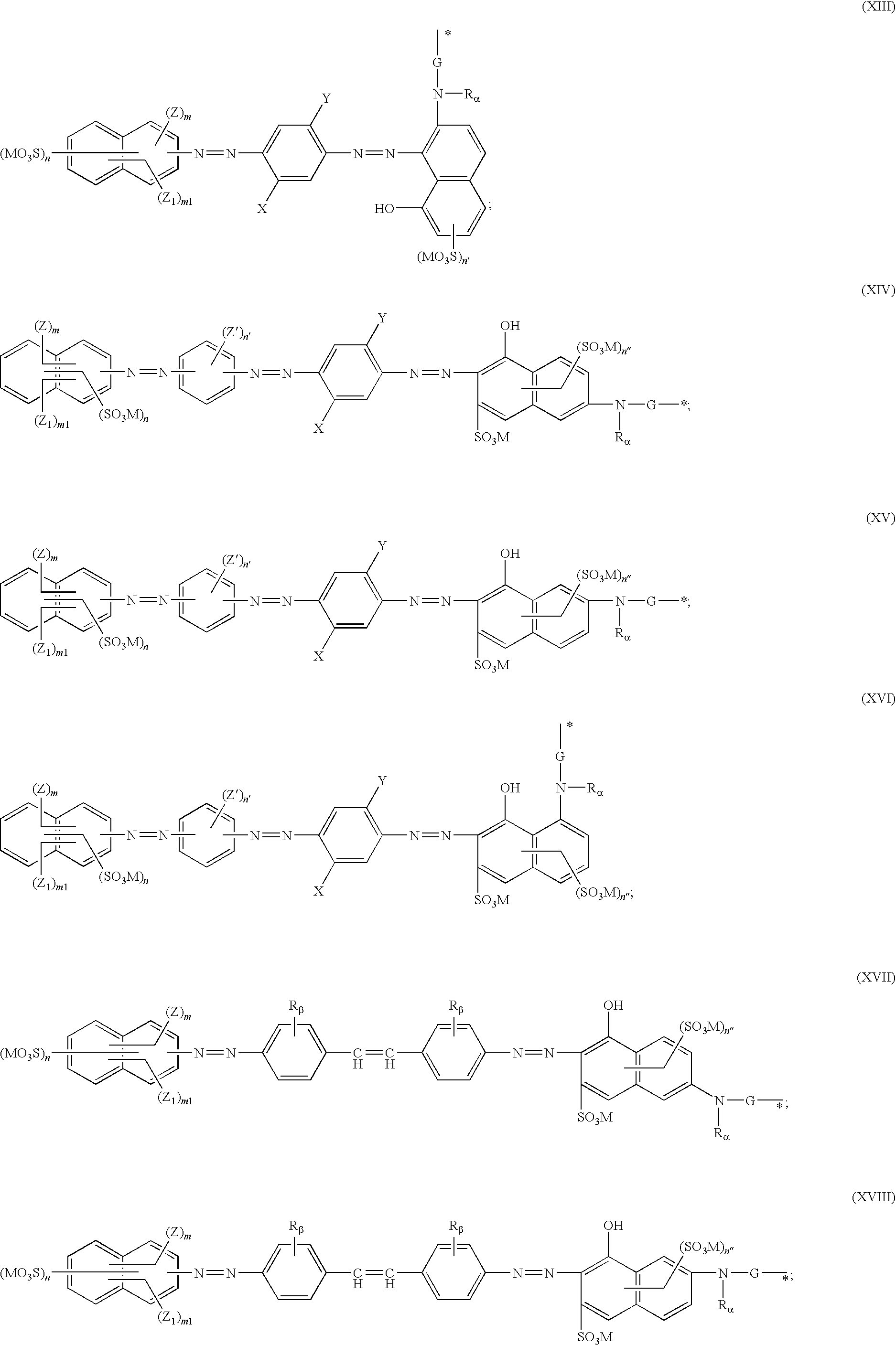 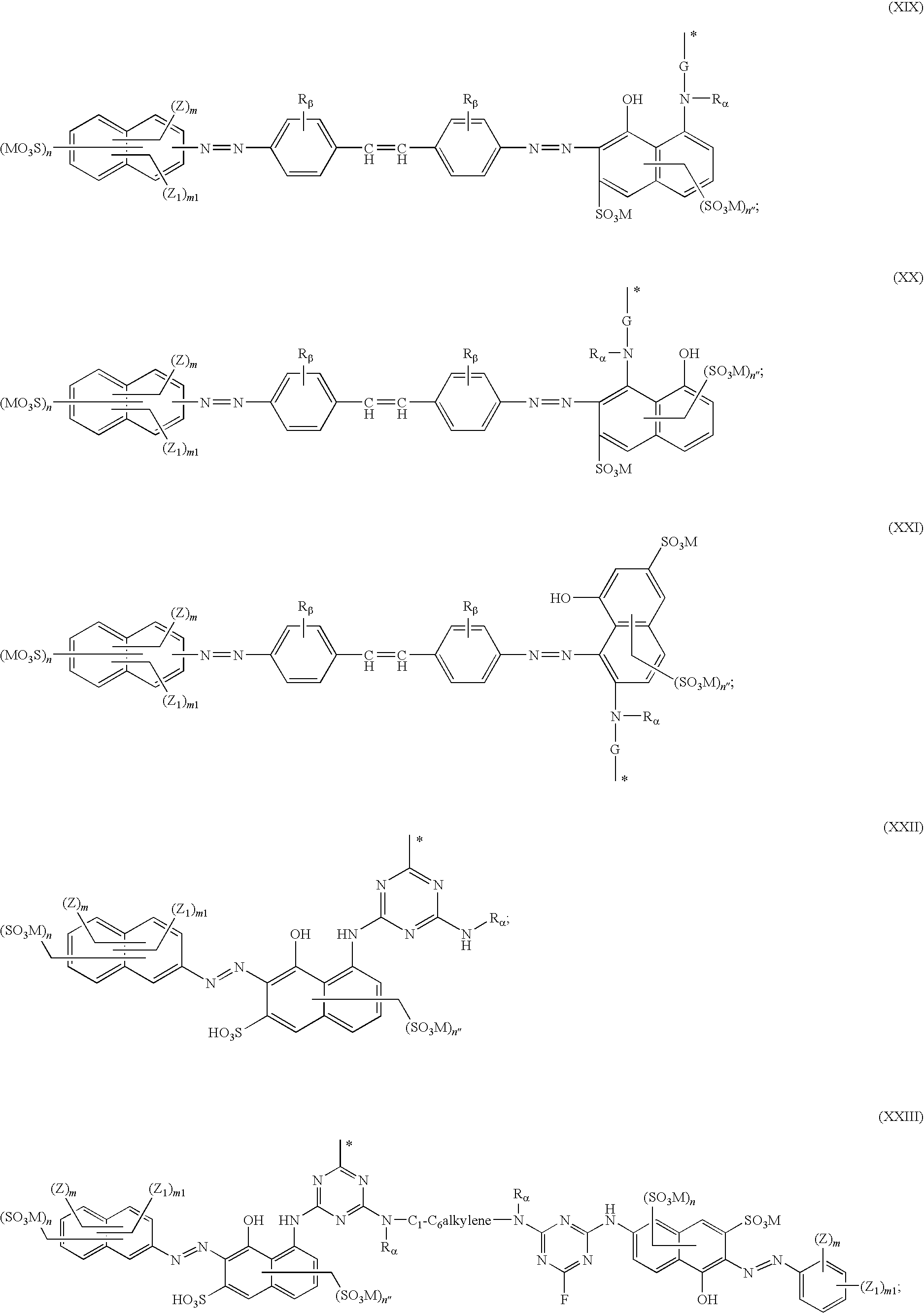 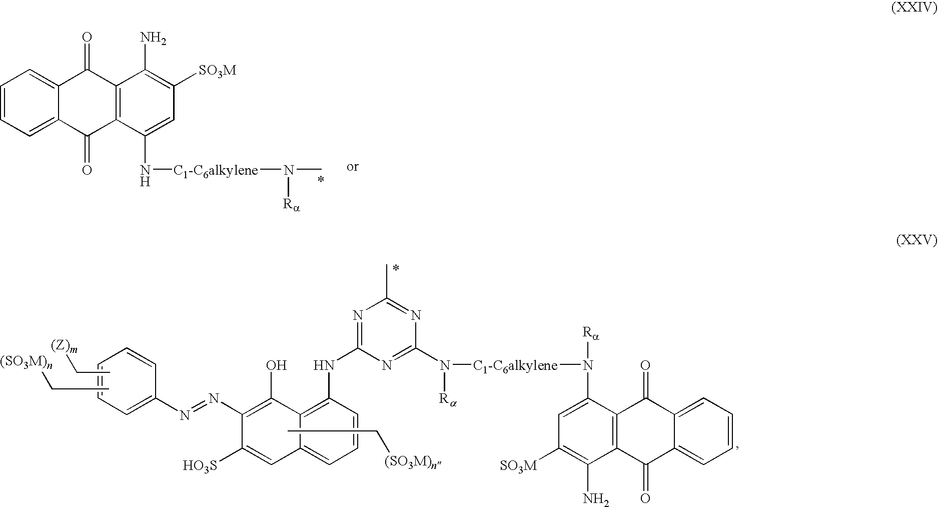
wherein
* denotes the bond to the bridging group L,
X and Y are each independently of the other hydrogen; —SO₃M; unsubstituted straight-chain or branched C₁-C₄alkyl; straight-chain or branched C₁-C₄alkyl which is substituted by at least one substituent from the group hydroxy, cyano, —SO₃H, —NH₂, carboxy, C₁-C₄alkoxy-carbonyl, C₁-C₄alkoxy, phenyl, naphthyl and pyridyl; unsubstituted straight-chain or branched C₁-C₄alkoxy; straight-chain or branched C₁-C₄alkoxy which is substituted by at least one substituent from the group hydroxy, cyano, —SO₃H, —NH₂, carboxy, C₁-C₄alkoxy-carbonyl, C₁-C₄alkyl, phenyl, naphthyl and pyridyl; —COOH or —COOC₁-C₄alkyl;
R_{α} is hydrogen; unsubstituted straight-chain or branched C₁-C₄alkyl; straight-chain or branched C₁-C₄alkyl which is substituted by at least one substituent from the group hydroxy, cyano, —SO₃H, —NH₂, carboxy, C₁-C₄alkoxy-carbonyl, C₁-C₄alkoxy, phenyl, naphthyl and pyridyl; unsubstituted aryl, or aryl which is substituted by at least one substituent from the group hydroxy, cyano, —SO₃H, —NH₂, carboxy, C₁-C₄alkoxy-carbonyl, C₁-C₄alkoxy and C₁-C₄alkyl,
each R_{β}, independently of the other, is hydrogen; —SO₃M; unsubstituted straight-chain or branched C₁-C₄alkyl; straight-chain or branched C₁-C₄alkyl which is substituted by at least one substituent from the group hydroxy, cyano, —SO₃H, —NH₂, carboxy, C₁-C₄alkoxy-carbonyl, C₁-C₄alkoxy, phenyl, naphthyl and pyridyl; unsubstituted straight-chain or branched C₁-C₄alkoxy, or straight-chain or branched C₁-C₄alkoxy which is substituted by at least one substituent from the group hydroxy, cyano, —SO₃H, —NH₂, carboxy, C₁-C₄alkoxy-carbonyl, C₁-C₄alkyl, phenyl, naphthyl and pyridyl,
Z is unsubstituted straight-chain or branched C₁-C₄alkyl; straight-chain or branched C₁-C₄alkyl which is substituted by at least one substituent from the group hydroxy, cyano, —SO₃H, —NH₂, carboxy, C₁-C₄alkoxy-carbonyl, C₁-C₄alkoxy, phenyl, naphthyl and pyridyl; unsubstituted straight-chain or branched C₁-C₄alkoxy, or straight-chain or branched C₁-C₄alkoxy which is substituted by at least one substituent from the group hydroxy, cyano, —SO₃H, —NH₂, carboxy, C₁-C₄alkoxy-carbonyl, C₁-C₄alkyl, phenyl, naphthyl and pyridyl; halogen; —OH; —NO₂; —COOH; —COOC₁-C₄alkyl; —NH₂; —NHC₁-C₄alkyl wherein the alkyl group may be substituted by at least one substituent from the group —OH, —NH₂, C₁-C₄alkyl, —CN and —COOH; —N(C₁-C₄alkyl)C₁-C₄alkyl wherein the alkyl groups each independently of the other may be substituted by at least one substituent from the group —OH, —NH₂, C₁-C₄alkyl, —CN or —COOH; —NH-aryl; —NH-aryl wherein the aryl is substituted by at least one substituent from the group hydroxy, cyano, —SO₃H, —NH₂, carboxy, C₁-C₄alkoxy-carbonyl, C₁-C₄alkyl and C₁-C₄alkoxy; —NHCOC₁-C₄alkyl or —NHCOOC₁-C₄alkyl,
Z′ is —SO₃M; unsubstituted straight-chain or branched C₁-C₄alkyl; straight-chain or branched C₁-C₄alkyl which is substituted by at least one substituent from the group hydroxy, cyano, —SO₃H, —NH₂, carboxy, C₁-C₄alkoxy-carbonyl, C₁-C₄alkoxy, phenyl, naphthyl and pyridyl; unsubstituted straight-chain or branched C₁-C₄alkoxy, or straight-chain or branched C₁-C₄alkoxy which is substituted by at least one substituent from the group hydroxy, cyano, —SO₃H, —NH₂, carboxy, C₁-C₄alkoxy-carbonyl, C₁-C₄alkyl, phenyl, naphthyl and pyridyl; halogen; —OH; —NO₂; —COOH; —COOC₁-C₄alkyl; —NH₂; —NHC₁-C₄alkyl wherein the alkyl group may be substituted by at least one substituent from the group —OH, —NH₂, C₁-C₄alkyl, —CN and —COOH; —N(C₁-C₄alkyl)C₁-C₄alkyl wherein the alkyl groups each independently of the other may be substituted by at least one substituent from the group —OH, —NH₂, C₁-C₄alkyl, —CN and —COOH; —NH-aryl; —NH-aryl wherein the aryl is substituted by at least one substituent from the group hydroxy, cyano, —SO₃H, —NH₂, carboxy, C₁-C₄alkoxy-carbonyl, C₁-C₄alkyl and C₁-C₄alkoxy; —NHCOC₁-C₄alkyl or —NHCOOC₁-C₄alkyl,
Z₁ is unsubstituted straight-chain or branched C₁-C₄alkyl; straight-chain or branched C₁-C₄alkyl which is substituted by at least one substituent from the group hydroxy, cyano, —SO₃H, —NH₂, carboxy, C₁-C₄alkoxy-carbonyl, C₁-C₄alkoxy, phenyl, naphthyl and pyridyl; unsubstituted straight-chain or branched C₁-C₄alkoxy, or straight-chain or branched C₁-C₄alkoxy which is substituted by at least one substituent from the group hydroxy, cyano, —SO₃H, —NH₂, carboxy, C₁-C₄alkoxy-carbonyl, C₁-C₄alkyl, phenyl, naphthyl and pyridyl; halogen; —OH; —NO₂; —COOH; COOC₁-C₄alkyl; —NH₂; —NHC₁-C₄alkyl wherein the alkyl group may be substituted by at least one substituent from the group —OH, —NH₂, C₁-C₄alkyl, —CN and —COOH; —N(C₁-C₄alkyl)C₁-C₄alkyl wherein the alkyl groups each independently of the other may be substituted by at least one substituent from the group —OH, —NH₂, C₁-C₄alkyl, —CN and —COOH; —NH-aryl; —NH-aryl wherein the aryl is substituted by at least one substituent from the group hydroxy, cyano, —SO₃H, —NH₂, carboxy, C₁-C₄alkoxy-carbonyl, C₁-C₄alkyl and C₁-C₄alkoxy; —NHCOC₁-C₄alkyl or —NHCOOC₁-C₄alkyl,
G is a direct bond; —COOC₁-C₄alkylene; unsubstituted arylene; arylene which is substituted by at least one substituent from the group hydroxy, cyano, —NO₂, —SO₃H, —NH₂, carboxy, C₁-C₄alkoxy-carbonyl, C₁-C₄alkoxy and C₁-C₄alkyl; unsubstituted C₁-C₄alkylene, or C₁-C₄alkylene which is substituted by at least one substituent from the group hydroxy, cyano, NO₂, —SO₃H, —NH₂, carboxy, C₁-C₄alkoxy-carbonyl, C₁-C₄alkoxy and C₁-C₄alkyl,
n is 0; 1 or 2,
n′ is 0; 1 or 2,
n″ is 0 or 1,
m is 0; 1 or 2,
m₁ is 0; 1 or 2,
each M, independently of any other(s), is hydrogen; or an alkali metal ion or ammonium ion.

9. An encapsulated granulate according to claim 1, wherein a mixture of meltable hydrophobic materials having a solidification point range above 30° C. is used as meltable coating material of the encapsulating layer.

10. An encapsulated granulate according to claim 1, wherein the average particle size of the finely particulate solid is <100 μm.

11. A process for the manufacture of encapsulated granules of phthalocyanine compounds according to claim 1, which comprises applying the encapsulating layer to the granules by mixing them with a coating material melt, containing fine particulate solids, in a mixing device.

12. A process for the manufacture of encapsulated granules of phthalocyanine compounds according to claim 1, which comprises applying the encapsulating layer by spraying a coating material melt, containing fine particulate solids, onto the granules in a fluidized bed.

13. A washing agent formulation containing
I) from 5 to 70% A) of at least one anionic surfactant and/or B) at least one non-ionic surfactant, based on the total weight of the washing agent formulation,
II) from 5 to 60% C) of at least one builder substance, based on the total weight of the washing agent formulation,
III) from 0 to 30% D) of at least one peroxide and, optionally, at least one activator, based on the total weight of the washing agent formulation, and
IV) from 0.001 to 1% E) of at least one granulate according to claim 1,
V) from 0 to 60% F) of at least one further additive, and
VI) from 0 to 5% G) water.
